(19) United States
(12) Patent Application Publication
(10) Pub. No.: US 2010/0174549 A1
(43) Pub. Date: Jul. 8, 2010

(54) Emergency Consequence Assessment Tool and Method

(76) Inventors: Kevin George Garrahan, Fairfax Station, VA (US); Shanna Lee Collie, Boerne, TX (US); Shannon Sage Garcia, San Antonio, TX (US); Thomas Locke Rust, Alexandria, VA (US)

Correspondence Address: MICHAEL N. LAU;LAU & ASSOCIATES, LLC, 2121 EISENHOWER AVENUE, SUITE 200, ALEXANDRIA, VA, 22314, US

(21) Appl. No.: 12/085,865

(22) PCT Filed: Dec. 1, 2006
(86) PCT No.: PCT/US06/45980

§ 371 Date: May 30, 2008

Related U.S. Application Data
(60) Provisional application No. 60/741,443, filed on Dec. 2, 2005.

(51) Int. Cl. G06Q 10/00

(52) U.S. Cl. 705/1.1

(57) ABSTRACT

The Emergency Consequence Assessment Tool (ECAT) is an interactive web-based software tool. ECAT is designed to meet the challenge of assessing health risks and determining what actions need to be taken during a crisis caused by a terrorist attack or natural disaster. ECAT provides instant access to key information and allows its users to conduct rapid analyses. The tool also provides a holistic approach to rapid risk assessment by integrating critical information across many diverse scientific disciplines and is a useful training tool. ECAT allows its users to conduct health risk assessment, risk management, and risk communication. It allows users not only to define the health threats, but also to determine what actions need to be taken to protect the public and first responders, and how best to communicate this information to the public. It evaluates the risks from chemical and biological agents in multiple environments, such as indoors, outdoors and from water contact, including ingestion, inhalation, and dermal exposure. Further, ECAT has the potential to quantify risks to different human subpopulations.

This patent application is filed under 35 U.S.C. 119(e) claiming the priority date of U.S. Provisional Patent Application No. 60/741,443 filed on Dec. 2, 2005 by inventors Kevin Garrahan and Shanna Collie.

### BACKGROUND OF THE INVENTION

Terrorism is a style of modern warfare. Unlike conventional warfare where the fighting is predominantly between professional militaries with an attempt to minimize civilian casualties, terrorism resorts to targeting civilians and militaries with a goal of causing a pandemonium and destroying civilian infrastructures in which people rely upon in a modern society. Because this form of warfare causes wide-spread destructions in a society, it would require inter-disciplinary efforts across multiple governmental agencies and private institutions to defend against terrorism and deal with aftermaths of any attack. Of critical importance in fighting against terrorism is the timely access of specialized knowledge and correct application thereof to deal with aftermaths of an attack. This specialized knowledge must be accessible by a broad spectrum of agencies, institutions, professionals and individuals such as governmental agencies, municipalities, military, law enforcement, academia, and public health, among many others.

With this background, tools are needed to aid in the assessment of risks and facilitate informed decision-making when responding to terrorist threats or actual terrorist attacks. A variety of tools exist and are used by first responders to provide information and assist in on-scene rapid assessment and response. The usefulness and applicability of these tools in responding to specific terrorist threats/attacks are limited as the existing emergency response network was not developed to specifically address terrorist activities and/or exposure to chemical and biological warfare agents.

The Environmental Protection Agency (EPA) National Homeland Security Research Center (NHSRC) has developed the present invention entitled Emergency Consequence Assessment Tool (ECAT) for use in the recognition, evaluation, and control of terrorist incidents involving chemical, biological, and/or radiological agents. NHSRC has been charged with characterizing risks to the public and emergency response personnel, and providing advice, guidance, and scientific expertise to emergency response personnel, decision makers, and government officials on homeland security issues. The demand for this type of support occurs without advance notice, at any time of the day or night. It is necessary that emergency response personnel are provided with the best tools available; in addition, first responders and building/facility owners and operators may use tools, such as ECAT, prior to an event in the hope of preventing a disaster or at least preventing unnecessary risks.

The present ECAT invention is designed to achieve the goals of (1) developing a rapid assessment of risk to the public and emergency response personnel and (2) providing advice, guidance, and scientific expertise to risk managers. The design combines the basic elements of the operation's response and risk assessment paradigms, geared toward situations posed by a terrorist threat or actual attack dealing with chemical and biological threat agents. Modules of ECAT address the basic components of quantitative EPA risk assessment, as developed for evaluation of risks to public health resulting from exposure to environmental contaminants. The risk assessment will thus include the classic hazard identification related to data collection and evaluation, exposure assessment, toxicity assessment, and risk characterization phases, along with risk management as an additional component to synthesize all previous steps into a final recommendation for responsive actions. The interactive, web-based application prompts the user for critical information during the analytical processes of recognition and evaluation, then presents threat-specific risk information and recommendations for emergency response actions during the control process.

### SUMMARY OF THE INVENTION

It is a first object of the Emergency Consequence Assessment Tool (ECAT) to provide rapid access to complex information by organizing critical data and information in modules to perform the tasks of threat identification, exposure assessment, toxicity/hazard identification, risk characterization, and risk management that fall within such themes as recognition, evaluation, and control.

It is a second object of ECAT to provide risk analysis guidance by presenting illustrative scenarios that demonstrate how risk data, models, and protocols can be applied during an environmental emergency.

It is a third object of ECAT to rapidly identify a threat agent by providing users with a menu checklist of health symptoms or adverse effects and an on-scene checklist of observations describing the attack.

It is a fourth object of ECAT to provide a software algorithm that instantly compares observations with known symptoms and properties of threat agents.

It is a fifth object of ECAT to provide an algorithm that issues a summary identifying likely agents and the basis for making a match between health symptoms and known symptoms and rendering a summary thereof.

It is a sixth object of ECAT to provide instant access to fact sheets and quick reference guides developed by EPA and other government agencies describing threat agents by accessing the Uniform Resource Locator (URL) links on menus.

It is a seventh object of ECAT to allow users to derive numeric estimates of exposure to threat agents by providing iterative sets of pull-down menus that allow a user to select or input appropriate receptors, exposure pathways, exposure models, exposure measurements, exposure assumptions, exposure routes, and exposure factors that can be used in an algorithm that calculates exposure to potentially exposed populations.

It is an eighth object of ECAT to allow users to immediately identify adverse health effects and health benchmarks for chemical, biological, and radiological threat agents by providing summaries of effects along with dose-response curves complete with citations and references.

It is a ninth object of ECAT to allow users to rapidly develop numeric estimates of health risk by using an algorithm and a calculator to estimate a receptor-specific hazard quotient derived by dividing the exposure estimate by the health benchmark. A pop-up page provides details about the formula, assumptions, and factors used in the calculations.

It is a tenth object of ECAT to provide critical information on what actions are advisable when threat agents have been released into the environment by providing online summaries, fact sheets, and references organized by topics of recommendations to evacuate/stop use or shelter in place, personal protective equipment, treatment techniques, decontamination procedures, cleanup levels, waste disposal options, and detection methods.

It is an eleventh object of ECAT to provide guidance on how to communicate during a crisis by providing a summary of message mapping techniques and illustrative examples.

It is a twelfth object of ECAT to provide guidance on how to conduct risk analyses of terror attack scenarios by illustrating scenario-based risk assessments.

Further objects of the present invention will become apparent upon a full review and comprehension of the present invention as disclosed in this application and the provisional patent application in which this patent application claims priority thereof.

### BRIEF DESCRIPTION OF THE DRAWING

FIG. 1 shows by way of an example an integration diagram of the EPA risk assessment paradigm with the EPA emergency response paradigm.

FIG. 2 shows by way of an example a system flow-chart of the present invention.

FIG. 3 shows by way of an example a login screen to the ECAT system of the present invention.

FIG. 4 shows by way of an example an ECAT system screen for first time users.

FIG. 5 shows by way of an example an ECAT system screen for first time users including threat identification, exposure assessment and toxicity assessment selections at the right hand bar.

FIG. 6 shows by way of an example an ECAT system screen of a number of possible threat scenarios.

FIG. 7 shows by way of an example an ECAT system screen for creating a new incident response or training scenario.

FIG. 8 shows by way of an example an ECAT system screen showing some ECAT scenarios.

FIG. 9 shows by way of an example an ECAT system screen showing some ECAT threat agents.

FIG. 10 shows by way of an example an ECAT screen for agent identification.

FIG. 11 shows by way of an example an ECAT screen illustrating how symptoms manifested on a victim is identified and gathered.

FIG. 12 shows by way of an example an ECAT system screen a table of agent identification results.

FIGS. 13 and 14 show by way of examples ECAT systems screens showing matched threat agent specific information.

FIG. 15 shows by way of an example an exposure assessment screen of the ECAT system.

FIG. 16 shows by way of an example an exposure parameter screen of the ECAT system.

FIG. 17 shows a diagram regarding the calculation of contaminant mass of each time step.

FIG. 18 shows a flow chart of agent and computation modules.

FIG. 19 shows a table tabulating surface wind speed information versus cloud cover information.

FIG. 20 shows a table recommending fresh air supply information.

FIG. 21 shows a table tabulating area versus minimum total air exchanges per hour information.

FIG. 22 shows by way of an example a tabulated result of based on a hotspot model.

FIG. 23 shows by way of an example an ECAT screen regarding symptoms and doses related to toxicity.

FIG. 24 shows by way of an example an ECAT system screen of dose/effect detail.

FIG. 25 shows by way of an example a chart illustrating dose response data for ocular effects in humans.

FIG. 26 shows by way of an example of an ECAT system screen of the calculated custom toxicity value.

FIG. 27 shows by way of an example of an ECAT system screen illustrating bio-threat infectivity and virulence information.

FIG. 28 shows by way of an example an ECAT screen providing a summary information of anthrax in animals.

FIG. 29 shows by way of an example a screen with example data charted in percentage lethal versus quantity of spores.

FIG. 30 shows by way of an example an ECAT system screen showing ECAT bio exposure notes.

FIG. 31 shows by way of an example of an ECAT system exposure point concentration screen.

FIG. 32 shows by way of an example an ECAT system screen indicating an ECAT estimating concentrations.

FIG. 33 shows by way of an example an ECAT system screen containing a sub-screen with sizes for common container types.

FIG. 34 shows by way of an example of an ECAT system screen for gathering exposure assessment information suitable for using a water model.

FIG. 35 shows by way of an example an ECAT system screen showing water model output information including a summary of all the calculations necessary for its derivation.

FIG. 36 shows by way of an example of an ECAT system screen for entering air model inputs.

FIG. 37 shows by way of an example an ECAT screen showing a time of day air release entry page and an outdoor air dispersion modeling entry page.

FIG. 38 shows by way of an example an ECAT screen showing a wind-speed entry page.

FIG. 39 shows by way of an example an ECAT system screen showing an entry page for the entry of further detailed information for outdoor air dispersion modeling.

FIG. 40 shows by way of an example an ECAT system screen showing an indoor air model input page.

FIG. 41 shows by way of an example an ECAT system screen showing a summary of indoor air model calculations.

FIG. 42 shows by way of an example an ECAT system screen showing risk characterization including the ECAT default reference dose.

FIG. 43 shows by way of an example an ECAT system screen showing the basis of the default reference dose.

FIG. 44 shows by way of an example an ECAT system screen showing custom toxicity values for hazard quotient calculations.

FIG. 45 shows by way of an example an ECAT system screen of its content management system.

FIG. 46 shows by way of an example an ECAT system screen showing a number of searchable documents in the ECAT knowledge database.

FIG. 47 shows by way of an example an ECAT system screen showing a screen to obtain referencing information.

FIG. 48 shows by way of an example an ECAT system screen showing documents or references being added to the content management.

FIG. 49 shows by way of an example of an ECAT system screen showing how weblinks may be added.

FIG. 50 shows by way of an example an ECAT system screen showing how weblinks can be verified.

FIG. 51 shows by way of an example an ECAT system screen showing personal protection equipment information.

FIG. 52 shows by way of an example an ECAT system screen continuing the information from FIG. 51.

FIG. 53 shows by way of an example an ECAT screen where calculation sets or models can be added or edited.

FIG. 54 shows by way of an example an ECAT system screen showing a selection screen to add, copy or edit calculations or formulas.

FIG. 55 shows by way of an example an ECAT system screen showing treatment information for sarin exposure.

FIG. 56 shows by way of an example an ECAT system screen showing decontamination information of sarin.

FIG. 57 shows by way of an example an ECAT system screen regarding detection methods and detectors.

FIG. 58 shows by way of an example an ECAT system screen regarding clean-up information.

FIG. 59 shows by way of an example an ECAT system screen regarding waste disposal.

FIG. 60 shows by way of an example an ECAT system screen showing some frequently asked questions with answers regarding a dirty bomb attack.

FIG. 61 shows by way of an example an ECAT system screen showing benchmarks and advisories.

FIG. 62 shows by way of an example a table of receptor body weights.

FIGS. 63A and 63B show by way of an example a table of receptor versus age-specific inhalation rates.

FIG. 64 shows by way of an example a table of receptor versus exposed skin surface area.

FIGS. 65A and 65B provide a table regarding the input parameters for the water distribution system model.

FIG. 66 shows by way of an example a table regarding type of agent related to treatment information.

FIG. 67 shows by way of an example output from the detection limit utility.

FIG. 68 shows by way of an example input values for outdoor air model.

### DETAILED DESCRIPTION OF THE INVENTION

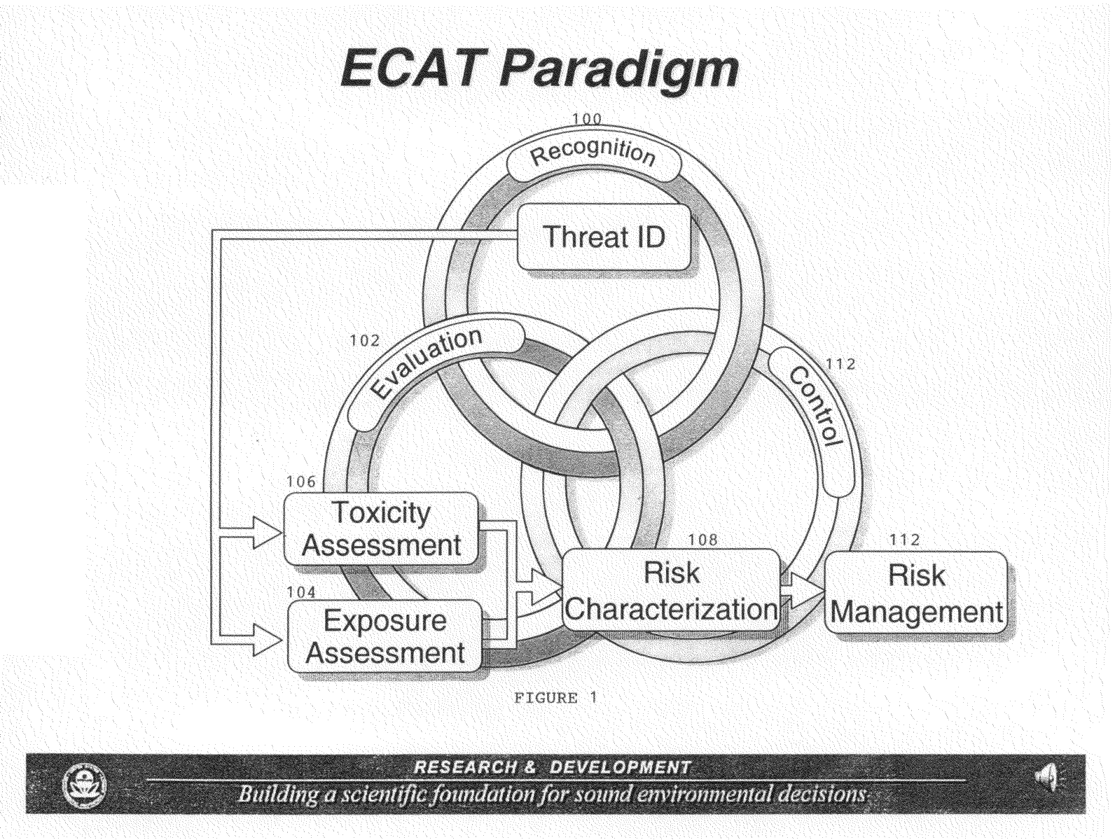

The diagram in FIG. 1 clearly shows that the ECAT system needs to accommodate multiple types of users, with differing needs and requirements. The foremost user group is the group of science advisors who provide support to emergency responders; emergency responders may not have time to access or need all of the information contained in ECAT. For example, the ECAT design guides a user through a step-wise risk assessment process beginning after earliest stages of risk identification in an emergency response. At the same time, the present invention is designed to allow for an option to skip these steps and begin the risk assessment at a point farther down the decision tree. Other users will have more general needs and will need immediate access to an array of information sources contained in ECAT. These users might not have the need or the time to deal with a stepwise approach that requires them to provide multiple inputs before having assess to needed information about the toxicity and chemical properties of a substance, the appropriate actions to reduce risk, or access to other appropriate actions to reduce risk, or access to other relevant information sources. ECAT can accommodate these users by providing direct access to documentation and search functions. Another group of users could be located at a response scene, where Internet access is slow, unreliable or not available.

ECAT is a tool to assist in performing the rapid assessment of risk following an emergency situation posed by a terrorist threat or actual terrorist attack dealing with chemical and biological threat agents using standard, readily available risk assessment procedures. These risk assessments will provide a risk assessment template for responders should an incident occur that mimics the circumstances in the scenario. ECAT allows for the collection 101, evaluation 102, and identification of threat data used to conduct exposure assessment 104 and toxicity assessment 106, to provide risk characterization 108 and determine initial risk management 110 as a way to gain control 112 of any emergency situation. Designed to provide science advice for training and in support of first responders, ECAT provides a basis for initial response to terrorist attacks and control of threat incidents involving chemical and/or biological agents.

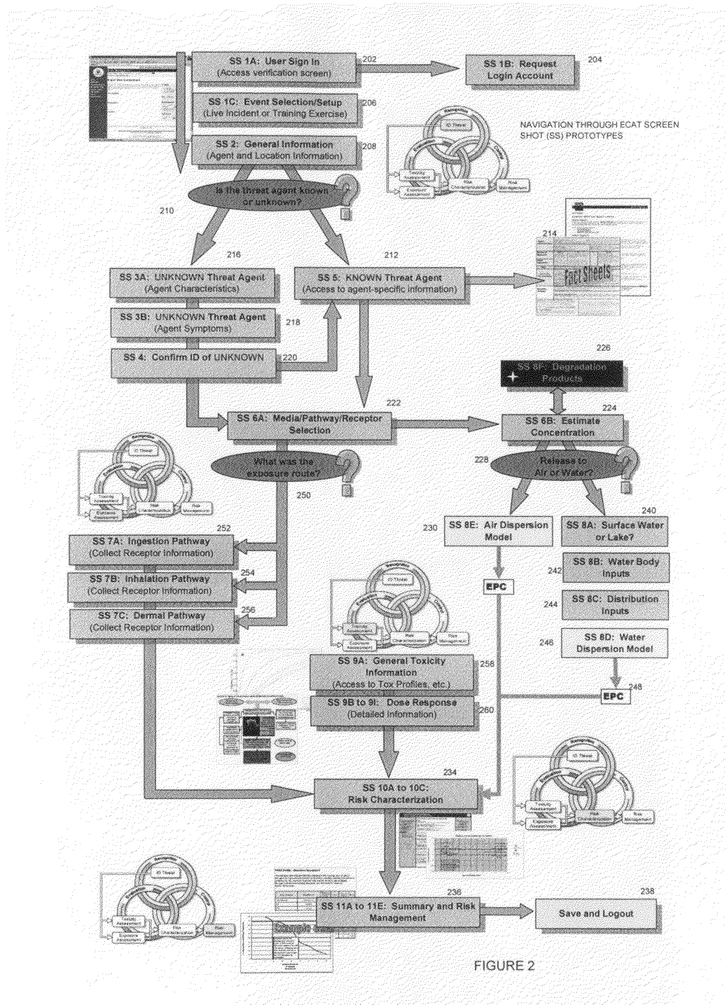

FIG. 2 shows a system flow-chart of the present invention illustrating how major features corresponding to the flow-chart in FIG. 1 is performed in greater detail. Since ECAT is designed to be accessible by a large array of individuals and agencies, it can be made available as a web-based application. To maintain proper control of the integrity of the ECAT system, a login is required prior to use, as shown in step 200. Of course, all users who are able to successfully login the ECAT system already have their information in a login account. Users not yet registered with the login account should request a login account as shown in step 202 before being able to enter the ECAT system. After successfully login to the ECAT system, the user may proceed to an event selection or setup at step 206 of FIG. 2. Within the event selection or setup step 206 may have two categories, one category is for training or exercise purposes to allow concerned individuals to learn how to fully utilize the capabilities of the ECAT system prior to the occurrence of any actual emergency scenarios. The other category is of course for live incident in which the ECAT system is used in actual emergency situations. Made available to the user is general information including agent and location information as shown in step 208.

Before proceeding any further, a determination must be made regarding whether any threat agent causing either a real or mock emergency situation is a known agent or an unknown agent, as shown in step 210. If it is a known threat agent, then specific agent information will be assessed by ECAT as shown in step 212 and provided to the user as shown in step 214. On the other hand, if it is an unknown type of threat agent, then agent characteristics will be gathered, as shown in step 216, and agent-induced symptoms will be gathered, as shown in step 218. Based on the gathered agent characteristics and agent-induced symptoms, an identification of the unknown threat agent will be made, as shown in step 220. After confirming the identity of the threat agent, specific threat agent information will be assessed by ECAT as shown in step 212 and provided to the user as shown in step 214.

In addition to accessing and providing the specific threat agent information to the user, ECAT system also makes or permits the making of a media/pathway/receptor selection, as shown in step 222. Following this selection step, two determinations need to be made. First is estimating a concentration of the threat agent and second is to determine the exposure route of the threat agent. If the path of estimating concentration of the threat agent is taken at step 224, then what naturally follows is to determine whether the threat agent is released to air or water, as shown in step 228. It should be noted that there is an option to permit an interactive communication between estimating concentration in step 224 and degradation products in step 226 before proceeding to determine whether the threat agent is released to air or water in step 228.

If the threat agent is released to air, then an air dispersion model will be used in step 230 followed by an exposure point concentration analysis, as shown in step 232. The exposure point concentration analysis will provide the foundation to arrive at a risk characterization, as shown in step 234. The risk characterization is arrived in consultation with general toxicity information by accessing to Tox profiles as shown in step 258 and dose response as shown in step 260. Thereafter, a summary and risk management recommendation may be rendered, as shown in step 236. The user may then save all information and logout from the ECAT system, as shown in step 238.

If it is determined that the threat agent is released to water in step 228, then a series of information may be gathered, including whether the threat agent is released to surface water or lake in step 240, where are the water body inputs in step 242, where are the distribution inputs in step 244 before a water dispersion model is utilized in step 246, followed by an exposure point concentration analysis, as shown in step 248. The exposure point concentration analysis will provide the foundation to arrive at a risk characterization, as shown in step 234. The risk characterization is arrived in consultation with general toxicity information by accessing to Tox profiles as shown in step 258 and dose response as shown in step 260. Thereafter, a summary and risk management recommendation may be rendered, as shown in step 236. The user may then save all information and logout from the ECAT system, as shown in step 238.

If a step of determining the exposure route is taken at step 250, then a user may either selectively or sequentially provide information regarding ingestion pathway to gather receptor information in step 252, inhalation pathway to gather receptor information in step 254 and dermal pathway to gather receptor information in step 256. From either selectively gathering receptor information or sequentially gathering receptor information, the receptor information will provide the foundation to arrive at a risk characterization, as shown in step 234. The risk characterization is arrived in consultation with general toxicity information by accessing to Tox profiles as shown in step 258 and dose response as shown in step 260. Thereafter, a summary and risk management recommendation may be rendered, as shown in step 236. The user may then save all information and logout from the ECAT system, as shown in step 238.

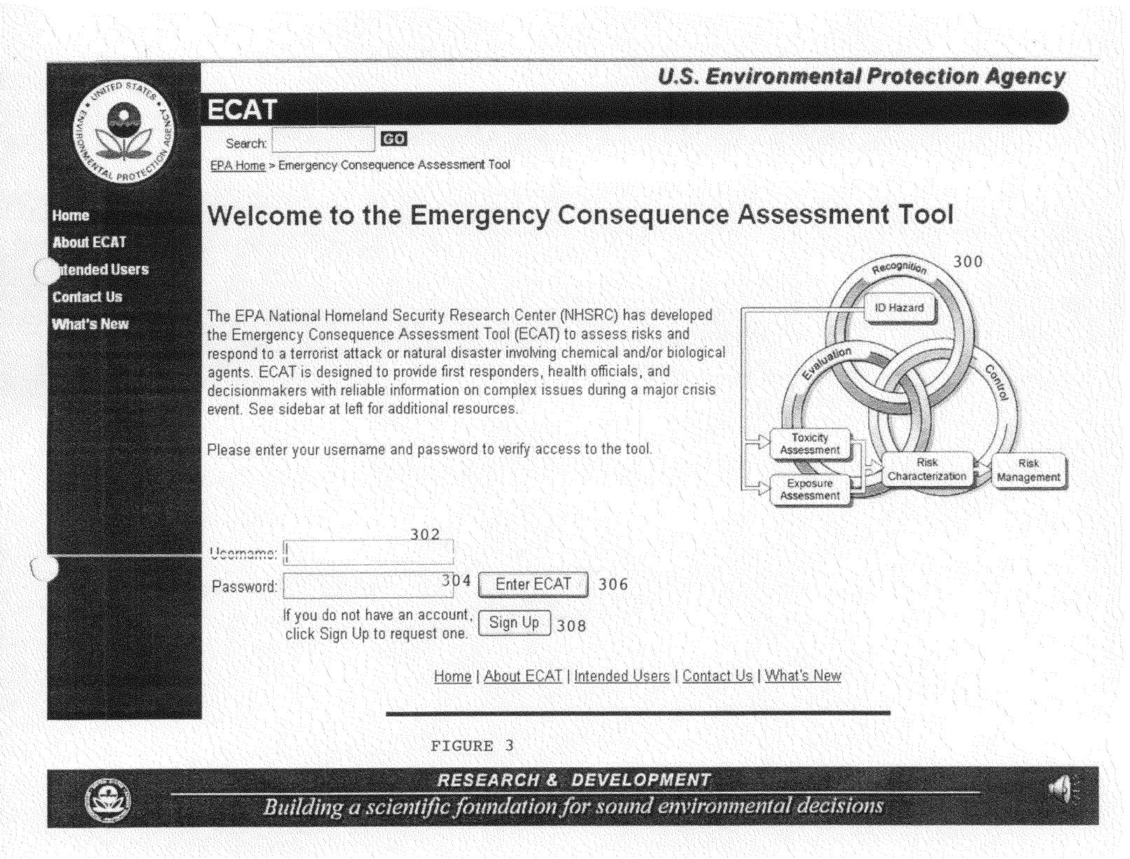

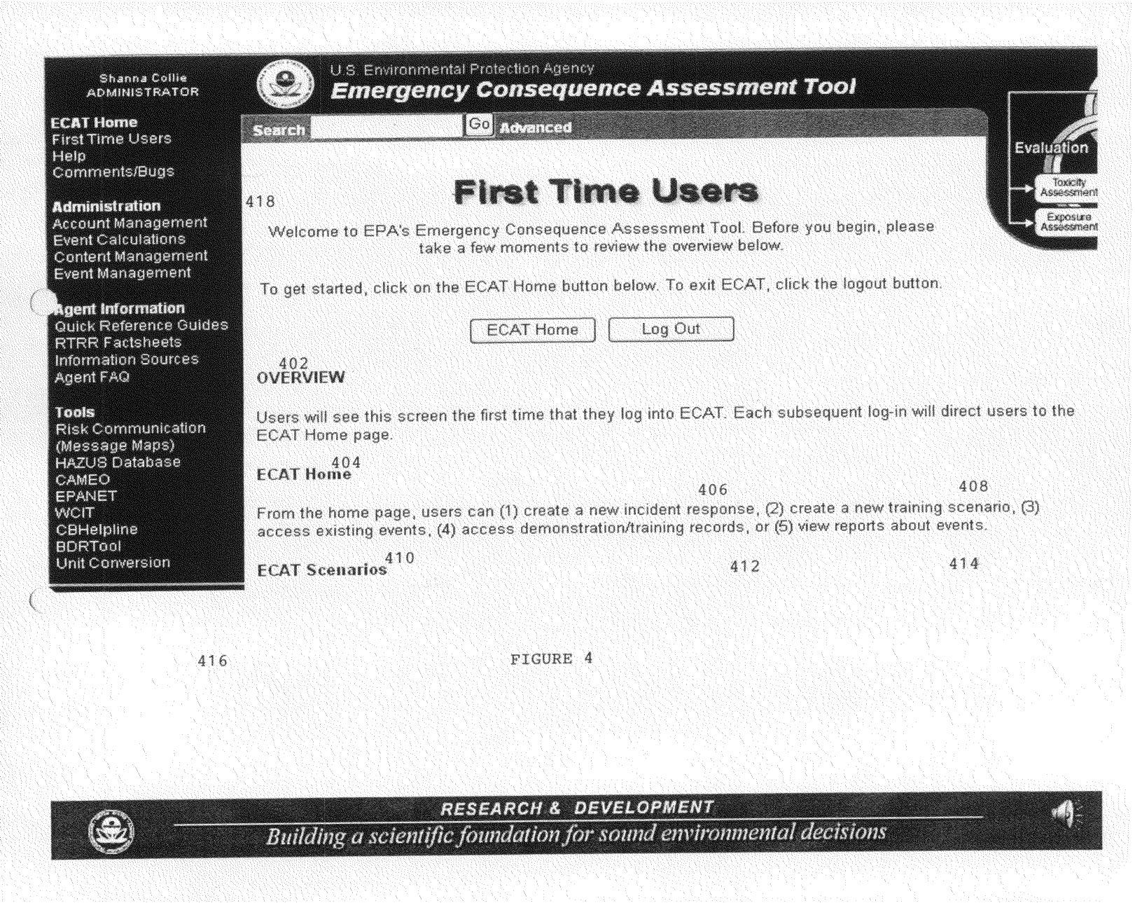

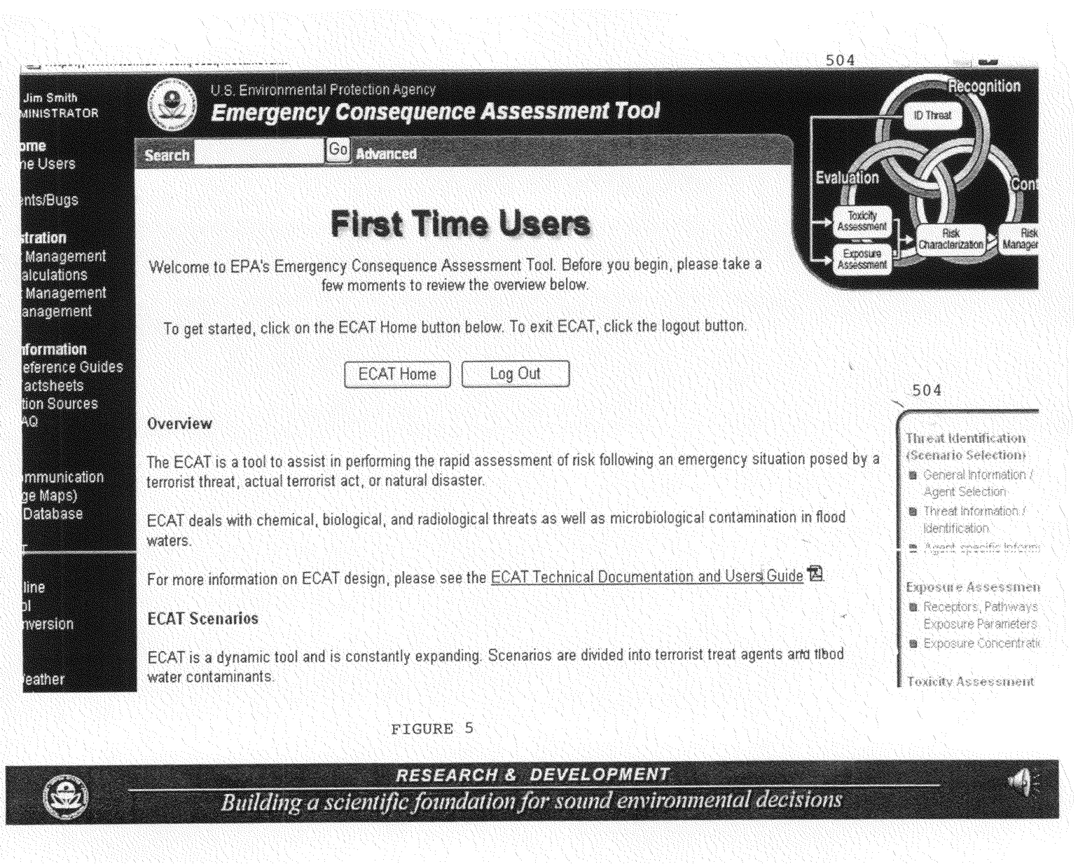

A login screen 300 is shown by way of an example in FIG. 3. As with many web-based assessed systems, after successfully established a login account, a user must be able to present a correct username at prompt 302 and password at prompt 304 before being able to utilize the ECAT system by successfully actuating the Enter ECAT icon 306. If a user does not have an account with the ECAT system, the user may click on the Sign Up icon 308 to initiate establishing an account.

Upon successful login to the system, a User Agreement will be displayed. Users must accept this agreement before continuing the login process and entering the ECAT system. The ECAT User Agreement states by way of an example that access and use of the Emergency Consequence Assessment Tool requires a user ID and password that must be kept confidential at all times. Users of the system must review and abide by the guidelines concerning the maintenance of a user ID, passwords and sensitive information.

New users logging into the ECAT system for the first time are provided additional information to assist in getting started. The following topics are covered on the First Time Users screen. Specifically, topics include Overview of the System 402, Getting Started, Getting Help, Reporting Errors, and User Agreement. Although the First Time Users screen will not display automatically with subsequent logins, the information provided in the First Time Users screen is directly accessible by using the link on the left side menu bar 416.

Subsequent logins will direct users to the Home page 404 allowing them to perform a number of functions including Create a new incident response 406, Create a new training scenario 408, Access existing events 410, Access demonstration/training records 412, and View reports about events 414.

The ECAT system contains three navigation methods which are accessed through the left/right side menu bars 416 and 502, and the interactive ECAT paradigm 504 located at the top of the screen.

The left side menu bar 416 provides links to general information resources, external links, and application functions. The right side menu bar 502 is based on the ECAT paradigm and is event-specific. The ECAT paradigm graphic 504 shows how to access event specific information.

The ECAT system includes a comment tracker for feedbacks about the system and is accessible by selecting the Comments/Bugs link 418 located on the left side menu bar 416. The Comments page allows information on the Type of Feedback, Specific User Information, Description of detected Bug(s). The ability to upload file attachments and screen shots is also available.

The operation of key ECAT system features include saving files, opening files, and printing. On each screen where the user is prompted to enter information, the user is prompted to save the data they have entered. The user can save their data at any point during the input process by selecting the Save and Exit or Save and Continue buttons located at both the top and bottom of the screen.

If the user has saved a live incident or training scenario and wishes to reopen it, the user can do this by going to the scenario selection area of the ECAT Home screen. The user may then click on the View icon shown below to open a scenario. In-progress scenarios may be viewed and edited after opening; completed events may only be viewed.

The user can print the screens they are viewing and can print their results by selecting the “Print-Screen” and “Print-Results” options under the File menu.

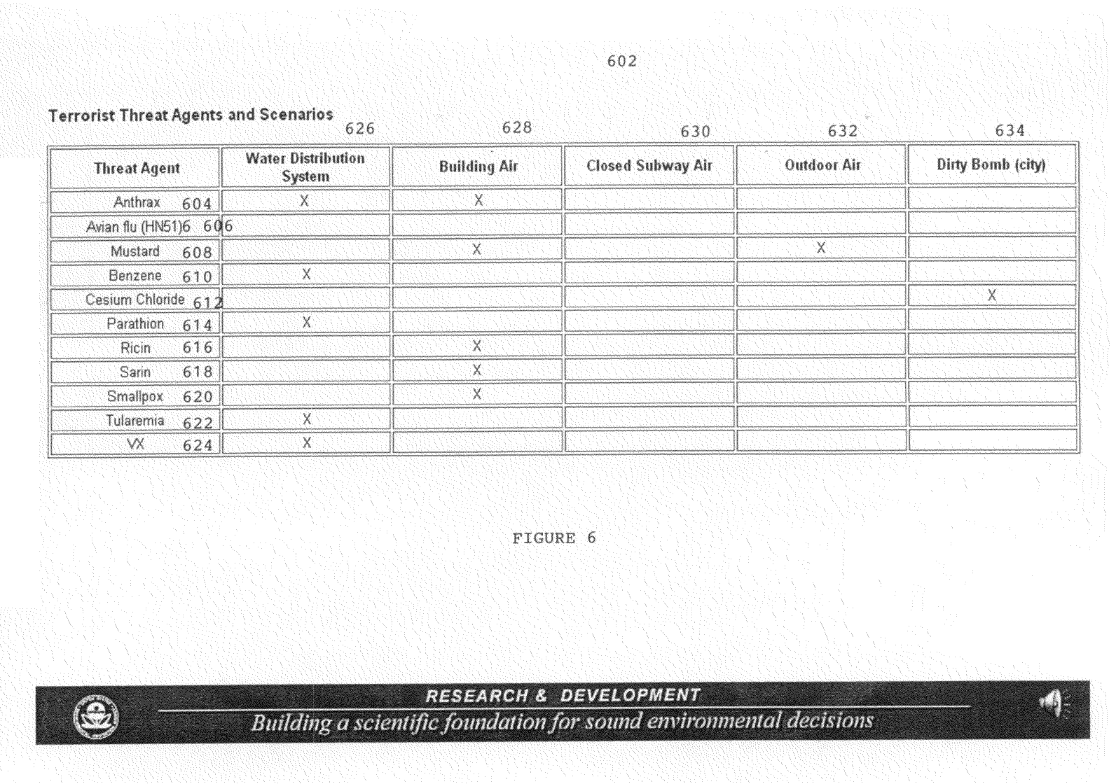

FIG. 6 shows by way of an example an ECAT system screen of a number of possible ECAT scenarios in a table 602. There are shown by way of an example eleven possible scenarios including such threat agents as anthrax 604, avian flu 606, mustard 608, benzene 610, cesium chloride 612, parathion 614, ricin 616, sarin 618, smallpox 620, tularemia 622 and VX 624. These threat agents may possibly be released in water distribution system 626, building airway 628, closed subway airway 630, outdoor air 632 and as a dirty bomb 634 in a city. The number of scenarios may be added at any time.

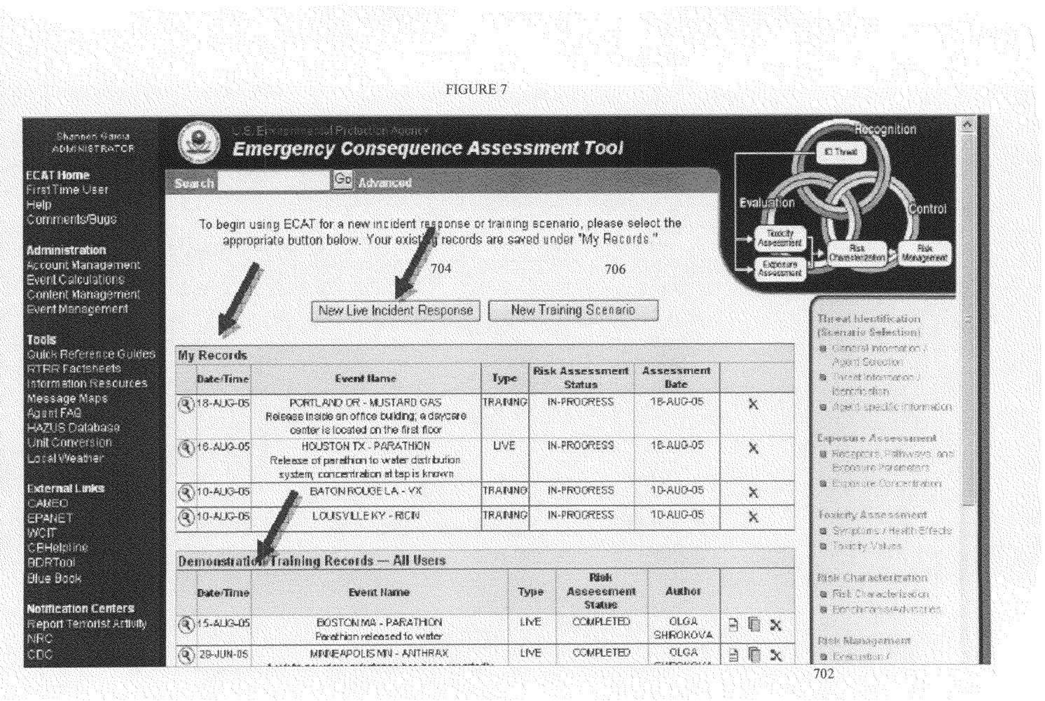

To create a new incident response 704 or training scenario 706, a user must select the appropriate button to get started, as shown in FIG. 7. Records created during this selection are saved under the My Records table. Records in the My Records table are visible only to the user that created them and ECAT system administrators. ECAT system users that are assigned an Administrator designation may make any scenario visible to all users by placing it in the Demonstration/Training Records table, which is visible to all ECAT users.

Icons located in the right-most column 702 allow scenarios to be copied for completed events only or deleted. Reports for completed events may also be viewed. Only an ECAT system Administrator may delete scenarios housed in the Demonstration/Training Records area. In FIG. 7, there are shown features of copy event (completed events only), delete event and view report (completed events only).

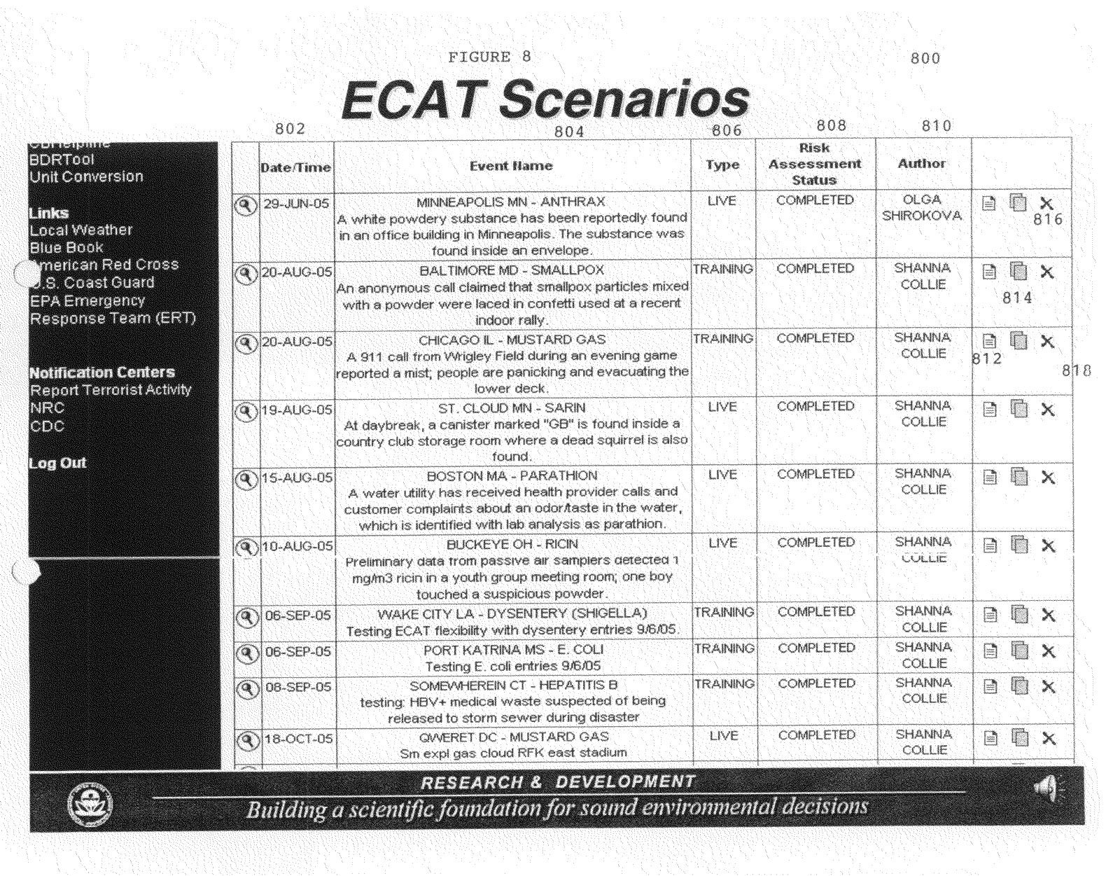

FIG. 8 shows by way of an example some ECAT scenarios in a table 800. Users can view public (demonstration/training records of) scenario where a previous ECAT user has entered assumptions and modeled exposures, then publish the scenario to be shared with EPA colleagues and fellow ECAT users. This feature allows quality control of assumption entry and near real-time adjustment of assumptions for sensitivity analyses and simultaneous assessment.

Table 800 illustrates pertinent details of each scenario showing date/time 802 of the scenario, event name 804, event type 806, risk assessment status 808, and author reporting the scenario 810. On the right hand bar 818, a user may choose to view a scenario 812, copy a scenario 814 or delete a scenario 816. On course, only an administrator may delete a scenario.

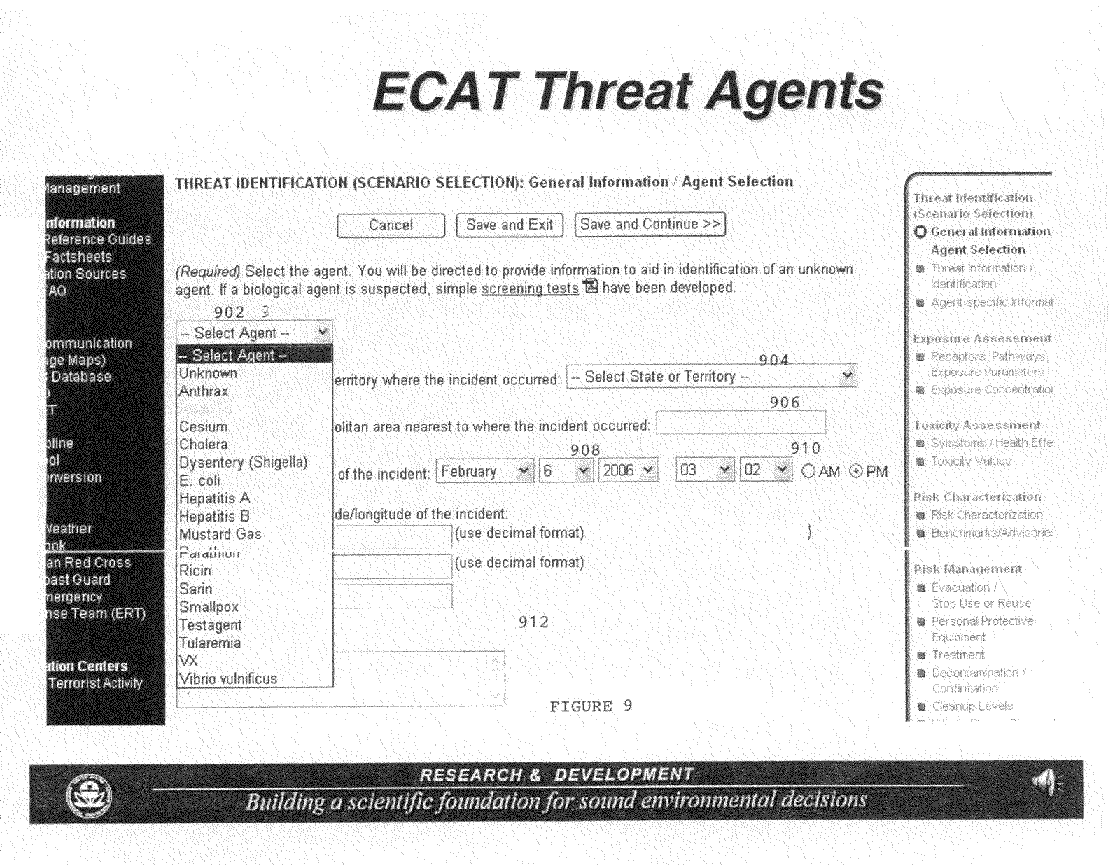

FIG. 9 shows by way of an example an ECAT system screen showing some ECAT threat agents. If a review of a scenario based event in FIG. 8 is not desired, then the user can create a new event for any of a number of prototype CBR threat agents and obtain general information about the selected threat agent.

As part of the threat identification component of ECAT; the user is required to identify the agent at icon 902, specify the location (City and state or territory) where the incident occurred at icon 904, identify the metropolitan area nearest to where the incident occurred at icon 906, specify the date of the incident at icons 908, specify the time the incident occurred at icon 910, and specify the latitude/longitude where the incident occurred at icon 912. The User will also be asked to provide information regarding the agent's physical state, the matrix it was released to (that is air, water, or a solid surface), and any symptoms that have been reported for the exposed population. This information is used to record site-specific information associated with the scenario and to aid in the identification of an unknown agent.

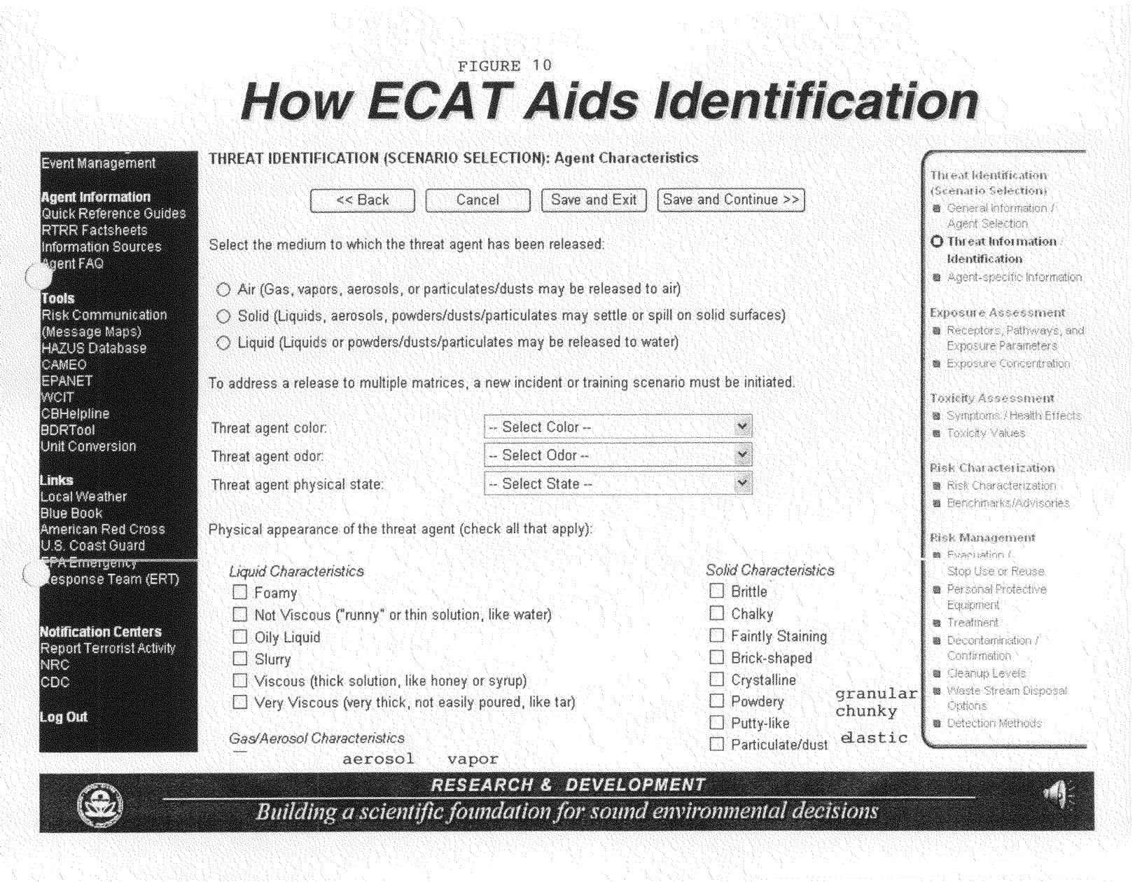

FIG. 10 shows by way of an example an ECAT system screen for agent identification. On this screen, the User is prompted to enter agent-specific information, including the matrix the agent was released into; any noticeable odor or color, its physical state, and its appearance.

Matrix allows users to identify where the threat agent was released into. For example, gases, vapors, and aerosols will generally be released to the air matrix. Dusts/particulates or powders may be released to air, solid surface, or water (liquid) matrices. Liquids may be released to water (liquid) matrix or onto a solid surface.

Users identify the color that best describes the threat agent using a pull-down menu. Users also identify any noticeable odor using a pull-down menu. Finally, users are asked to describe the physical appearance of the threat agent. For example, if it is a solid, is it powdery? Or is it a dust? If it is a liquid, is it thick (viscous) or runny (non-viscous)? Is it a gas or vapor? Or an aerosol? These are all critical information needed to correctly identify the threat agent. After all the physical characteristics are gathered, they are compared to known threat agents in a database.

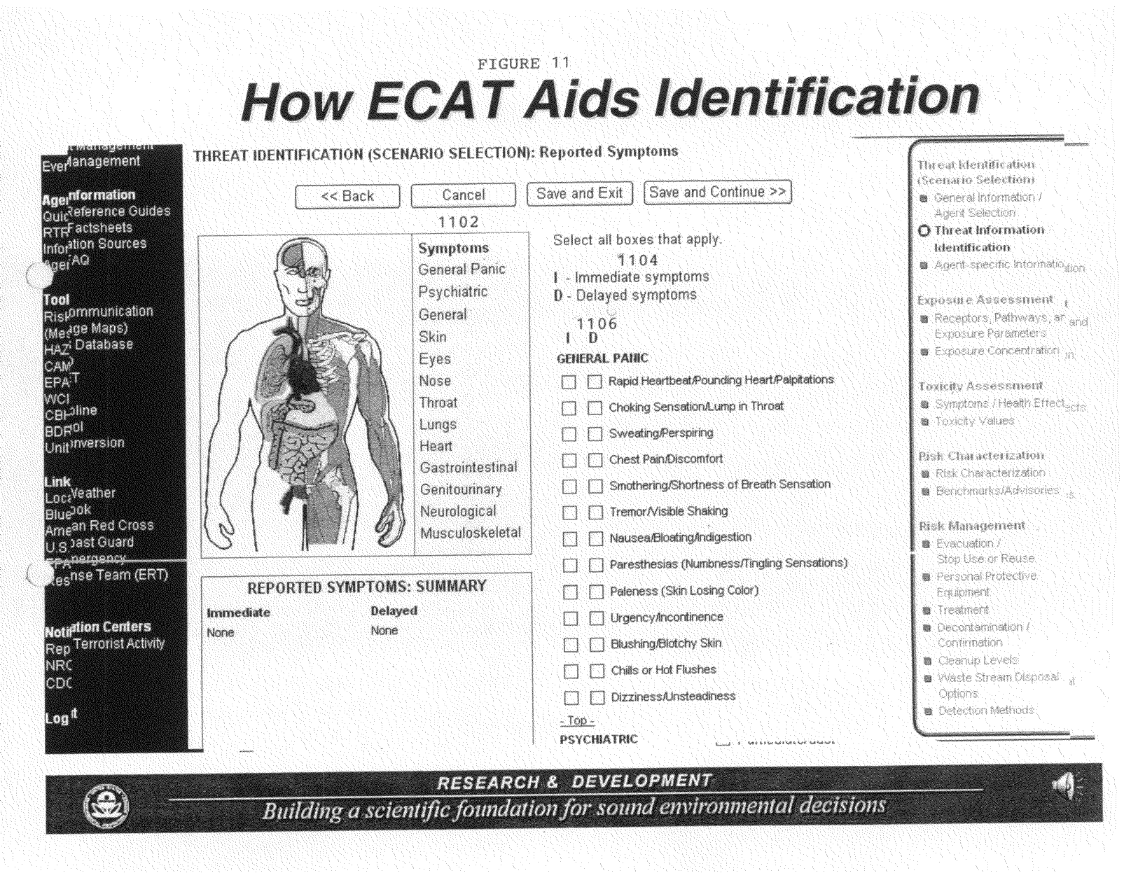

As an effort to correctly identify the threat agent, in addition to collecting characteristics information of the threat agent itself, symptoms caused by the threat agent are also collected. FIG. 11 shows by way of an example an ECAT system screen illustrating how symptoms manifested on a victim is identified and gathered.

On the Reported Symptoms screen, users are asked to describe any symptoms 1102 exhibited by victims. Symptoms are grouped according to target organ or system, for example, eyes or nervous system. Using the radio buttons on the screen, the User may filter symptoms to show all the symptoms in the database or only the agent-specific symptoms.

Symptoms can be selected based on whether they are immediate 1104, that is, occurred immediately after exposure; or whether they are delayed 1106, that is, whether there is a period of time before symptoms appear. For example, exposure to a blister agent such as mustard may result in a blistering of the skin soon after contact usually within 2 hours. However if mustard gas was also inhaled, a respiratory effect such as shortness of breath may not be apparent for up to 12/24 hours later.

Once all symptoms are collected, they are checked against those symptoms in the ECAT database. FIG. 11 actually shows an interactive screen wherein if an agent is suspected, only symptoms related to the suspected agent can be listed to aid in the identification of the threat agent and/or to estimate its dosage.

The physical characteristics of the threat agent in conjunction with symptoms manifested on victims may aid in making a positive identification of the threat agent. An algorithm is used to make the identification. Each of the categories matrix, color, odor, physical appearance, and symptoms described above are assigned an individual score (i.e. 0.2), with the total combined score being equal to 1. These fractions are then displayed on a screen later as a percentage likelihood “match” to inform the user how closely the agent-specific information supplied by the user matches the data in the ECAT database.

For example, users select Matrix=Liquid, Color=Light Brown to Tan, Odor=Rotten Eggs, Physical Appearance=Viscous, and Symptoms=Pin Point Pupils and Muscle Twitches; the database will be queried for possible matches. Each time a match is found for matrix, color, odor, or physical appearance, a score of 0.2 is returned. If a symptom match is found, a score of 0.2 is returned, which is then multiplied by a ratio of the matched symptoms for the agent to the total number of listed symptoms for the agent. For example, a symptom match for “pinpoint pupils” and “muscle twitches” (2 symptoms) out of a total of 4 reported symptoms would return a ratio value of 0.5. This value is then applied to the score returned for finding a symptom match (0.2). In this case, the final score for the symptom match component would be 0.1 (or 0.5×0.2). The scores for all five categories are then added for each agent in the database and expressed as a percentage. ECAT will return the agents with the highest percentage of matched categories.

Users will be informed if no matches are found, and thus no agent was identified as a possible match for the unknown agent. When the ECAT returns a possible match, users are asked to confirm the selection or select the desired threat agent from a pull-down menu.

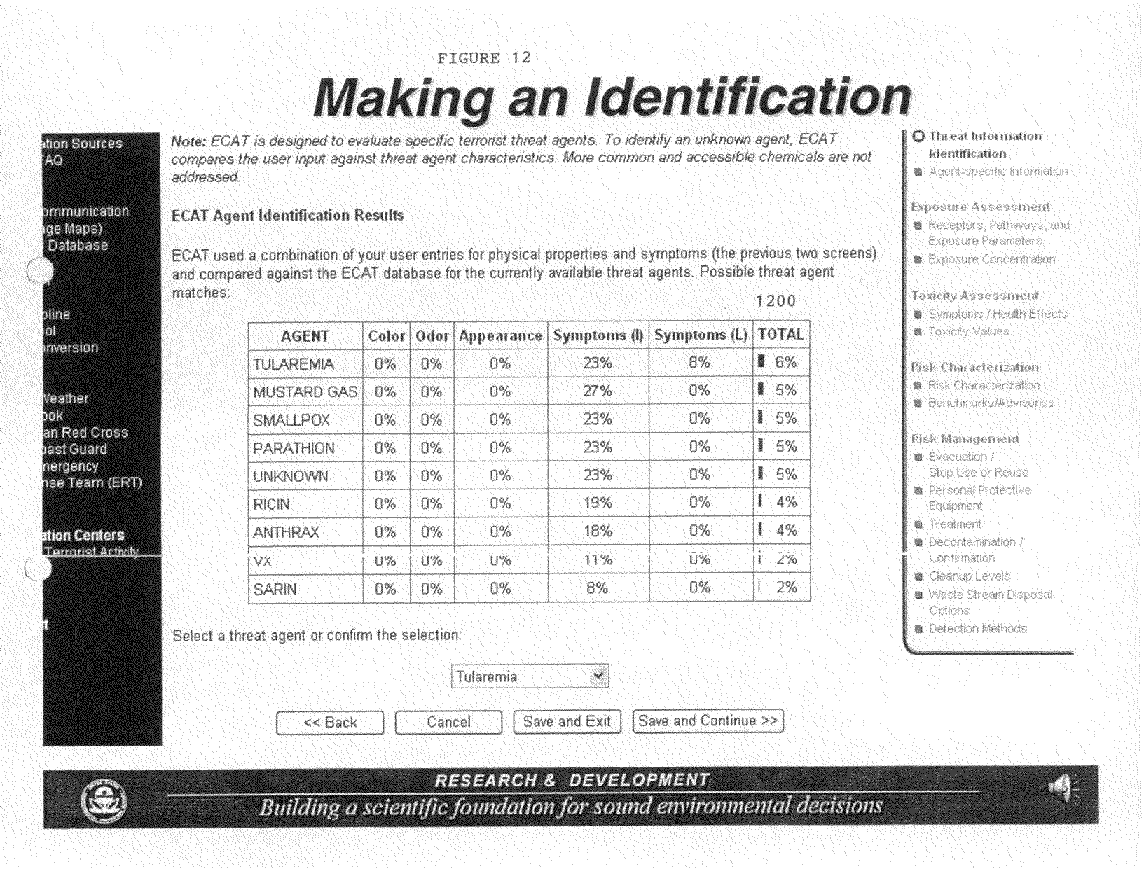

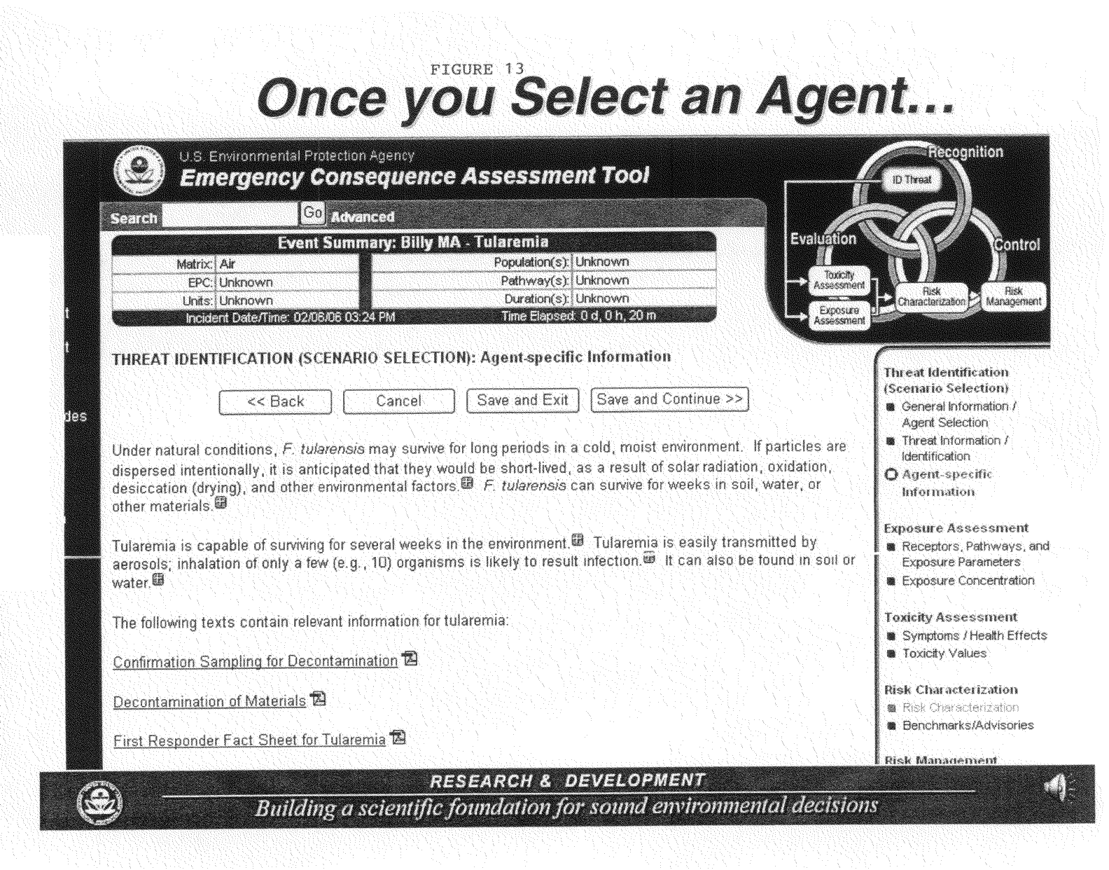

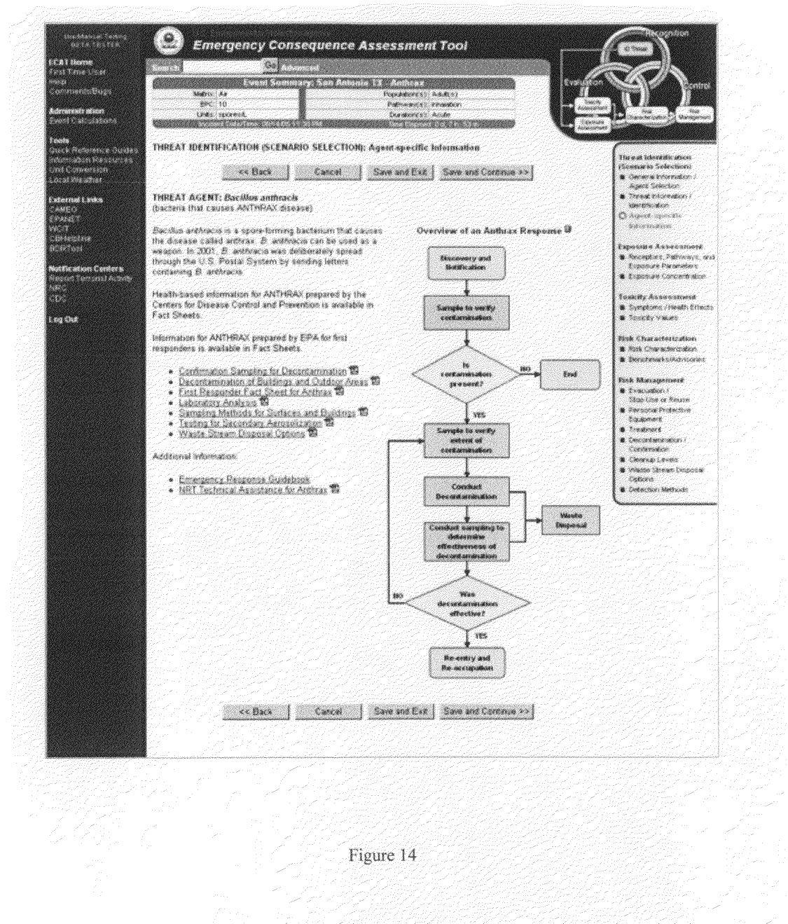

Some match results are shown by way of an example in table 1200 of FIG. 12. ECAT shows the rationale for the match. In this table, no physical parameters were entered, and some symptoms were common to more than one threat agent. The user can override ECAT's choice if the identified agent is not possible. With a threat agent selected either by the user or matched from known symptoms and physical properties, all areas of the ECAT paradigm appearing on the right hand corner and agent specific links become active and are made available using the right navigation bar, as shown by way of an example in FIGS. 13 and 14.

Once a positive identification is made on the threat agent, what follows is to make an exposure assessment. The objective of the exposure assessment is to estimate the type and magnitude of exposure to a threat agent. The results of the exposure assessment are combined with the chemical-specific toxicity information to characterize potential risks. Exposure assessment is the estimation of the magnitude, frequency, duration, and route of exposure. The components of the exposure assessment include:

(1) identification of the exposed population,

(2) identification of exposure pathways,

(3) quantification of exposure parameters, and

(4) quantification of the exposure point concentration.

To calculate the predicted dose or intake of a chemical agent, the user is asked to select pathway-specific exposure parameters, for example, drinking water ingestion rate for an adult or level of activity to determine inhalation rates for each receptor. The intake equation normalizes the dose using a receptor-specific body weight and event-specific time of exposure. Generally, the intake or dose of a particular chemical by a receptor is calculated using the equation:

I=EPC×CR×EF×ED/BW×AT
I=Chemical intake (milligram per kilogram per day [mg/kg-day])
EPC=Exposure point concentration (for example, milligram per liter [mg/L])
CR=Contact rate or the amount of media contacted per event (for example, liters per day [L/day])
EF=Exposure frequency (days per year)
ED=Exposure duration (years)
BW=Average body weight of the receptor (kilograms [kg])
AT=Average time of the exposure (days)
   The EPC term is generated by user input if the concentration at the exposure point, for example, a tap water concentration is known; if the EPC at the exposure point is not known, ECAT can model an EPC in a water distribution line, indoor air or outdoor air using the models. The exposure parameters, which make up the other terms of the equation are used based upon input supplied by the user.

The following sections discuss the components of the exposure assessment, which have been incorporated into ECAT.

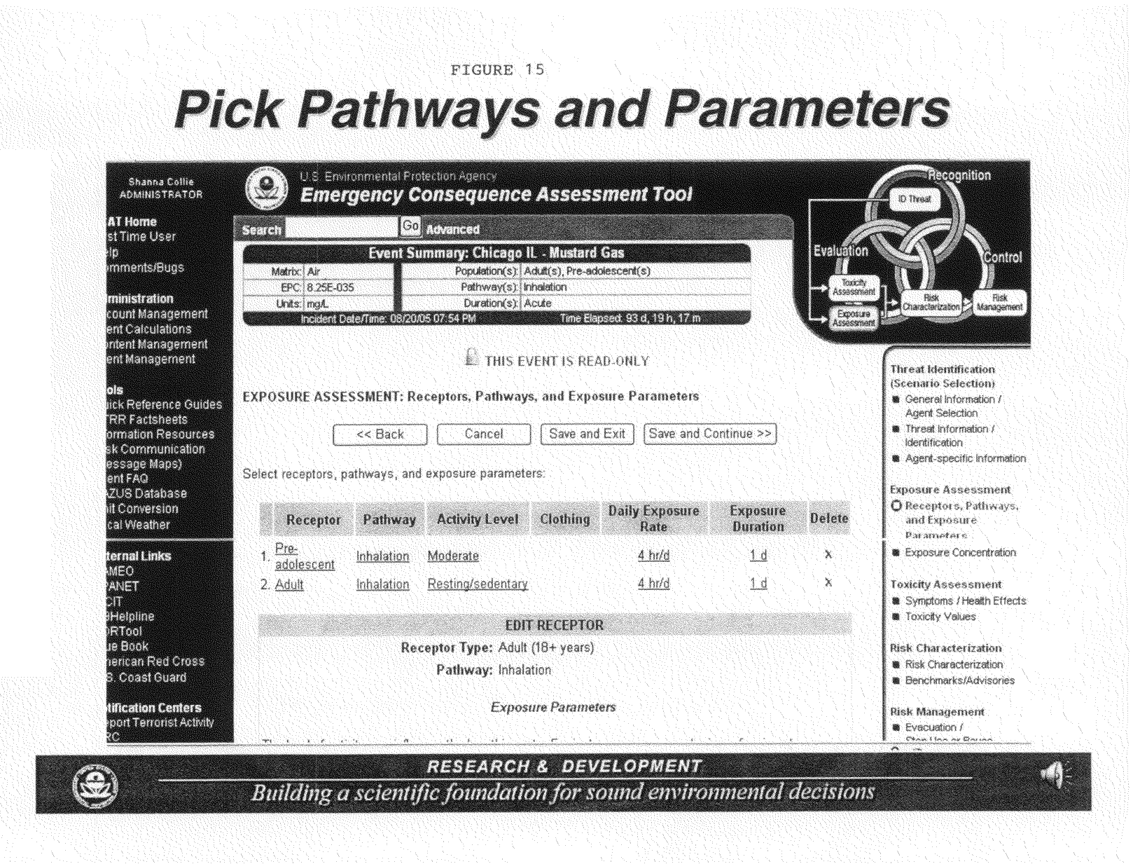

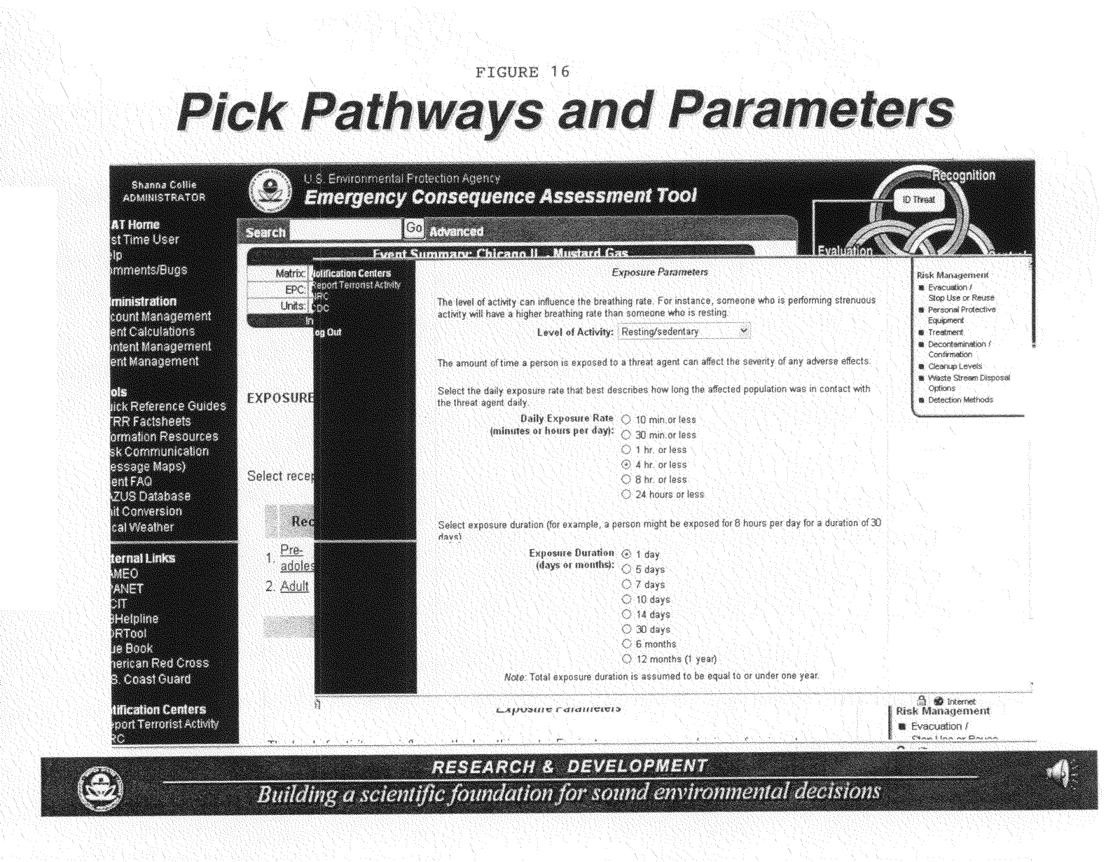

On the exposure assessment Receptors, Pathways, and Exposure Parameters screen of FIG. 15, users are able to select those receptors that best represent the population that was exposed to the threat agent. More than one receptor may be selected. Receptors are selected or added by using the Add New button. A pop-up window will appear that allows the selection of receptors and exposure pathways, as shown in FIG. 16.

The ECAT system is designed to calculate risks for receptors ranging in age from an infant to an adult. Receptors may be selected from the following categories:

Infant, aged 0 to <1 year

Toddler, aged 1 to 3 years of age

Preschooler, aged 4 to 6 years of age

Pre-adolescent, aged 7 to 9 years of age

Adolescent, aged 10 to 12 years of age

Teenager, aged 13 to 18 years of age

Adult, aged >18 years of age.

When selecting a receptor, it is important to note that children may be disproportionally impacted by a threat agent because:

1. they have a higher respiration rate than an adult; therefore, they will receive a higher dosage of vapors or aerosols;

2. they have a higher surface area to body mass ratio; therefore, they will receive a higher absorbed dosage. In addition, their skin is more permeable;

3. their breathing zone is lower to the ground; therefore, they are more vulnerable to dense gases.

Selection of a child receptor is conservatively made and a result tends to indicate maximized exposure. That is, all other parameters being equal such as exposure time and duration, a child receptor would be expected to receive a higher dosage than that of an adult.

On the exposure assessment Receptors, pathways, and Exposure Parameters screen of FIG. 15, users are able to select relevant exposure pathways after the receptor has been selected. The exposure pathway describes the mechanism by which a receptor is exposed to a chemical or biological threat agent. Exposure pathways are identified based on consideration of the source such as whether the agent was released to air or water and environmental condition such as whether the chemical is volatile or soluble in water.

ECAT is designed to address scenarios that include threat agents that have been released to indoor air within an office building, drinking water within a public water supply system, outdoor air in a stadium setting, subway system and metropolitan area. The following exposure pathways may be selected using the Select Exposure Route pull-down menu:

1. Inhalation: Threat agents released to air as a gas, vapor, mist, or aerosol may be inhaled. In addition, chemical threat agents in either liquid or solid form that are sufficiently volatile may volatilize to air and be inhaled. Dusts and particulate material may also be inhaled from air;

2. Ingestion: Threat agents released to a drinking water source may be ingested;

3. Dermal Contact: Threat agents released to a water supply that is used for household tap water may come in contact with skin during bathing/showering. In addition, gases, vapors, mists, and aerosols may come in contact with skin. Threat agents in the solid or liquid state may also come in contact with skin.

The next step in the exposure assessment process is to quantify the magnitude, frequency, and duration of exposure for the receptor(s) and pathway(s) selected. Exposure is defined as contact with a chemical or biological agent. Exposure maybe estimated by determining how much of an agent a receptor contacts. Exposure is a function of body weight, exposure time and duration, and contact rate such as an ingestion or inhalation rate.

Receptor and scenario specific parameters used to estimate exposure are discussed hereinbelow.

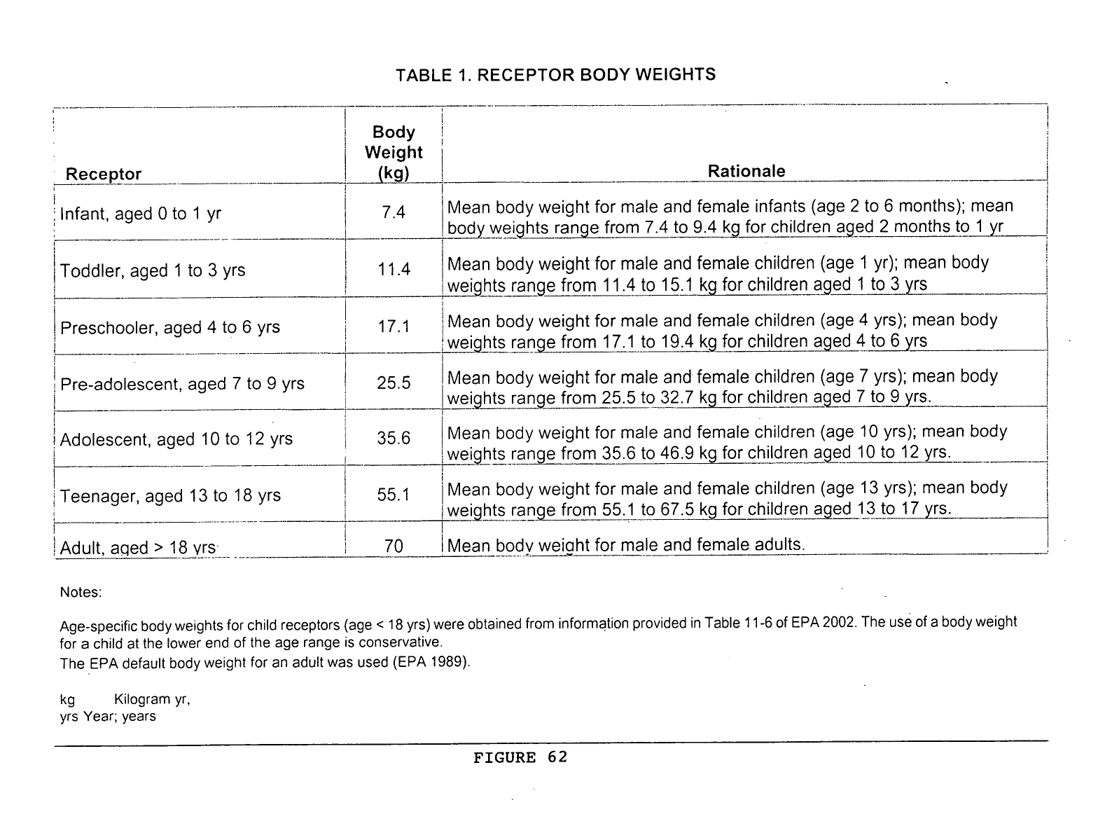

Body weights were determined for each receptor included in ECAT based on information provided in EPA's Exposure Factors Handbook (EPA 1997), Child specific Exposure Factors Handbook (EPA 2002), and Risk Assessment Guidance for Superfund (RAGS) Part A (EPA 1989). These handbooks are incorporated herein by reference. Age-specific body weights included in the ECAT are presented in Table 1 of FIG. 62.

As shown in Table 1, the body weight selected for each receptor represents the mean body weight for males and females. For children, a body weight for a child representing the lower end of the age range was used. For example, the mean body weight for a child aged 4 to 5 was used to represent the preschooler (aged 4 to 6); use of a lower body weight is conservative.

The amount of time a receptor is exposed to a threat agent, that is the amount of time a receptor is exposed on a daily basis (exposure time) and the duration over which the exposure occurs (exposure duration), must be specified in order to estimate risk. How long a receptor is being exposed to the threat agent may affect the severity of any adverse effects.

Exposure times are selected by users for the inhalation and dermal contact scenarios. These time frames estimate how long the receptor may have been exposed to the threat agent each day. For example, how long did they breathe contaminated air? Or how long was the agent on their skin? Selections include less than 10 or 30 minutes, and less than 1, 4, 8, or 24 hours. Exposure durations defined in recent NHSRC advisory level development documents include:

Acute: single dose or exposure up to 1 day;

Short-term: exposure from 1 to 30 days;

Intermediate: exposure from 1 to 365 days;

Subchronic: exposure from 1 to 7 years;

Chronic: long-term exposure or lifetime exposure.

For the exposure duration, users may select exposure durations of 1, 5, 7, 10, 14, and 30 days; 6 months; or 12 months (1 year). Because ECAT is designed to address a threat agent scenario, it is expected that exposure to the threat agent would not continue on a long-term or chronic basis; that is, emergency control measures such as evacuation or engineering controls would be taken to eliminate or greatly decrease the chance of exposure over a long period of time. Therefore, ECAT does not address exposure durations greater than 1 year.

Longer exposure times and/or durations are conservative, that is, they maximize exposure.

Selections for exposure time (dermal contact and inhalation pathways) and exposure duration are accessed from the receptor and exposure pathway selection window; the possible selections become available after the receptor and exposure pathway has been selected.

Inhalation Rates

ECAT includes scenarios that involve the direct release of a threat agent to indoor air (for example, inside an office building) or outdoor air (for example, at a sport stadium). ECAT also includes a scenario that addresses the release of a threat agent to a water supply system; volatile chemicals could be released to indoor air during household use of tap water. The estimation of the applied dose for a threat agent in air is dependent on the inhalation (or breathing) rate. Breathing rates are affected by numerous receptor characteristics, including age, gender, weight, health status, and level of activity (EPA 1989).

ECAT allows users to select a receptor based on age; age-appropriate, conservative body weights have been assigned to the receptors. As activity levels can affect the amount of air inhaled, and thus the amount of exposure to a threat agent, ECAT allows users to specify a level of activity for short-term exposures (for example, a few hours). For example, a person who is exercising heavily would be expected to have a higher inhalation rate than a person who is resting. The following activity levels are described by EPA (1997, 2002):
Resting/sedentary: This level of activity can be defined by activities such as lying down, sitting or standing
Light: This level of activity can be defined by slow walking (or walking at a normal pace; 1.5 to 3.0 miles per hour [mph]); another example might be light housework
Moderate: This level of activity can be defined by fast walking (3.3 to 4.0 mph) to slow running (3.5 to 4.0 mph); other examples might be children at play or yard work (adults)
Heavy: This level of activity can be defined by fast running (4.5 to 6.0 mph) or other similar strenuous exercise.

Age-appropriate inhalation rates are included in ECAT for the activity levels listed above. As discussed above, additional considerations should be taken into account for children when estimating risks via the inhalation pathway. Children may be more highly exposed via the inhalation pathway than adults because children have a higher resting metabolic rate and rate of oxygen consumption per unit body weight than adults. In a comparison between infants and adults at a resting state, twice the volume of air passed through an infant's lungs compared to an adult's lungs (EPA 2002).

In addition to inhalation rates associated with specific activity levels, age-specific inhalation rates that address varying levels of activity over the course of a day are included. For instance, a receptor that is exposed to a threat agent in air for an entire day may perform activities such as sitting, walking, or exercising.

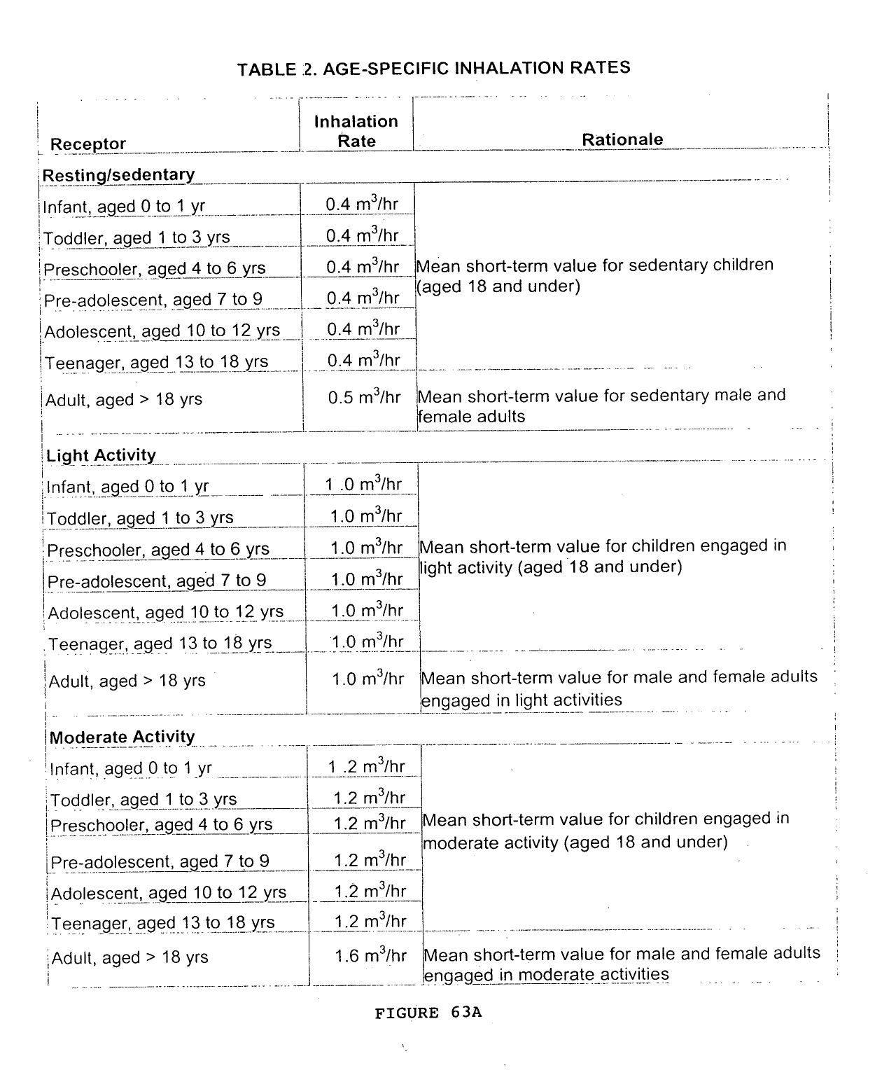

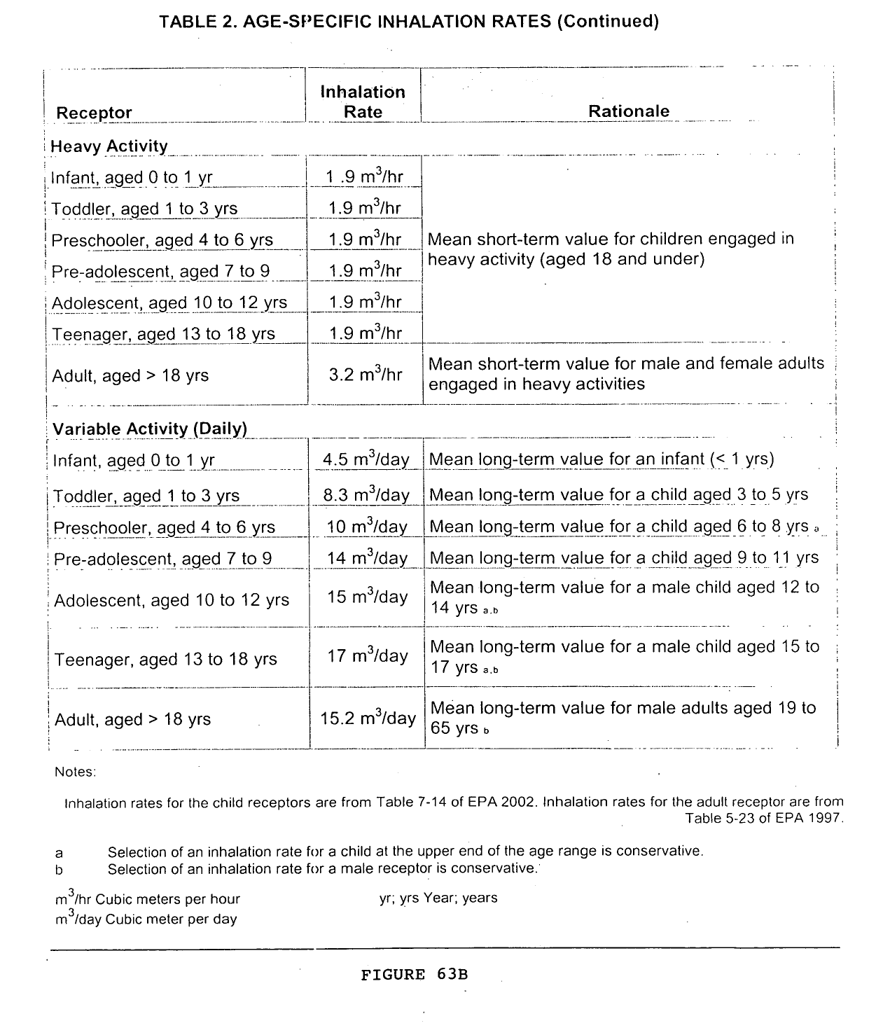

Inhalation rates for each receptor included in ECAT were determined based on information provided in EPA's Exposure Factors Handbook (EPA 1999) and Child-specific Exposure Factors Handbook (EPA 2002). This Handbook is incorporated herein by reference. Receptor-specific inhalation rates used to estimate exposure in ECAT are presented in a table in FIGS. 63A and 63B.

Drinking Water Ingestion Rates

ECAT includes a scenario involving the release of a threat agent to a drinking water supply system. In this scenario, receptors may come in contact with a threat agent through the use of tap water as a drinking water source. The amount of water ingested may affect the severity of any adverse effects.

If users specify that the threat agent was released to water and have selected the ingestion pathway, users will then be prompted to select the approximate amount of water consumed each day (or the daily drinking water ingestion rate) by the receptor. Selections include:
One cup/day
3 cups/day
1 L/day; EPA default drinking water ingestion rate for a child age 0 to 6 years of age; approximately 1 quart)
1.4 L/day (mean drinking water ingestion rate for adults [Table 3-30 of EPA 1997]; approximately 6 cups)
2 L/day (EPA default drinking water ingestion rate for an adult; approximately 8 cups)
5 L/day (Military default drinking water ingestion rate for an adult)

Default ingestion rates are preselected, that is, if a child receptor is selected, a default value of 1 L/day is used; if an adult receptor is selected, a default value of 2 L/day is selected. The user may override the default selections to choose a more appropriate ingestion rate from the choices listed. Higher ingestion rates are conservative, that is, higher ingestion rates maximize exposure.

Amount of Exposed Skin Surface Area

Threat agents released to either air or water may come in contact with skin.

Parameters that affect the amount of the agent that is absorbed through the skin include the amount of skin surface area in contact with the agent and the amount of time that the agent is in contact with the skin.

After the dermal contact pathway is selected as the exposure route, in order to estimate the amount of exposed skin surface area, users are asked to describe the type of clothing worn by the affected receptor. Clothing options are selected using radio buttons; options for upper body and lower body and the corresponding exposed skin areas are presented below.

Upper Body Clothing Selection

Shirtless

Short-sleeved or sleeveless shirt

Long-sleeved shirt

Lower Body Clothing Selection

Long pants

Shorts

Skirt

Corresponding Exposed Skin Area

Head, trunk, arms, hands

Head, arms, hands

Head and hands

Corresponding Exposed Skin Area

None (Legs are completely covered) Legs (Male or Female) Legs (Female)

In addition, a “Hands Only” selection is available to address an instance where only the hands came in contact with the threat agent—for instance, during hand washing activities or while opening a contaminated package.

For agents that can penetrate clothing (for example, mustard gas), an “Entire Body” selection is available, which assumes all skin may come in contact with the agent. Selection of “Entire Body” is conservative as it maximizes the amount of exposed skin surface area.

Similar to the inhalation pathway, children may also be more highly exposed than an adult via the dermal contact pathway. Due to the relatively small size of children, they have a higher body surface area relative to body weight, which is inversely proportional to age. For example, newborn infants have a surface area-to-body weight ratio that is more than two times greater than that for adults (Cohen-Hubal and others 1999 as cited in EPA 2002). Therefore, selection of a child receptor is usually a conservative choice.

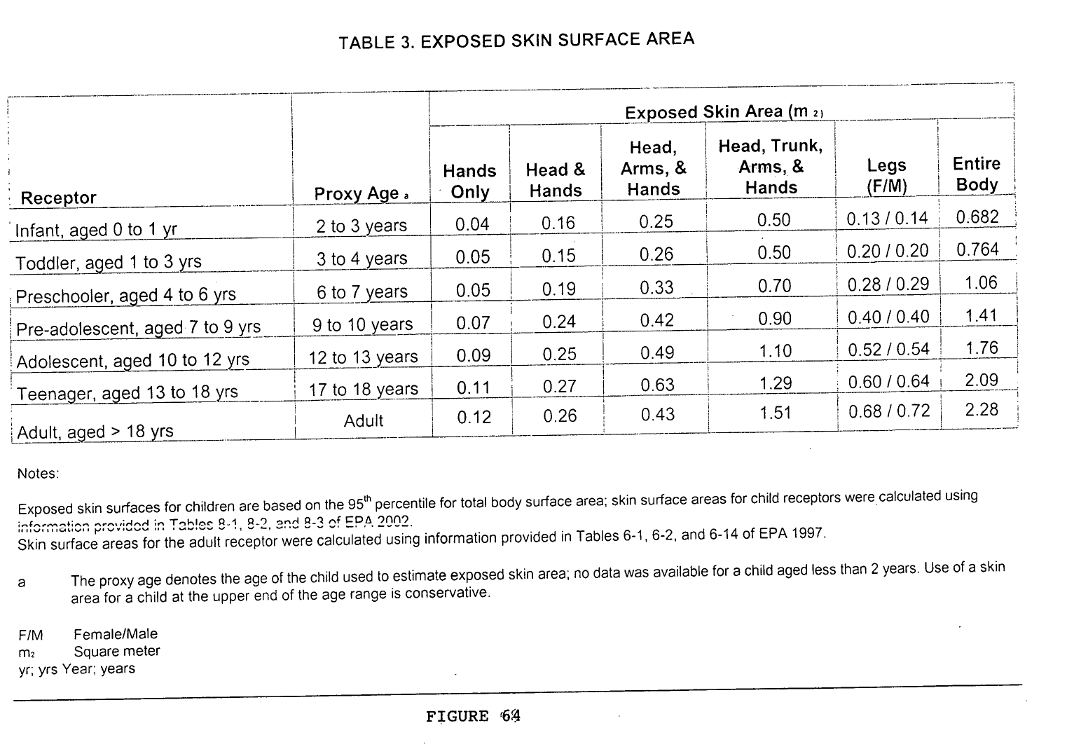

Skin surface areas for each receptor included in ECAT were determined based on information provided in EPA's Exposure Factors Handbook (EPA 1999) and Child-specific Exposure Factors Handbook (EPA 2002). This Handbook is incorporated herein by reference. Receptor-specific skin surface areas corresponding to the clothing selections discussed above are presented in a table in FIG. 64.

### Quantitation of the Exposure Point Concentration

The ECAT scenarios include releases to a water distribution system, indoor air (building air and subway train air), Stadium air (indoor and outdoor stadium air), and radiologic exposure from a detonated or undetonated dirty bomb. In order to quantify risk, an EPC must be estimated. ECAT will perform calculations to determine an EPC when a threat agent is released to water or air. The EPC will then be used as input to the risk assessment calculations.

On the EXPOSURE ASSESSMENT: Exposure Concentration screen the user is asked if EPC measurements (for example, concentration data) are available. The following selection options are available.
Yes, EPC measurements are available: The user should input the numerical concentration value and select the appropriate units from the pull-down menu.
No, EPC measurements are not available (EPC will be modeled): The user will then be guided through a series of screens to collect information that can be used in the water or air models, as appropriate.
Skip EPC measurement: The user may select this option to skip the EPC estimation step and move directly to the remainder of the agent-specific information housed in ECAT.

In order to calculate or model an EPC, the user will be asked to provide information that can be used to estimate the initial concentration that was released to the water distribution system.
Quantity/Container Size (Required): The user is asked to input a value corresponding to the estimated quantity that was released (for example, a 55-gallon drum dumped into a water distribution system). Units are selected from a pull-down menu. A link to common container (for example, a railroad car or tanker trailer) sizes is provided for ease of reference.
Initial Concentration (Optional): The user may input an initial concentration, if known. For example, it is known that a 55-gallon drum of material containing parathion at a concentration of 25 mg/L was released to the water distribution system.

The following sections describe the calculations and input used to model an EPC for a water scenario, the calculations and input used to model an EPC for an indoor air and outdoor (stadium) air scenario. When a threat agent is released, its physical/chemical properties (for example, vapor pressure or solubility) as well as fate and transport mechanisms (for example, dispersion, dilution) will affect the concentration at an exposure point (that is, tap water in a home 1 mile from the water treatment plant).

Calculation of an Exposure Point Concentration for a Water Scenario

The following sections describe the calculations and input used to estimate an EPC for use in the risk calculations when a threat agent is released to a water distribution system. Speed and simplicity are critical. It does not constitute a model of the raw water, treatment process, or distribution system. The myriad of physical and operational phenomena in water treatment have, in many cases, been simulated by simple first-order, linear equations. The complexity of flow in a distribution system, for example, is replaced with a simple distance-divided-by velocity calculation. As such, it is important that the risk manager have a clear idea of how these equations area applied and what constitutes the correct input. This may require review of certain input with water-treatment plant and distribution system engineers. The following sections describe the background information to support the water dispersion modeling function of the ECAT.

Skipping the Water Dispersion Model and Applying Dilution Factor

If users do not wish to go through the steps of the water model to determine an approximate concentration, they can choose to simply apply a dilution factor to the initial concentration. If users choose to skip the model, the initial concentration will simply be divided by the dilution factor chosen by users to calculate the approximate EPC (that is, the concentration at the tap of the nearest user). Users will also have the ability to apply their own dilution factor, if it is different from those available in the pull-down menu.

Origin of Contamination

Initially the User is asked to supply an initial quantity or concentration of agent that will be assessed. Next the User is given a chance to either run the water model in ECAT or just apply a dilution factor to the initial concentration.

If the User chooses to run the model, they are given four choices to address the introduction of the agent at a point upstream of the water treatment system:
1. River prior to water treatment plant.
2. Water treatment plant intake
3. After the water treatment plant Clearwells
4. Directly into distribution system

The introduction points are “downstream” of each other with point 1 (River prior to water treatment plant) being the point farthest upstream and points 2 through 4 being closer to the distribution system. The closer to the distribution system the introduction of the threat agent occurs, the more negative the potential impact on the public (that is, more contaminant may reach the public).

The calculations for each of the introduction points are the same, except only those modules downstream of the introduction point are used. For introduction point 3, “After the water treatment plant Clearwells”, it is assumed that an agent would not be introduced randomly at a water treatment plant, but rather at its most critical point downstream of the Clearwells. For introduction point 4, “Directly into distribution system”, introduction would be into a single pipe in the distribution system.

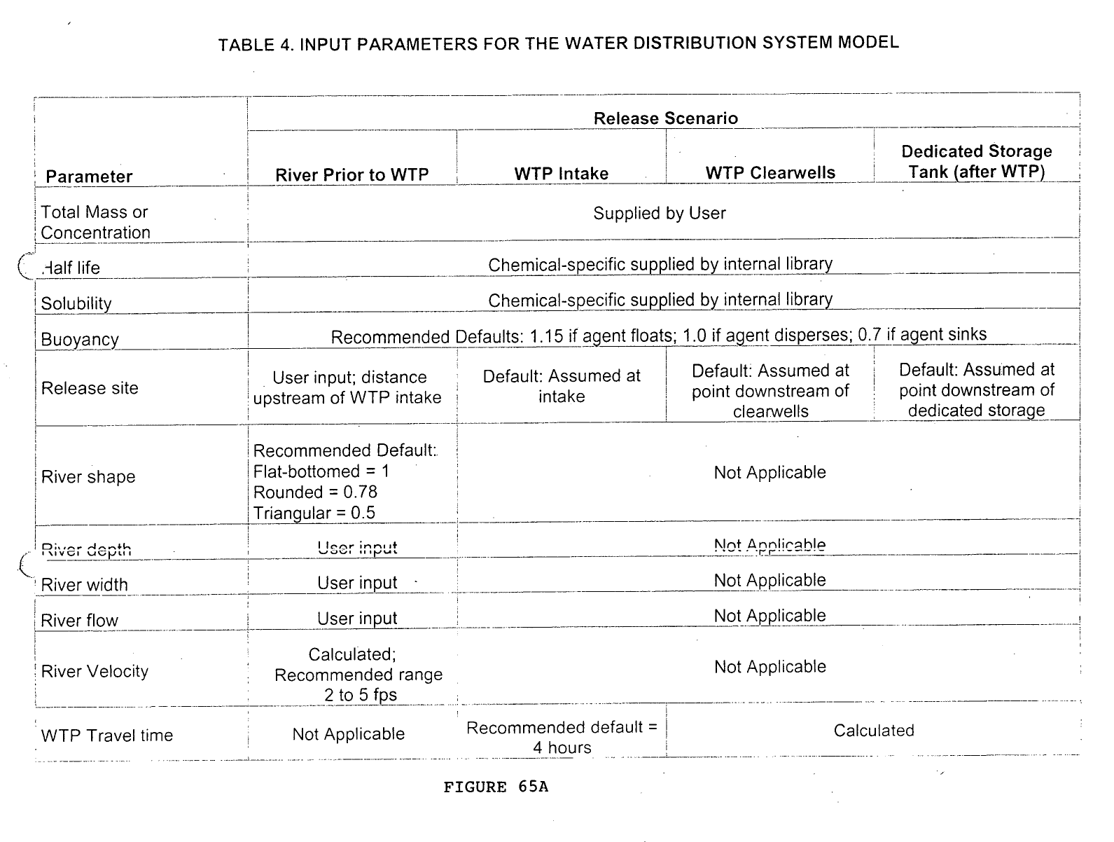

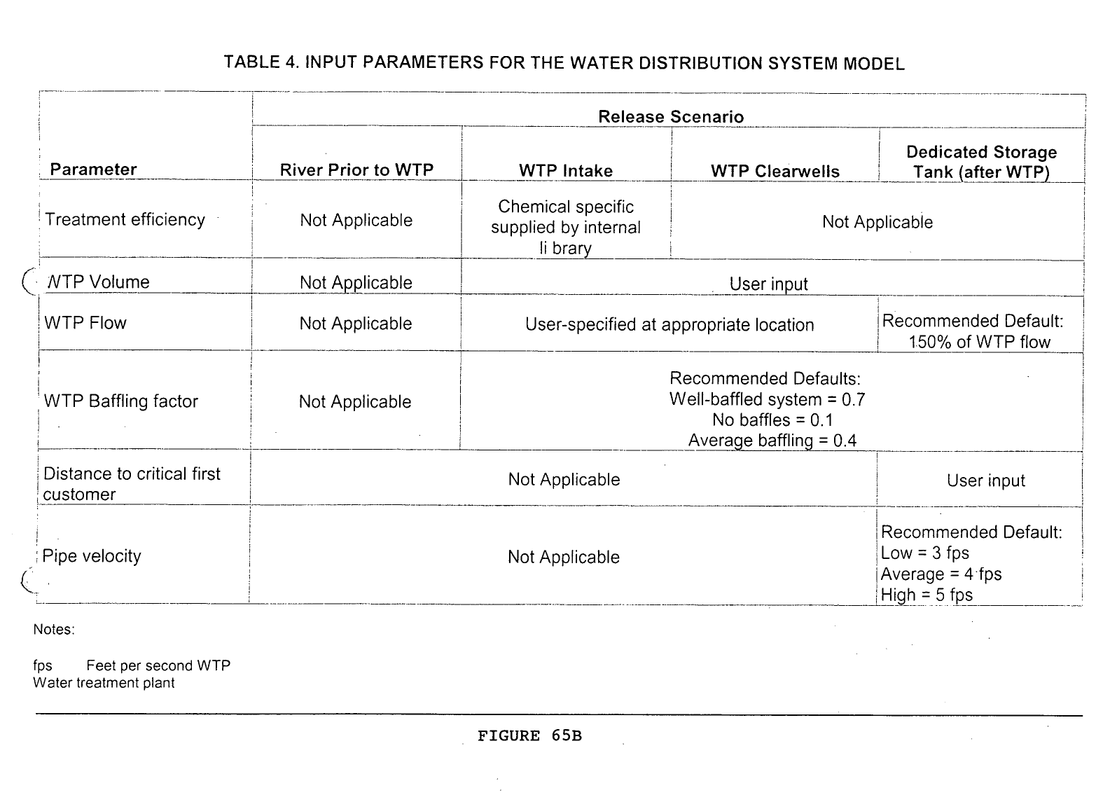

FIGS. 65A and 65B provide a table regarding the input parameters for the water distribution system model.

Selecting Water Body Scenario to Determine Default Value for Water Velocity (μ) and Assumptions for Model (“River prior to water treatment plant” only)

It is necessary to determine the velocity (p) of a water body as a primary step in calculating the agent's residence time. If flow rate is known, the velocity can be calculated from the flow rate (see below). Real time stream flow (as well as gauge height) data are available for several rivers and streams online at the United States Geographical Survey's website (http://waterdata.usgs.gov/nwis/rt). In addition, most WTP operators that draw from streams or rivers are very aware of the streamflow at their intakes. They generally will have a staff gauge at the intake and a rating curve to convert to flow. However, flow rate data are not available for every stream or river, and, in these cases, it would be necessary for users to choose a default water velocity based on a general description of the waterway.

Calculating Time Decay Based on Time of Travel (t) for Each Model Component

Over time, the initial mass of an agent in water will be reduced due to biodegradation. This exponential decay is applied to each of the model components: river, water treatment plant, clearwells, and dedicated storage.

Time of travel determines the secondary mass of the agent using the following equation:

M=(M₀)×exp^{-kt}

WHERE:
M=Secondary mass of the agent (milligrams [mg])
M₀=Initial mass of the agent (mg)
k=Decay coefficient (0.693/t_{1/2})
t_{1/2}=Half life of the agent (seconds)
t=Time of travel across model component (seconds)

The agent half life is supplied by the program based on the agent selected. Applying Treatment Factor (Water Treatment Plant only)

WTPs are designed with several processes to remove common contaminants. These same processes would also remove portions of a threat agent. The water dispersion model accounts for these processes and adjusts the concentrations accordingly.

Methods of water treatment vary in different communities, but typically the following treatment processes are used in drinking WTPs: coagulation/flocculation, sedimentation, sand filtration, and disinfection (EPA 2000). According to the American Water Works Association (AWWA 1990), coagulation, sedimentation, and filtration are 60 to 100 percent effective at removing bacteria, viruses, and volatile organic compounds (VOC) and 0 to 20 percent effective at removing semivolatile organic compounds (SVOC) from the water supply. In addition, disinfection is 90 to 100 percent effective at removing bacteria and viruses and 0 to 90 percent effective at removing VOCs and SVOCs from the water supply.

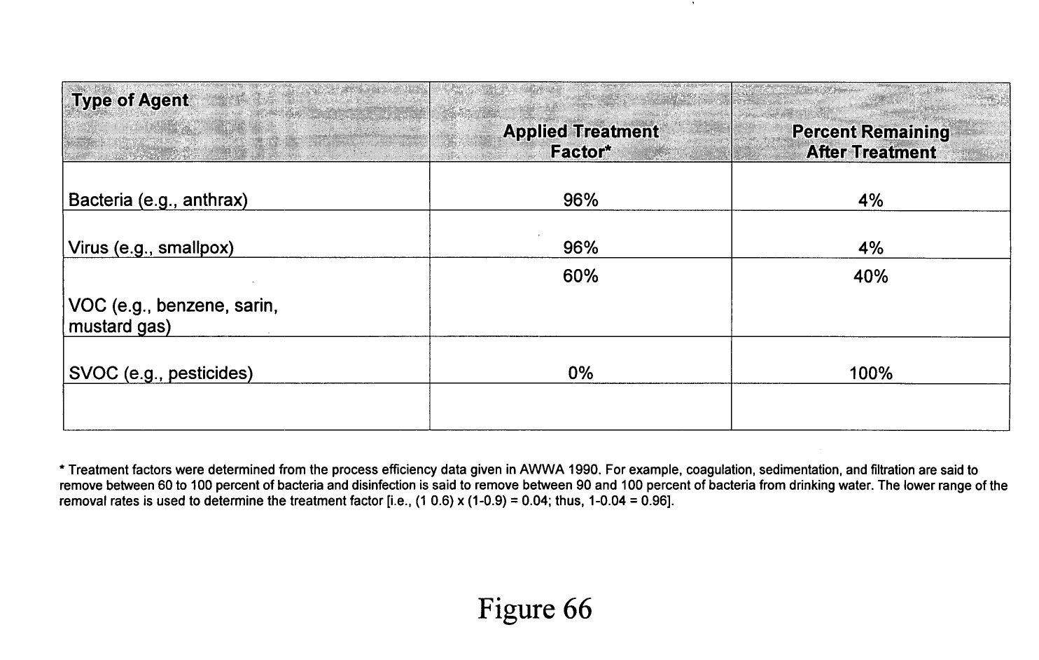

In order to apply these treatment factors to the agent in the water supply, the model applies the most conservative factor based on the above percentages. Treatment factors based on the type of agent that is being analyzed are shown in FIG. 66.

More treatment factors can be found at the EPA's website: http://www.epa.gov/pesticides/cumulative/pra-op/i i i_e_{—}3-f.pdf. It is recommended that these treatment factor values be conservatively reduced as they are based on mean values and also to account for short circuiting, operator error and/or less-that-optimal operation. In the water dispersion model, the overall treatment value was reduced by one-half. For example, a treatment factor of 48 percent (or one-half of 95 percent was used).

The treatment factor is supplied by the model based on the agent selected.

Calculating Concentration of Agent Across Each Model Component

The water dispersion model uses a simple triangular distribution method to route the agent across each of the model components:
River
Water treatment plant
Clearwells
Dedicated storage
Distribution system

This method assumes the influent agent mass will be dispersed and the resulting effluent agent mass is distributed triangularly. The computations are repeated at small time steps. After the last time step, the individual time step triangular distributions are aggregated to determine the total effluent mass distribution. This total effluent mass distribution is then passed down to the next computational module.

This method includes the following steps:
1. Computing of the average travel time across the model component.
2. Determining the incoming agent mass for the time step. For the river, this is single mass assumed to be added to the river at time step 1. For downstream model components, it will be the effluent from the upstream model component, reduced by appropriate factors for treatment and/or exponential decay.
3. Setting the leading edge of the agent distribution. For soluble agents (that is, agents that are soluble at lethal concentrations), it is assumed that the leading edge will be at 89 percent of the travel time (Jobson 1997). For nonsoluble agents, it is assumed to be at 100 percent of the travel time. The concentration at the leading edge is assumed to be zero.
4. Setting the duration of agent distribution. For soluble agents, it is assumed that the duration is equal to 0.70 times the travel time (in hours) to the 0.86 power (Kilpatrick 1993). For nonsoluble agents, it is assumed to be one time step, or uniform concentration “slug flow”.
5. Setting the trailing edge of the agent at the leading edge plus the duration. The concentration at the trailing edge is assumed to be zero.
6. Applying conservation of mass, set the maximum concentration at the travel time. This forms a triangular distribution for that time step.
7. The time steps are repeated until the total time exceeds the travel time of the entire model. After the last time step is competed, the various triangular distributions are aggregated to form the effluent agent distribution. This distribution is passed downstream and is used as the influent agent distribution by the next model component.

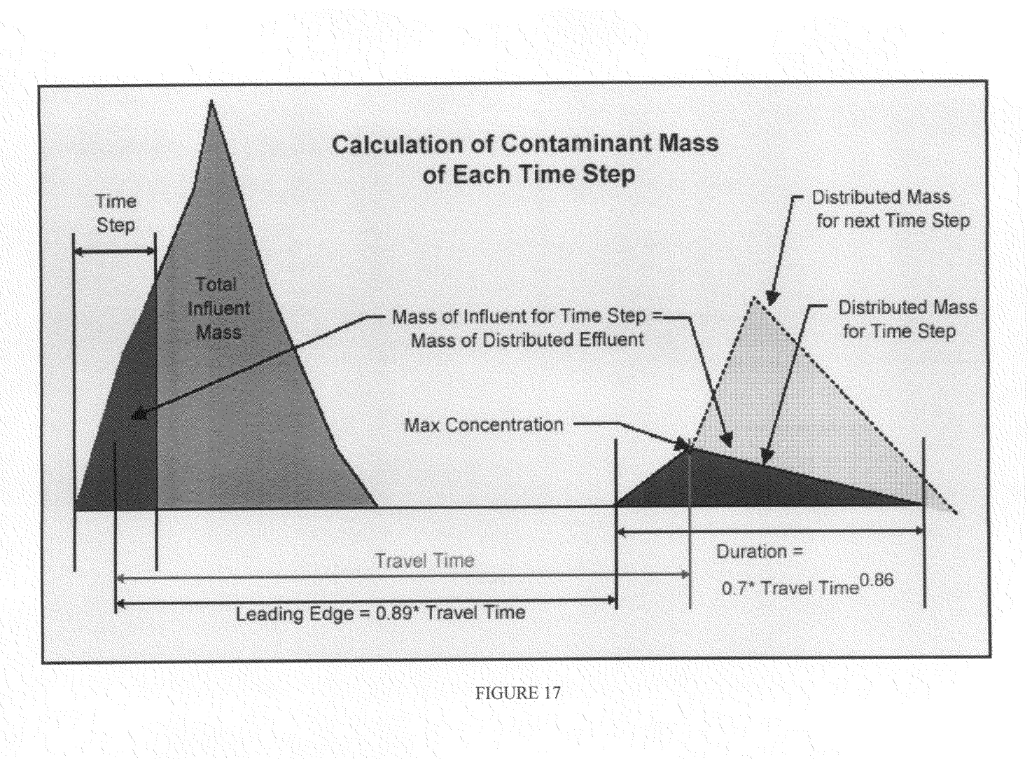

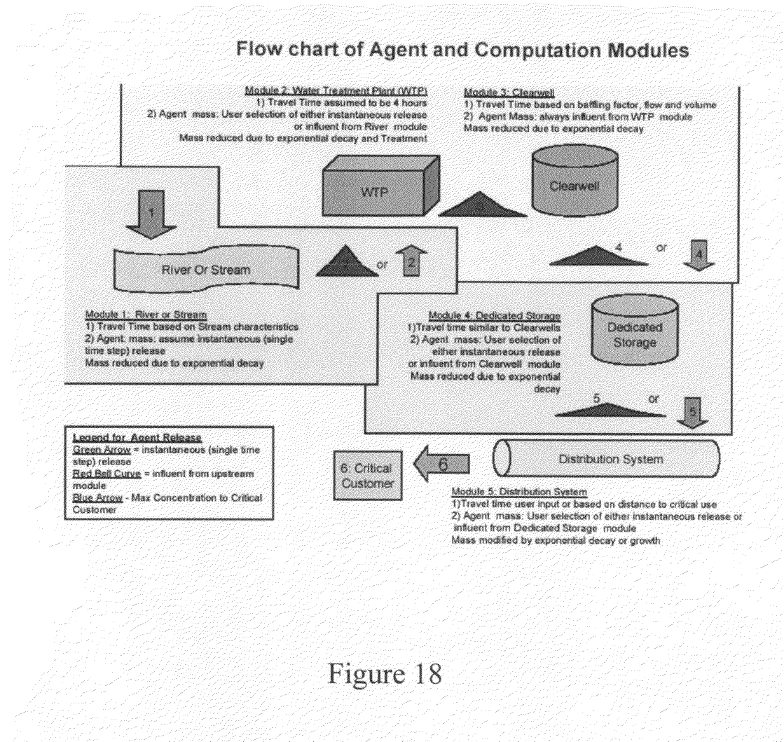

The time step method is depicted graphically in FIG. 17. Using this method, the only factors that are required are: (1) influent agent distribution and (2) travel time. Each of these factors is described in the respective model component section and is depicted graphically in FIG. 18. If the user selects the origin of contamination as “River prior to water treatment plant”, the water dispersion model will initiate the river or stream model components.

River Prior to Water Treatment Plant Model Component: If the user selects the origin of contamination as “River prior to water treatment plant”, the water dispersion model will initiate the river or stream model components.

Influent Contaminant Distribution: If the user selects the origin of contamination as “River prior to water treatment plant”, the water dispersion model will assume that all of the agent is added to the river or stream during a single time step.

Travel Time: If the user selects the origin of contamination as “River prior to water treatment plant”, the water dispersion model asks the user to input information regarding the dimensions and a description of a river or stream. If flow rate is known, these values will be used along with the flow rate to calculate the average stream velocity of the water body. The average stream velocity is an interim step used to determine the agent's time of travel in the water body. The following equation is used to calculate the average stream velocity:

μ=Q/(w×X×

D) where:
μ=Average stream velocity (feet per second [fps])
Q=Volumetric flow rate (cubic feet per second [cfs])
w=Width of river or stream (feet [ft])
X=Shape factor (0.5 if steep sided or triangular; 0.78 if rounded; 1 if flat bottomed or rectangular). If no information regarding the shape of the river or stream is available, “rounded” may be used as a default.
D=Velocity correction factor based on the agent's specific gravity and propensity to dissolve or disperse in water. This factor can range from 0 to 1.15 for agents that float. A factor of 1 is used for agents that typically dissolve or disperse; a conservative value of 0.70 is used for agents that sink. The velocity correction factor is supplied by the program based on the agent selected.

The calculated average velocity for non flood conditions should be in the following range:
Small stream: 2 fps or 0.6 m/s
Medium stream: 3 fps of 0.9 m/s
River: 5 fps or 1.5 m/s

Each region or state may have more appropriate values based on typical stream size and slope or specific values for the river or stream involved in the calculations.

The User can check these values against the value for parameter “Mean VelocityRiver” in the calculation summary that will appear on Water Model calculation summary screen following the input screen in units of meters per second.

Once the average stream velocity has been determined, the time of travel can then be calculated using the following equation:

t=dist/(μ×D)

where:
t=Time of travel (seconds)
dist=Distance from the input location to the intake distance (ft)
μ=Average stream flow velocity (FPS)
D=A factor from 0 to 1.5 based on the relative location of the agent: 1.5 for floating; 1 for dissolved, dispersed or emulsified; and 0.70 if it sinks.

Water Treatment Plant and Clearwell Model Component

If the user selects the origin of contamination as either “River prior to water treatment plant” or “Water treatment plant intake” the water dispersion model will use the “Water Treatment Plant” and “Clearwells” computation modules to take into account both the impacts of the WTP and any dilution factor of the clearwells. The user does not have the option to select a release directly to the clearwells alone as it is assumed that a terrorist would have enough knowledge of the WTP and would introduce the agent downstream to avoid the diluting impacts of the clearwells.
Water Treatment Plant Influent Contaminant Distribution: If the user selects the origin of contamination as “Water treatment plant intake,” the water dispersion model will assume that all of the agent is released at the intake of the WTP during a single time step.
If the user selects the origin of contamination as “River prior to water treatment plant”, the water dispersion model will take the effluent agent distribution from the river computation model and apply an exponential decay value; the model will then assume that the resulting concentration is the agent concentration at the WTP intake. The total agent influent mass will be a percentage of the total mass of the agent in the river or stream at the intake. This percentage will be equal to the ratio of the WTP flow to the stream or river flow.
Water Treatment Plant Travel Time: The User should assume a travel time of 4 hours for water dispersion model of the WTP, which is the residence time for flocculation and settling tanks as recommended in the Ten States Standard (Committee of the Great Lakes 1997). The travel time conservatively ignores any residence time in other processes within the WTP.
Clearwell Influent Contaminant Distribution: The water dispersion model will take the effluent agent distribution resulting from the WTP computation model, apply an exponential decay value and reduction value due to treatment, and assume the resulting agent concentration applies to the Clearwell influent. The total agent influent mass to the Clearwells will equal the total effluent mass of the WTP.
Clearwell Travel Time: The water dispersion model will assume a travel time equal to the residence time of the Clearwell, after applying a baffling factor (Dickinson 2005). The baffling factor accounts for any short circuiting that would lessen potential dilution within the Clearwell. For a well-baffled system, the factor is 0.7. For a system with no baffles, the factor is 0.1. An average value of 0.4 is estimated. The user will be asked if the system is well-baffled, has no baffles, or is average. The residence time of the Clearwells is computed as the Clearwell volume divided by the WTP flow. The travel time would equal the residence time multiplied by the baffling factor.

Dedicated Storage After the Water Treatment Plant Clearwells

The user may select “After the water treatment plant Clearwells” as the point of introduction to the system. This option would be used if there is dedicated storage between the WTP and the distribution system. In many systems, during times of high demand, water may reach the customers without passing through any storage. As such, there will be no dilution of contaminated water. In newer systems and older systems that have been retrofitted, however, the plant may have a dedicated line to a storage tank in order to maintain a constant water age. Such a system would ensure some measure of dilution.

The Storage Tank computation module applies factors to the agent in a manner identical to the approach used for the Clearwells. Users will be asked questions regarding the capacity of the storage tank. If the user answers “No” the program will then bypass the storage tank questions and the user be directed to a screen that asks for information about the distribution line.
Influent Contaminant Distribution: The water dispersion model will take the effluent agent distribution from the Clearwell computation module, apply any exponential decay and assume the resulting agent concentrations apply to the Dedicated Storage influent. The total agent influent mass going to the Dedicated Storage will equal the total effluent mass of the Clearwells.
Travel Time: Computations for the travel time of the Dedicated Storage will be identical to for the Clearwells.

Distribution System

Estimating the flow direction and concentration of an agent through a looped distribution system is extremely complicated. It requires hydraulic modeling of the system under different demands, as well as water quality monitoring. Many systems will already have calibrated hydraulic modeling completed. Water quality monitoring, however, is less likely to be modeled.

Given these complications and the time required for verification of model results, analysis of a looped system will not be used by ECAT. Instead, the system will be represented by a single pipe from the WTP Clearwell to a “critical customer.” Depending on the network, there may or may not be a storage tank between the WTP Clearwell and the critical customer.

Selection of the critical customer will be extremely important and subjective. In a way of thinking, the critical customer will be that customer with the freshest water. For example, the closest home to the WTP may not be a good choice, since an individual home usually does not have enough demand to clear all the water between the service connection and home in a short period. A factory or school on the other hand, may have a large demand and will have the capacity to clear the water in the pipe between the service connection and the factory or school.

A good guideline will be to identify the area typically with the highest chlorine residual and then identify the heaviest user in that area; this would be a good candidate for a critical customer.

Calculating Time Delay in Network

Users are for two inputs to determine the travel time from the dedicated storage to the critical customer's tap. In a looped distribution system, pipes are generally sized to maintain pressures in allowable ranges during maximum demand periods. Maximum demand will generally include fire flows. Velocities are typically limited to the 5-10 feet per second (fps) range during maximum demand. Most pipes will have velocities below this range. This velocity will be used in determining water age. The user will be asked to supply the approximate distance from the dedicated storage or water treatment plant to the critical first user. The user will also be asked to supply the approximate pipe velocity. The recommended values for the pipe velocity range from a low value of 3 fps to a high value of 5 fps.

The program computes the time from the pipe length and velocity. The travel time and distribution are computed in a manner similar to other models. There is no dilution factor applied, given the relatively small volume involved.

Often municipalities have models of the pipeline network. If this is the case, the velocity should be based on model runs with demands similar to the conditions used in the ECAT model.

If the user selects “Directly into distribution system” for the introduction to the system, the program only simulates flow in a single pipe and not the entire system. The user must supply the demand for that pipe system only.

Results

The ECAT water dispersion model focuses on predicting the reaction time of a WTP operator with respect to the time it may take to initiate preventative actions in the case of an agent release, along with the relative concentrations at the critical locations of exposure. Accordingly, along with other information, the water model presents the time difference between the agent release and the leading edge of the pollutant at the critical first customer. This appears as the value for parameter “Time ToCritCust” in the Water Model calculation summary screen following the input screen in units of hours.

The model will also estimate the value of the maximum concentration at the critical first user, which will occur sometime after the leading edge time. This appears as the value for parameter “EPC” in the Water Model calculation summary screen following the input screen, in units of mg/L.

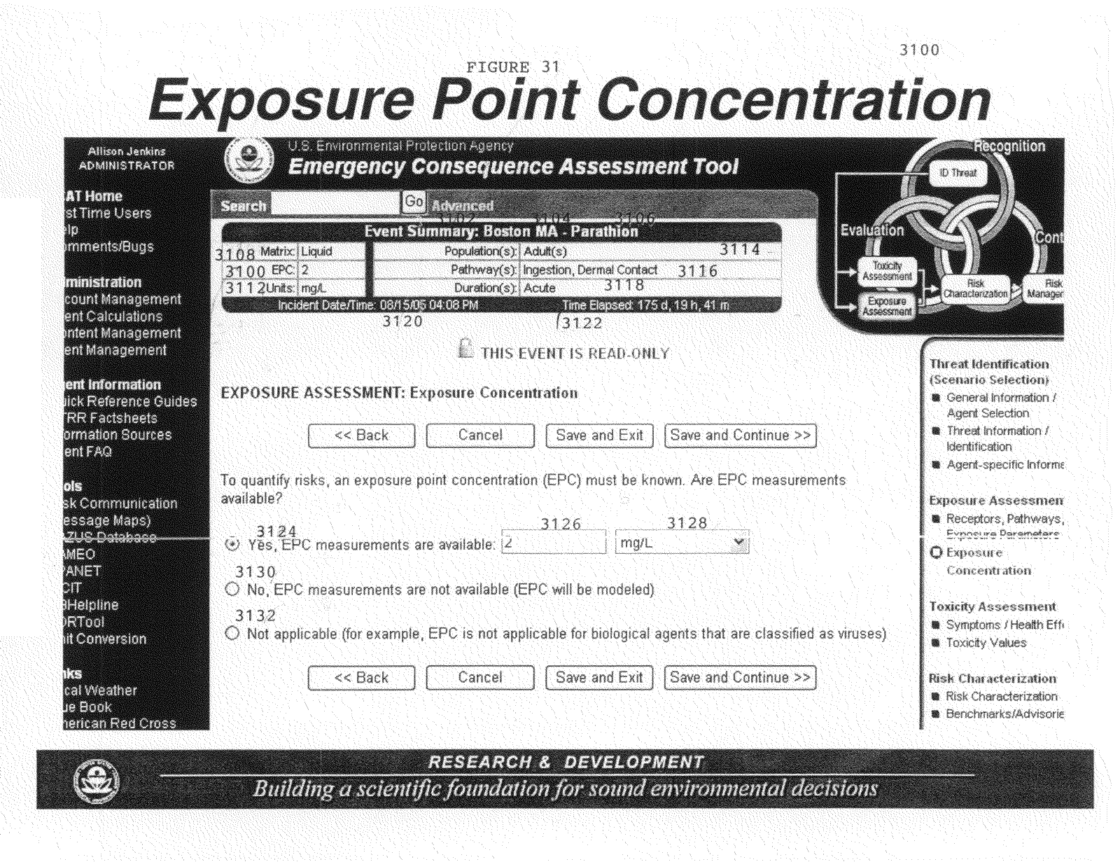

FIG. 31 shows by way of an example of an ECAT system exposure point concentration screen 3100. Users may use this screen to enter the exposure point concentration. There is an event summary 3102 showing the location 3104 where the threat agent is present, the identification of the threat agent 3106, the matrix in which the thread agent travels in 3108, the exposure point concentration 3110, the unit in which the concentration is measured 3112, the population group affected 3114, the pathway of infliction 3116, the duration of infliction 3118, the incident reporting date/time 3120, and the amount of time elapsed since incident is reported 3122.

In reality, the exposure point concentration amount is difficult to obtain. In situations where the amount is known, the information can be checked via circle 3124 and the quantity and unit may be entered respectively via prompts 3126 and 3128. The ECAT system will utilize this information to assess the situation.

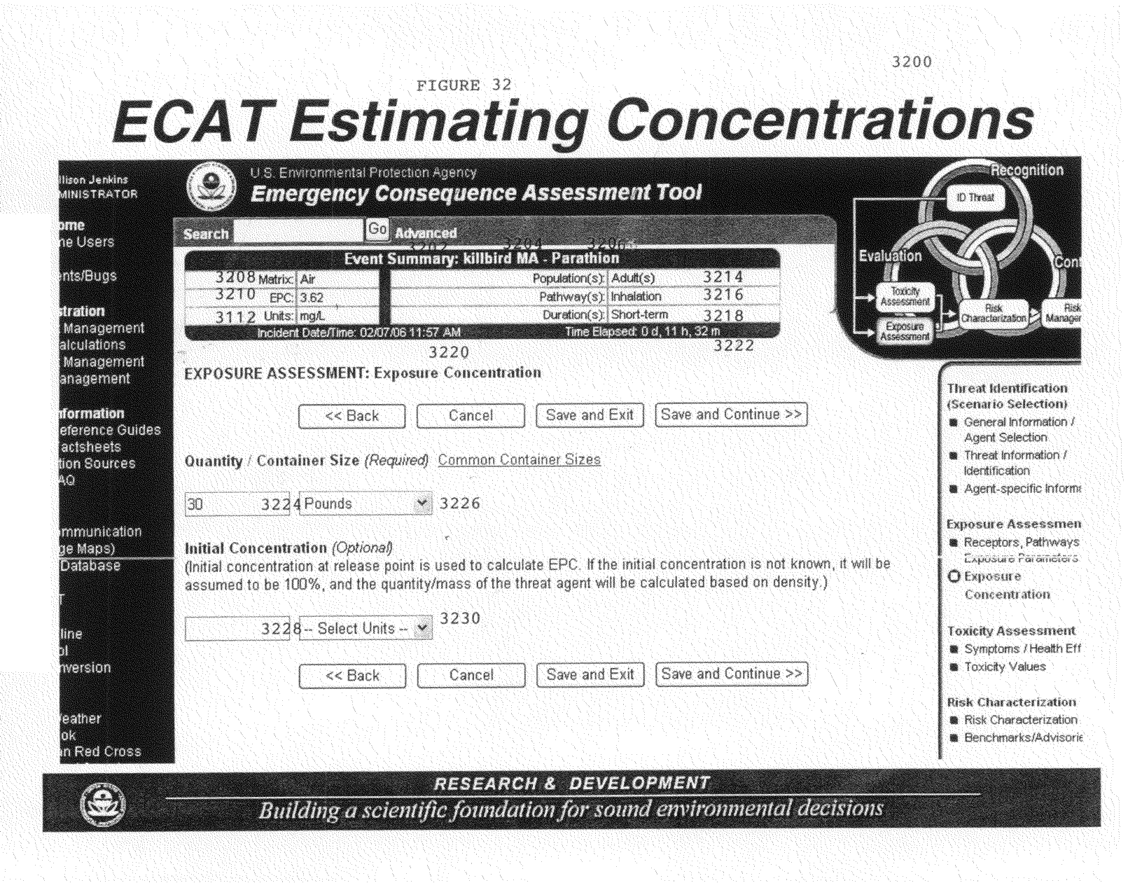

On the other hand, if the amount of exposure point concentration is simply indeterminate, then circle 3130 should be checked. This will allow the ECAT system to use build-in air and water models to estimate the exposure point concentration. FIG. 32 shows by way of an example an ECAT system screen indicating an ECAT estimating concentrations. Like many ECAT screens, there is an event summary 3202 showing the location 3204 where the threat agent is present, the identification of the threat agent 3206, the matrix in which the thread agent travels in 3208, the exposure point concentration 3210, the unit in which the concentration is measured 3212, the population group affected 3214, the pathway of infliction 3216, the duration of infliction 3218, the incident reporting date/time 3220, and the amount of time elapsed since incident is reported 3222. What is required to make the estimation is the quantity and container size information housing the threat agent, which information may be entered respectively in prompt 3224 and 3226. Optional information for estimation purposes is the initial concentration. Initial concentration at release point is used to calculate the exposure point concentration. If the initial concentration is not known, it will be assumed to be 100%, and the quantity/mass of the threat agent will be calculated based on density. The quantity and unit may be respectively entered in prompts 3228 and 3230.

In some circumstances, the threat agents are viruses or biological agents, exposure point concentration is inapplicable. Circle 3132 should be checked to inform the ECAT system.

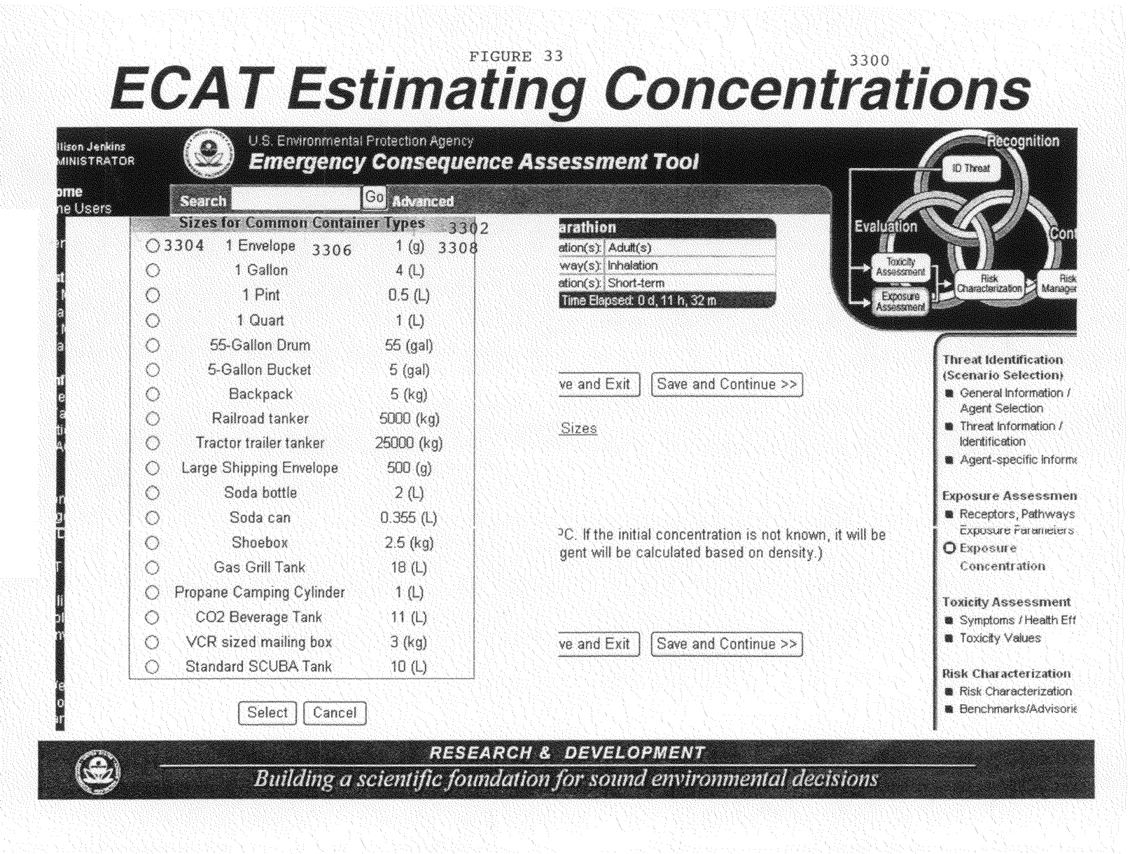

To model an exposure point concentration of a threat agent in water or air, ECAT requires an estimate of the quantity using common containers. If the user does not know the volumes of common containers, ECAT can provide this information in a separate window. FIG. 33 shows by way of an example an ECAT system screen 3300 containing a sub-screen 3302 with sizes for common container types. Sub-screen 3302 shows three columns of information, the first column shows blank circles 3304 prompting to be checked if appropriate, the second column shows common description of containers 3306 and the third column shows quantity and container capacity in measurement units. Through this sub-screen, even if exact amount of threat agent is unknown, at least educated and scientifically sound estimations of the amount threat agent can be determined.

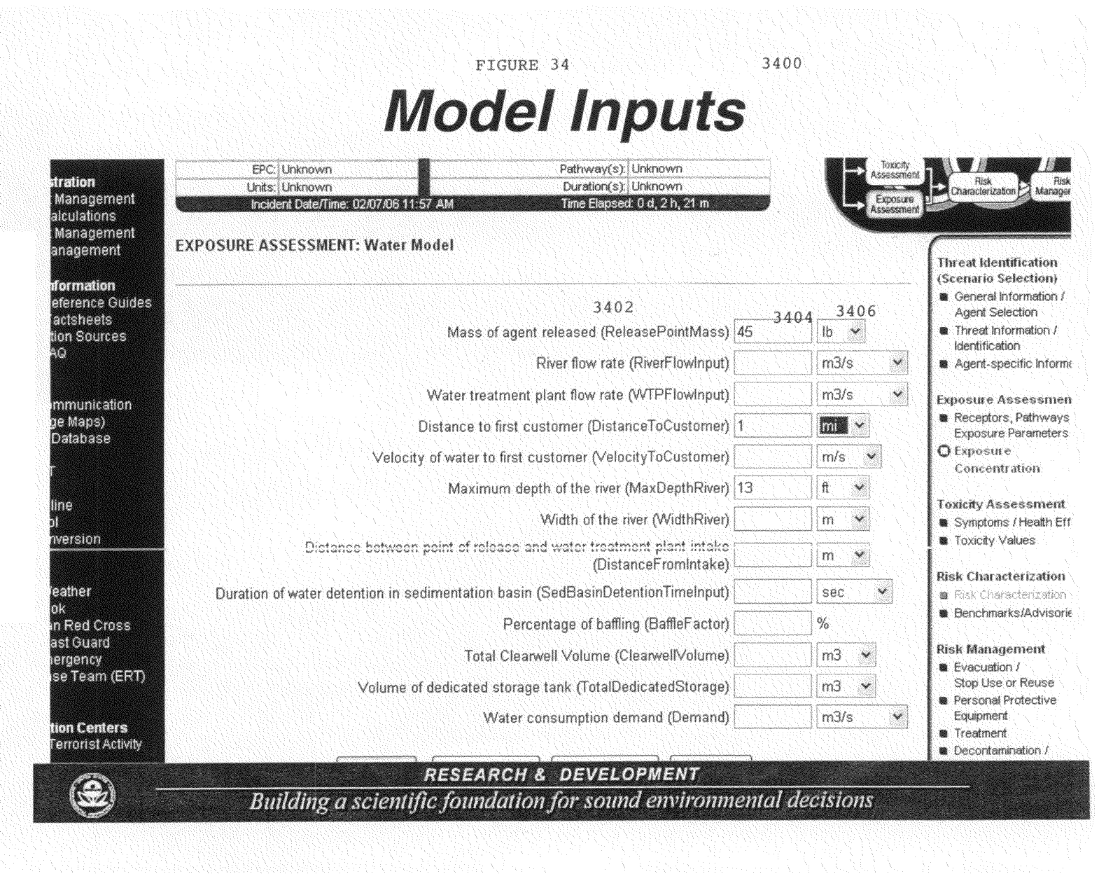

After prompting the previous information, further distinction is made regarding whether the exposure assessment should be based on water model or air model. FIG. 34 shows by way of an example of an ECAT system screen for gathering exposure assessment information suitable for utilizing water model. As shown in screen 3400 of FIG. 34, there are three columns of information pertaining to water modeling. Column 3402 identifies various factors related to water modeling, column 3404 shows numerous prompts into which quantity information may be input, and column 3406 shows numerous measurement units among which the user may specify.

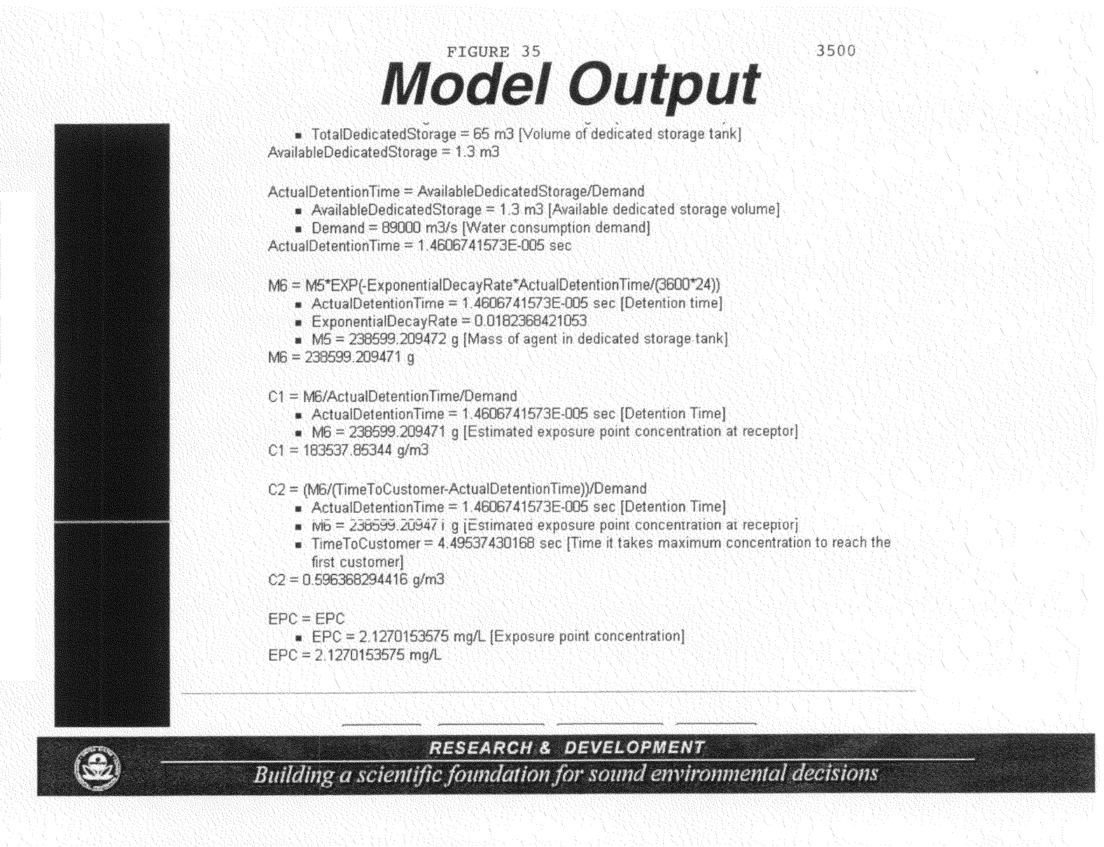

Once pertinent information is completely entered in model input screen 3400 for water modeling, a water model output screen may be shown. FIG. 35 shows by way of an example an ECAT system screen showing water model output information 3500 including a summary of all the calculations necessary for its derivation. The user may use this information to assess the situation and proceeding further considerations accordingly.

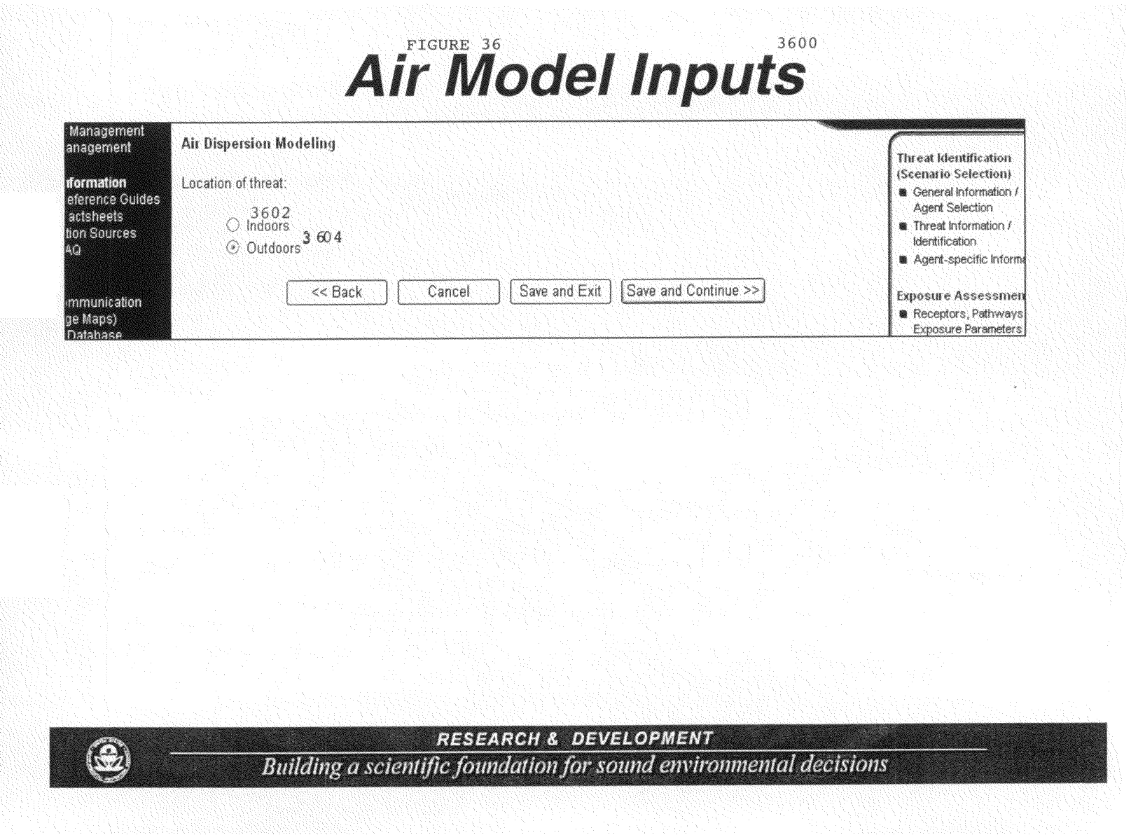

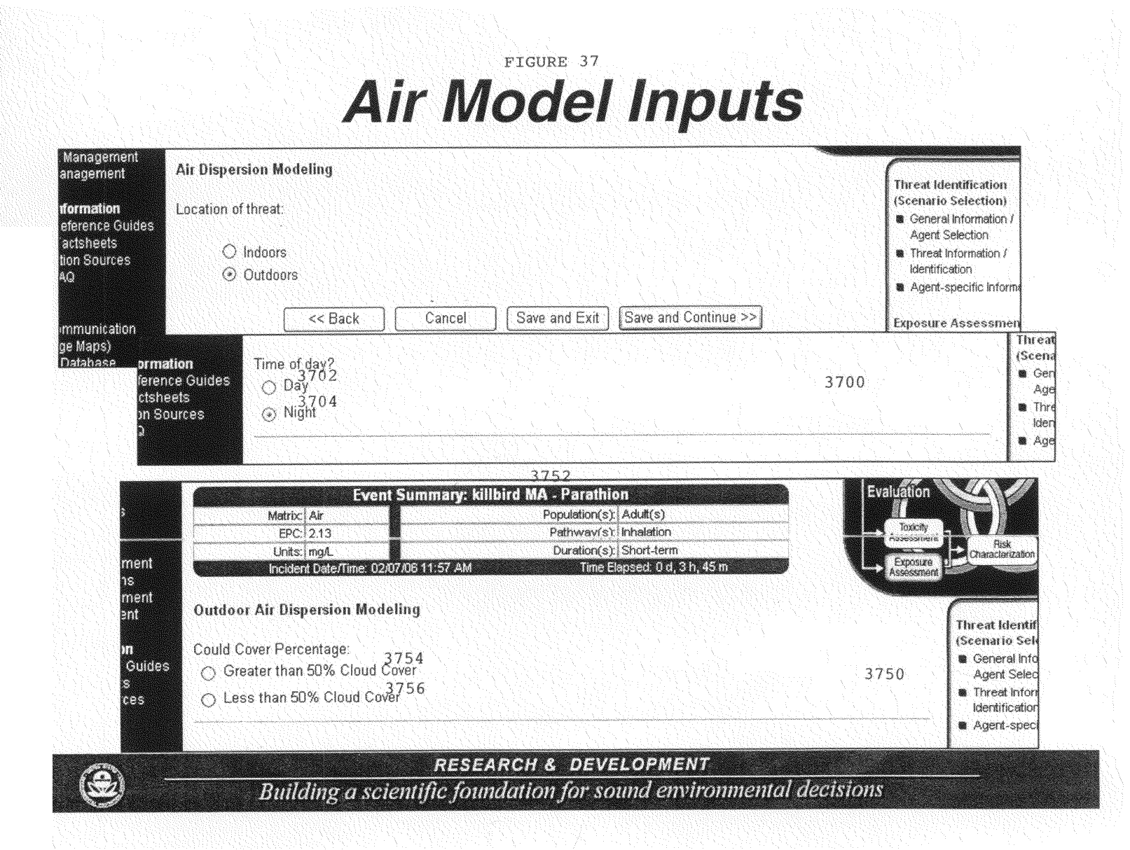

If air modeling is more appropriate for the situation, the user may enter information pertaining to air modeling to ECAT. FIG. 36 shows by way of an example of an ECAT system screen for entering air model inputs. As shown in screen 3600 of FIG. 36, the most fundamental distinction to be made in air modeling is whether the threat agent is released indoors or outdoors, which can be entered respectively via check circles 3602 and 3604. In screen 3600, outdoors is checked via check circle 3604. Sub-screens 3700 and 3750 appear so further detailed information may be entered. FIG. 37 shows by way of an example an ECAT screen showing a time of day entry page 3700 and an outdoor air dispersion modeling entry page 3750. On page 3700, the user is asked to input information regarding the time of day in broad categories like day time or night time via check circles 3702 and 3704.

On page 3750, there is an event summary 3752 like many other ECAT screens, details of which are not further discussed. The user is asked to determine and inform whether the outdoor cloud condition in terms of cloud cover percentage. If there is greater than 50% cloud cover, then circle 3754 should be checked. If there is less than 50% cloud cover, then circle 3756 should be checked.

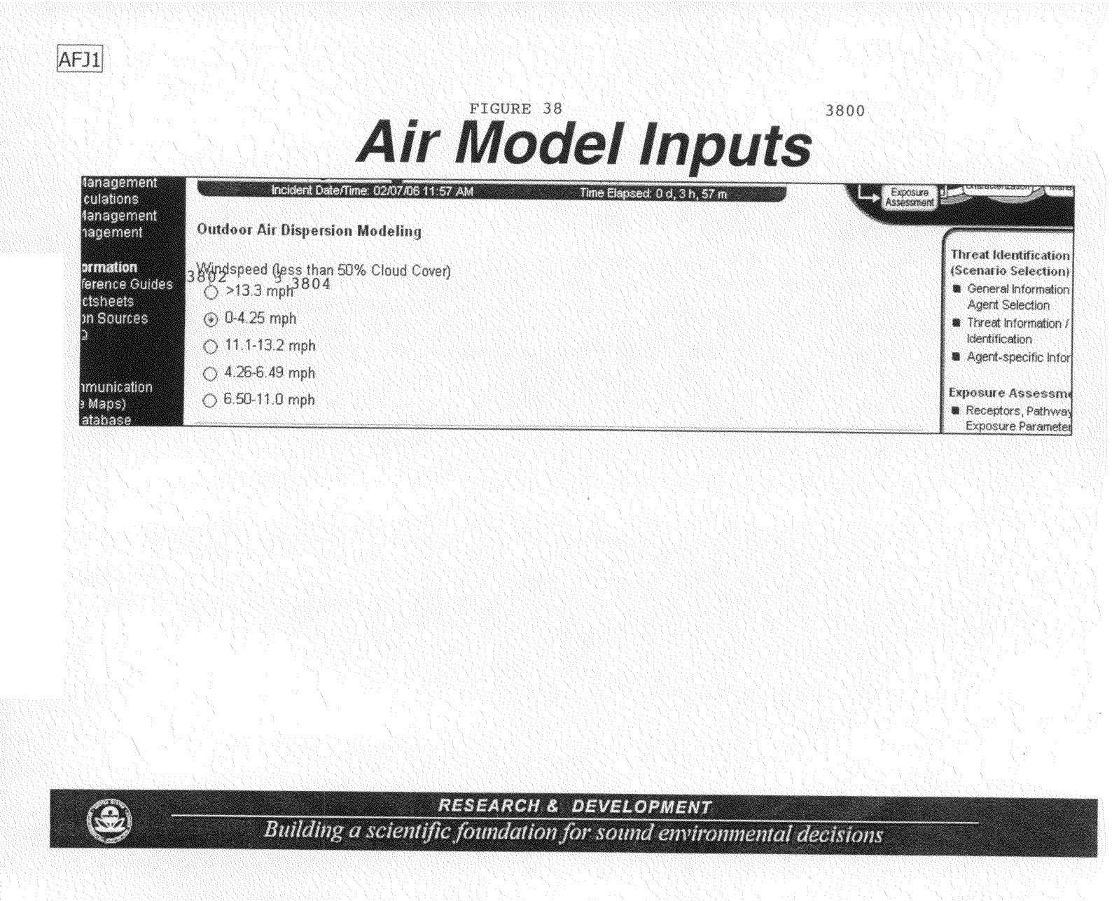

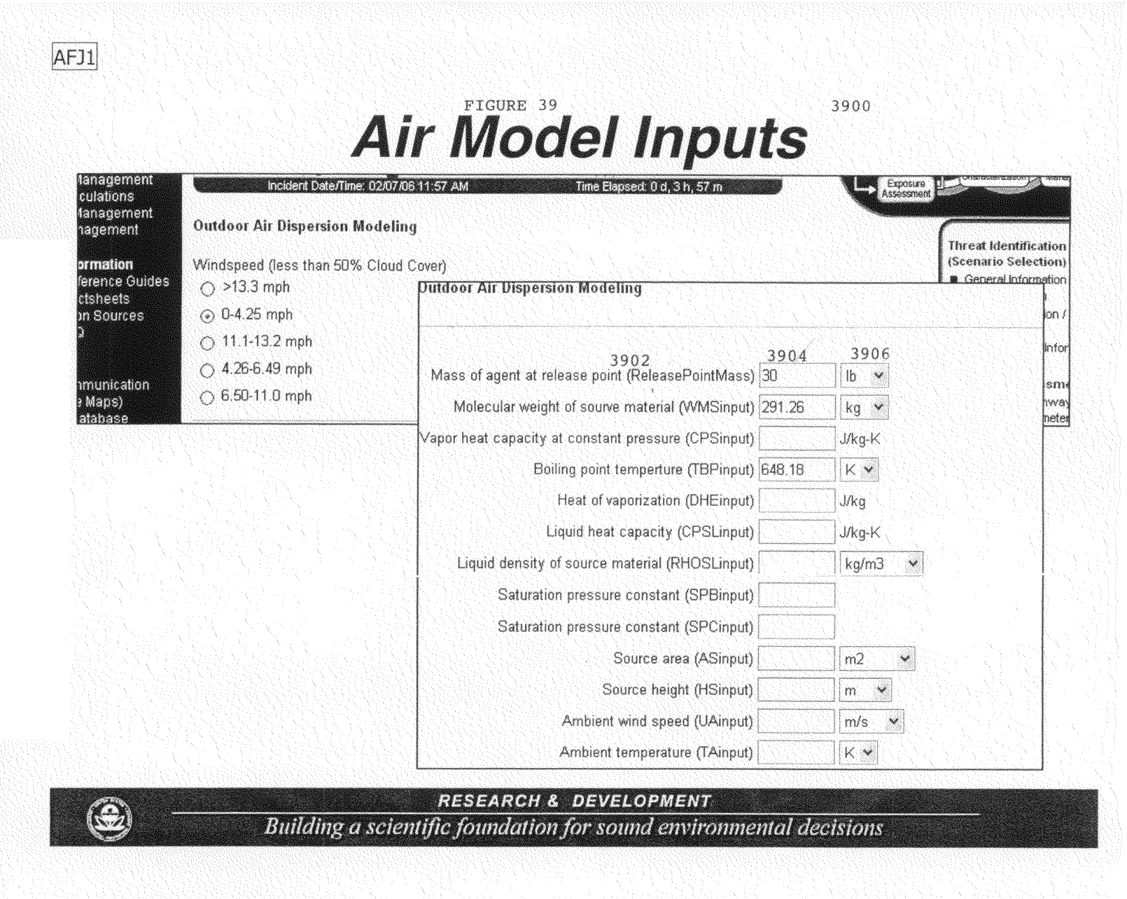

Thereafter, windspeed information is prompted in entry page 3800. FIG. 38 shows by way of an example an ECAT screen showing a wind-speed entry page 3800. Of course, wind-speed only becomes an important consideration when the threat agent is released outdoors. In this example entry page, a less than 50% cloud cover is shown. A separate entry appropriate for more than 50% cloud cover is also available. In screen 3800, there are a number of ranges 3804 of wind-speeds measured in miles per hour organized in a column. In another column 3802 correspondingly adjacent to ranges 3804 are circles in which a user may check if appropriate. Assuming the user check the range between 0-4.25 miles per hour wind speed, a new entry page appears. FIG. 39 shows by way of an example an ECAT system screen showing an entry page 3900 for the entry of further detailed information for outdoor air dispersion modeling.

As shown in entry page 3900 of FIG. 39, there are three columns of information pertaining to outdoor air dispersion modeling. Column 3902 identifies various factors related to outdoor air dispersion air modeling, column 3904 shows numerous prompts into which quantity information may be input, and column 3906 shows numerous measurement units among which the user may specify.

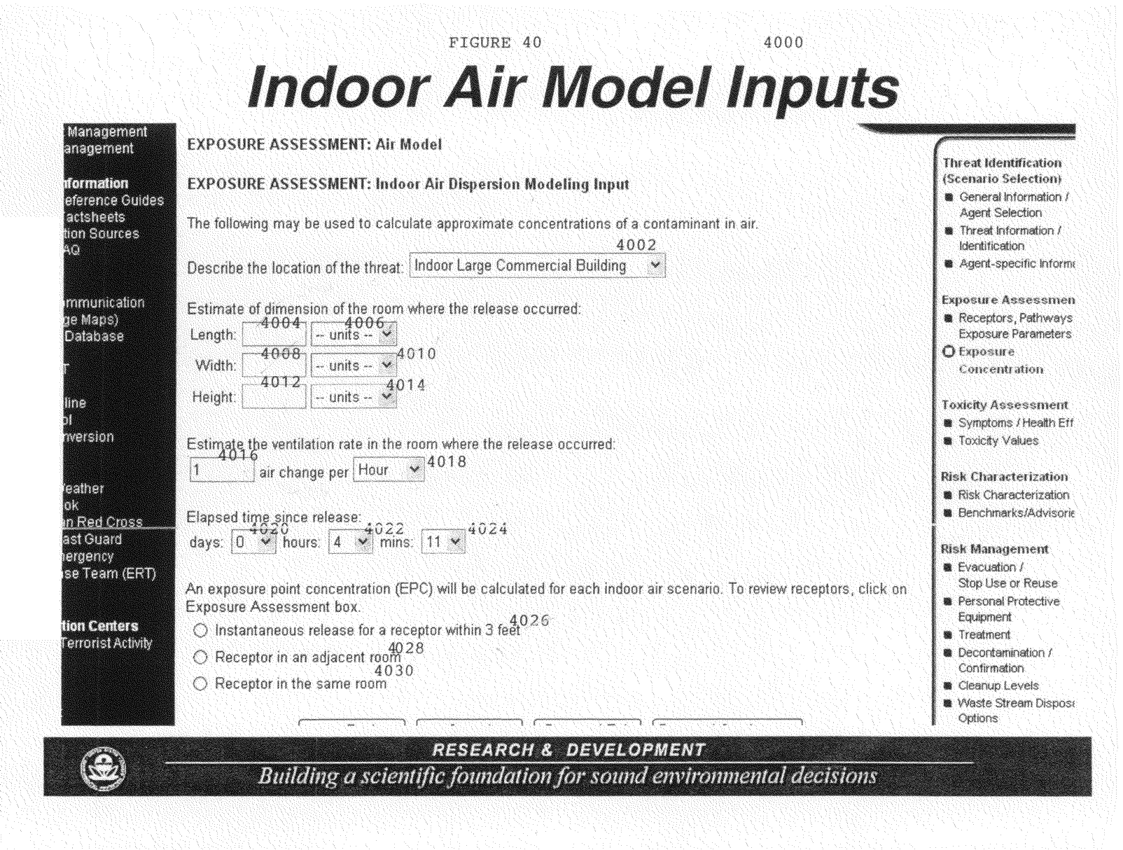

On entry page 3600, if the indoors circle 3602 is checked, then entry page 4000 appears to collect relevant information. FIG. 40 shows by way of an example an ECAT system screen showing an indoor air dispersion modeling input page 4000. At prompt 4002, the user inputs the location of the threat agent, the example given in prompt 4002 is at an indoor large commercial building. The user needs to specify further an estimation of dimension of the room where the release of threat agent occurred. The room size is measured in length 4004, width 4008 and height 4012, along with appropriate measurement units at prompts 4006, 4010 and 4014. Next, an estimation of the ventilation rate in the room where the threat agent is released is input in terms of the number of air changes 4016 per unit of time 4018. Thereafter, an elapsed time since release is needed. The user needs to input the number of days at prompt 4020, hours at prompt 4022 and minutes at prompt 4024. Lastly, to calculate an exposure point concentration for each indoor scenario, the user need to select one of instantaneous release for a receptor within 3 feet at prompt 4026, receptor in an adjacent room at prompt 4028 and receptor in the same room at prompt 4030.

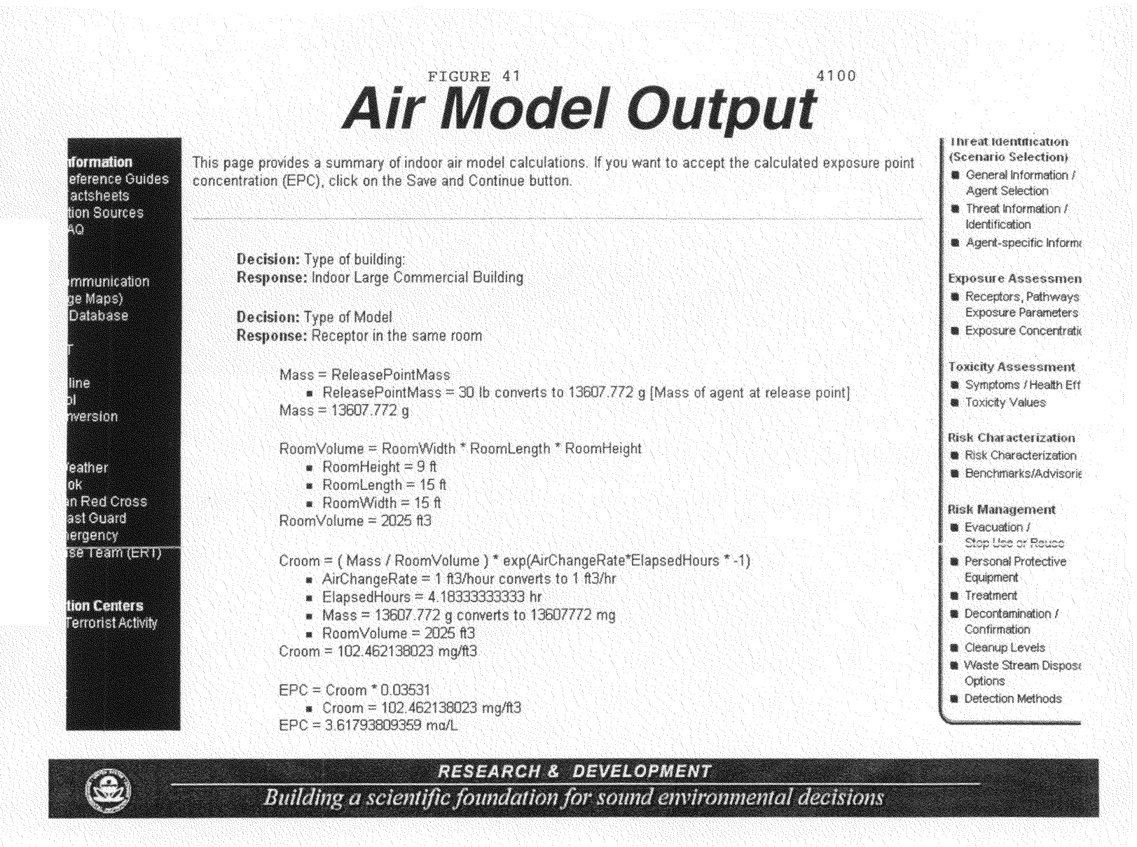

After all these entries, ECAT will make a calculation and provide a summary of indoor air model calculations. FIG. 41 shows by way of an example an ECAT system screen showing a summary of indoor air model calculations 4100. This screen shows the exposure point concentration and a summary of all the calculations necessary for its derivation. The user may make decisions based on information provided by this summary.

Calculation of an Exposure Point Concentration for an Air Release Scenario

If a User has selected mustard gas or sarin released to the “air” medium, they will be prompted to select an “Indoor Air” or “Outdoor Air” scenario in order to model an EPC.

Calculation of an Exposure Point Concentration for an Outdoor Release

The scenario which is available to the User for an outdoor release is the outdoor stadium scenario. The outdoor stadium release is modeled using the SLAB model, which was developed by Lawrence Livermore National Laboratory/Lakes Environmental (1997). The SLAB model is a computer model that simulates the atmospheric dispersion of denser-than-air releases (for example, mustard gas). Releases evaluated in the model include (1) a ground-level evaporating pool, (2) an elevated horizontal jet, (3) a stack or elevated jet, and (4) an instantaneous volume source. For the purposes of evaluating a release to an outdoor air stadium in ECAT, an instantaneous volume source was assumed. Sources may be either pure vapor or a mixture of vapor and liquid droplets.

The User's Manual for SLAB: An Atmospheric Dispersion Model for Denser-Than-Air Releases (Lawrence Livermore National Laboratory/Lakes Environmental 1997) provides a theoretical description of the model. The User's Manual is incorporated herein by reference.

The outdoor air modeling component of ECAT requires input from the user regarding the release scenario. Input components regarding the outdoor conditions include weather conditions (wind speed, ambient temperature, relative humidity), time of release (day or night), and cloud cover. Input parameters for the outdoor air model are described below.
Time of Release: The information is provided by the user during the initial description of the event; this information will be used to determine whether the event has occurred during the day or night.
Cloud Cover Percentage: The user will be asked to describe the amount of cloud cover present at the time of release; either “Greater than 50% Cloud Cover” or “Less than 50% Cloud Cover” may be selected. This information is used to describe the stability of the atmosphere into which the release is being dispersed. The greater the percentage of cloud cover, the more stable the atmosphere will be. A stable atmosphere will be conducive to less dispersion.
Wind Speed. After selecting the cloud cover percentage, the user is asked to input the wind speed at the time of release. If current wind speed information is unavailable, local wind conditions may be obtained by going to the links located on the left side of the screen and clicking on “Local Weather”. This will take you to the National Oceanic and Atmospheric Administration webpage where the name of a city and state may be entered to obtain current weather information. Radio buttons with the following wind speed selections are available:
   a) 0 to 4.25 miles per hour (mph)—Calm to light air: in light air, smoke drifts downward
   b) 4.26 to 6.49 mph—Light breeze: wind felt on face; leaves rustle
c) 6.50 to 11.0 mph—Gentle breeze: leaves and twigs in constant motion
d) 11.1 to 13.2 mph—Moderate breeze: raises dust and loose paper
e) Greater than 13.2 mph

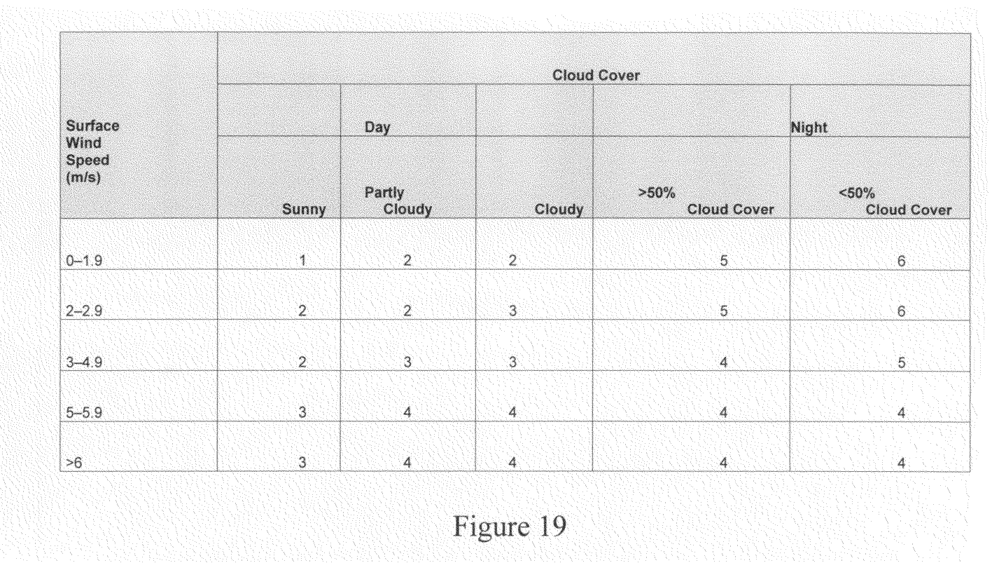

Using the user-specified information, the model will select an atmospheric stability class. Stability class estimates used in the model for varying wind speeds, release times, and cloud covers are presented in FIG. 19, where 6 represents the most stable conditions and 1 represents the least stable conditions.

After entering information related to the environmental conditions at the time of release, the user will then be asked to provide input specific to the threat agent release.
Mass of agent at release point: This field should be pre-populated to reflect the information input by the user on the EXPOSURE ASSESSMENT: Exposure Concentration screen.
Source Area: The user is asked to input a numerical value to represent the areal size of the agent plume. The area of the plume may be up to 7 characters long with a range between 0 and 9999999. The user may select the appropriate units from a pull-down menu.
Source Height: The user is asked to input a numerical value to represent the height from which the agent was released. The height of release may be up to 5 characters long with a range between 0 and 99999. The user may select the appropriate units from a pull-down menu.
Ambient Wind Speed: The user is asked to input a numerical value to represent the wind speed at the time of the release. The ambient wind speed may be up to 5 characters long with a range between 0 and 99999. The user may select the appropriate units from a pull-down menu.
Ambient Temperature: The user is asked to input a numerical value for the ambient temperature at the time of release. The temperature may be up to 4 characters long with a range between −999 and 9999. The user may select the appropriate units from a pull-down menu.
Relative Humidity (%): The user is asked to input a numerical value for the percent relative humidity at the time of release. The percent humidity may be up to 3 characters long with a range between 0 and 100; no units selection is needed as relative humidity is always expressed as a percentage.

The user is asked to specify the vertical position of the receptor with respect to ground level. The user may select one of the following options using the radio buttons:
10 Meters (or 33 feet) above ground level
20 Meters (or 66 feet) above ground level
50 Meters (or 165 feet) above ground level
Ground level

After the all of the input parameters have been entered, ECAT provides two options for viewing the dispersion model output.
Graphical Summary: ECAT provides an interactive color graphic. The user may use the cursor to click on any of the dots on the figure to obtain the following information:
   Location: Distance downwind from the release (meters)
   Time (seconds): How long it took for the estimated concentration to reach the receptor

Exposure Point Concentration (mg/L)
Tabular Output: The user may view the dispersion model output in tabular form by clicking on the words “Tabular Output” on the Outdoor Air Model—Output page. A link to the SLAB model user guide is provided for a more detailed explanation of the tabular output.

Calculation of an Exposure Point Concentration for an Indoor Air Scenario

There are three scenarios available to the user to simulate indoor air releases. Choices include:
Multi-Room Building
Closed Subway Car
Indoor Stadium

Multi-Room Building Indoor Air Scenario

If the Multi-Room Building scenario is chosen, the user is asked to input information regarding the dimensions of the room where the release occurred. The user should enter a value for Length, Width, and Height and select the appropriate units from the pull-down menu.

The user will also be asked to provide information estimating the ventilation rate (in terms of air changes per hour) in the room where the release occurred. Some information about typical ventilation rates is shown below:

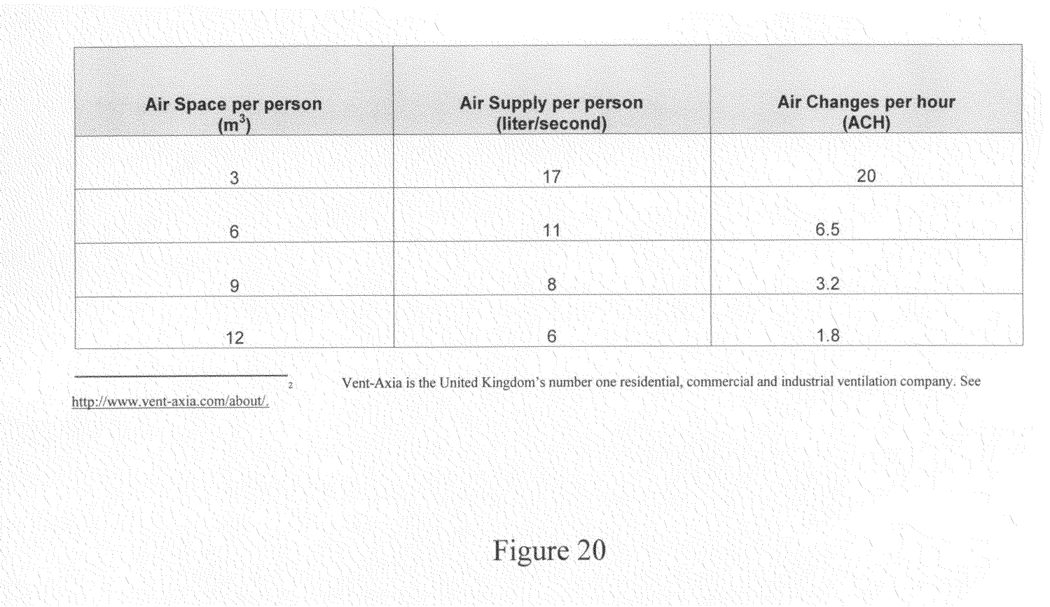

Ventilation experts at Vent-Axia² provide FIG. 20 for the recommended fresh air supply.

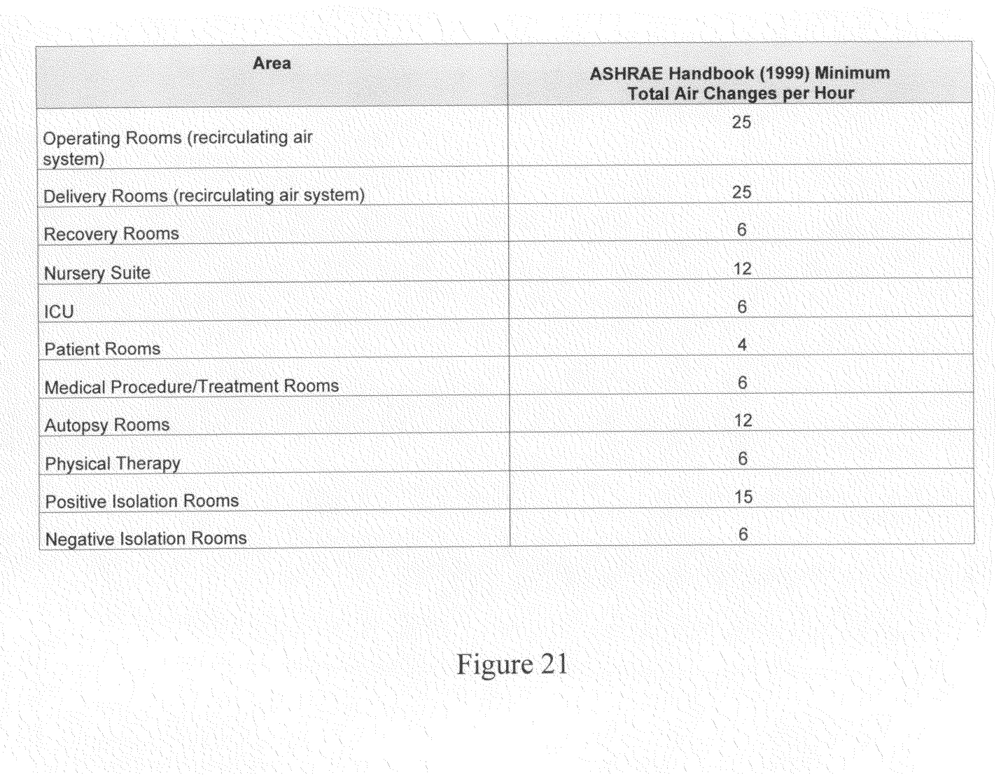

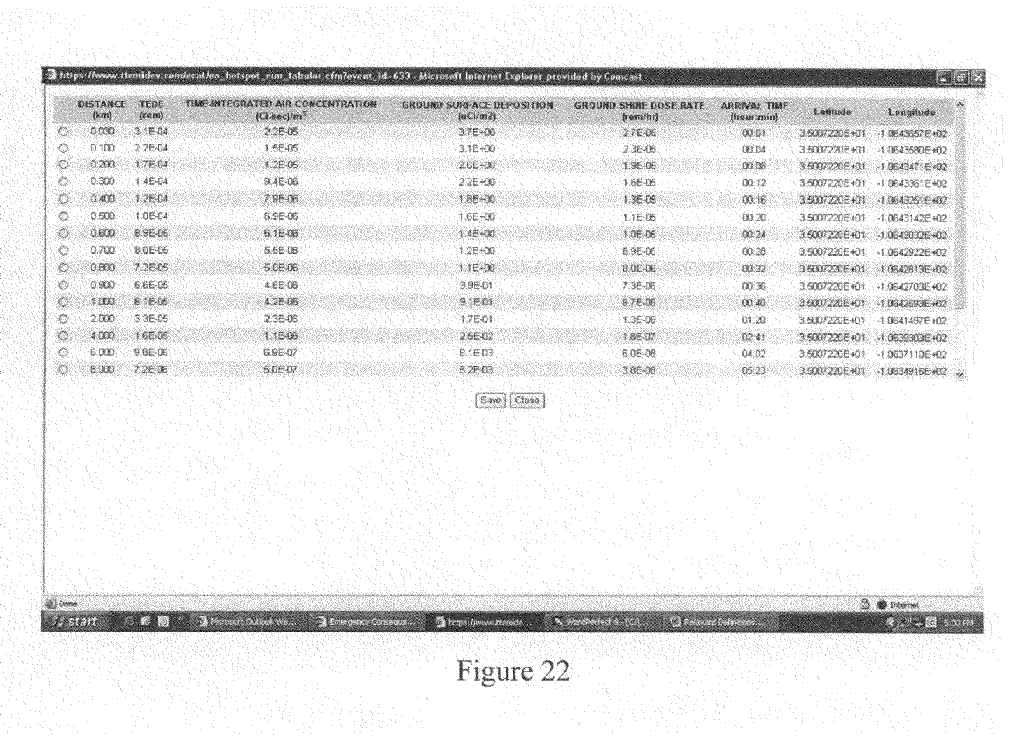

FIG. 21 is from the American Society of Heating, Refrigerating and Air-Conditioning Engineers (ASHRAE).

The next input required from the user is the estimation of the elapsed time since the release. This will be scenario specific.

When calculating the concentration of a threat agent released in a multi-room building, users will be able to calculate the concentration of the agent in a room based on three scenarios:
Instantaneous release for a receptor within 3 feet:

That is, the receptor is located within three feet of the release at the time of the release
Receptor in an adjacent room: At the time of release the receptor is located in an adjacent room that exchanges air with the room where the release occurred.
Receptor in the same room: The receptor is assumed to be located in the room where the release occurred (but at a distance greater than 3 feet).

The equations used to estimate the EPC for each of the scenarios described above are provided in the following sections.

Instantaneous Release for a Receptor within 3 Feet

In this scenario, it is assumed that someone came in contact with an agent at the time of a release. It is assumed that the person is within three feet of the release and that complete mixing occurs. The concentration is calculated using the following equation:

^{C}release=M/27

where:
^{C}release=Concentration of the threat agent at the time of the release (milligram per cubic feet [mg/ft³])
M=Mass of the threat agent released (mg)
27=Volume of the assumed 3 foot box in which the release occurs (3 ft×3 ft×3 ft=27 cubic feet [ft³])

Receptor in an Adjacent Room

This scenario models the airborne concentration of a threat agent in a room adjacent to where it has been released. In this scenario, it is assumed that the initial concentration of the threat agent is zero (0) in the adjacent room and that over time the concentration of the threat agent increases due to air exchange with the adjoining room where the release occurred. It is also assumed that the adjoining rooms are the same size.

In this scenario, a burst-source situation is approximated. In order to be conservative, outside air flow was assumed to be zero (0). In addition, removal of the agent due to plate-out (that is, settling) on building surfaces is not considered. This simplifies the model as these particles can be resuspended after they are adsorbed to or deposited on surfaces due to turbulent effects (that is, a closing door or someone walking through the room). Modeling resuspended particles depends on many site-specific factors and cannot be generalized. Because the airborne concentration, including resuspended particles, will never be greater than the concentration ignoring plate-out effects, this assumption is conservative.

^{C}adj=(M/2V)×(1−exp^{-Q/V}*^{t})

where:
^{C}adj=Concentration of the threat agent in an adjacent room after a given time period (mg/ft³)
M=Initial mass of the threat agent (mg)
V=Volume of air based on room dimensions (ft³)
Q=Air flow rate (ft³/hr)
Q/V=Air change rate per hour
t=Time since release occurred (hr)

Receptor in the Same Room

In this scenario, it is assumed that someone enters the room where the release occurred after a threat agent was released. A burst-source situation is also approximated for this scenario as was described above. Outside air flow was assumed to be zero (0). Removal of the agent due to plate-out (that is, settling) on building surfaces is not considered, which simplifies the model as these particles can be resuspended after they are adsorbed to or deposited on surfaces due to turbulent effects (that is, a closing door or someone walking through the room). Modeling resuspended particles depends on many site-specific factors and cannot be generalized. Because the airborne concentration, including resuspended particles, will never be greater than the concentration ignoring plate-out effects, this assumption is conservative. The following equation is used to model the burst source scenario:

^{C}room=(M/V)×ₑₓₚ−(Q/V*t)

Where:
^{C}room=Concentration of the threat agent in a room after a given time period (mg/ft³)
M=Initial mass of the threat agent (mg)
V=Volume of air based on room dimensions (ft³)
Q=Air flow rate (cubic feet per hour [ft³/hr])
Q/V=Air change rate per hour
t=Time since release occurred (hours [hr])

Closed Subway Car Indoor Air Scenario

If the Closed Subway Car scenario is chosen, the user will be asked to input information regarding the dimensions of the car where the release occurred. The user should enter a value for Length, Width, and Height and select the appropriate units from the pull-down menu. Inputs of ventilation rate and elapsed time since the release will also be required, as described above.

When calculating the concentration of a threat agent released in a subway car, users will be able to calculate the concentration of the agent in the car based on two scenarios:
Instantaneous release for a receptor within 3 feet: That is, the receptor is located within three feet of the release at the time of the release
Receptor in the same room: The receptor is assumed to be located in the room where the release occurred (but at a distance greater than 3 feet).

The equations used to estimate the EPC for each of the scenarios described above were described previously.

Indoor Stadium Air Scenario

The indoor stadium release is modeled using the SLAB model, which is described in more detail above. For the purposes of evaluating a release in an indoor air stadium in ECAT, an instantaneous volume source was assumed. Sources may be either pure vapor or a mixture of vapor and liquid droplets.

The User's Manual for SLAB: An Atmospheric Dispersion Model for Denser-Than-Air Releases (Lawrence Livermore National Laboratory/Lakes Environmental 1997) provides a theoretical description of the model.

The indoor air modeling component of ECAT requires input from the user regarding the release scenario. Input components regarding the indoor conditions include source information (source mass, source area and source height). All other indoor conditions have been assumed to be constant to simulate calm, stable conditions for all indoor stadium scenarios. Input parameters for the indoor air model are described below.
Time of Release: The information is provided by the user during the initial description of the event, but will not be used for the calculation of stability conditions. For the calculation of stability conditions time of day will be assumed to be midnight, to simulate the most stable conditions.
Cloud Cover Percentage: One hundred percent cloud cover will be assumed to simulate the most stable conditions. The greater the percentage of cloud cover, the more stable the atmosphere will be. A stable atmosphere will be conducive to less dispersion.
Wind Speed. Calm winds (0 to 4.25 miles per hour (mph)) will be assumed to simulate the most stable conditions.

Using the user-specified information, the model will select an atmospheric stability class of 6 (most stable conditions). Stability class estimates for varying wind speeds, release times, and cloud covers were presented previously.

The user will be asked to provide input specific to the threat agent release.
Mass of agent at release point: This field should be pre-populated to reflect the information input by the user on the EXPOSURE ASSESSMENT: Exposure Concentration screen.
Source Area: The user is asked to input a numerical value to represent the a real size of the agent plume. The area of the plume may be up to 7 characters long with a range between 0 and 9999999. The user may select the appropriate units from a pull-down menu.
Source Height: The user is asked to input a numerical value to represent the height from which the agent was released. The height of release may be up to 5 characters long with a range between 0 and 99999. The user may select the appropriate units from a pull-down menu.
Ambient Wind Speed: The ambient wind speed will be assumed to be 1 meter per second to simulate conditions within an indoor stadium.

Ambient Temperature: The temperature will be assumed to be 70 degrees Fahrenheit to simulate conditions within an indoor stadium.

Relative Humidity (%): The relative humidity will be assumed to be 50 percent to simulate conditions within an indoor stadium.

The user is asked to specify the vertical position of the receptor with respect to ground level. The user may select one of the following options using the radio buttons:
10 Meters (or 33 feet) above ground level
20 Meters (or 66 feet) above ground level
50 Meters (or 165 feet) above ground level
Ground level

After the all of the input parameters have been entered, ECAT provides two options for viewing the dispersion model output.
Graphical Summary: ECAT provides an interactive color graphic. The user may use the cursor to click on any of the dots on the figure to obtain the following information:
   Location: Distance downwind from the release (meters)
   Time (seconds): How long it took for the estimated concentration to reach the receptor
   Exposure Point Concentration (mg/L)
Tabular Output: The user may view the dispersion model output in tabular form by clicking on the words “Tabular Output” on the Outdoor Air Model—Output page. A link to the SLAB model user guide is provided for a more detailed explanation of the tabular output.

If the User selects cesium chloride as the threat agent, the scenario available is the Dirty Bomb scenario. Radioactive sources emit energy that can damage living tissue.

ECAT evaluates radiation dose for three separate situations:
Yes, radiation dose measurements are available (such as obtained from calibrated radiation detection devices)
Diffuse Source (Detonated Dirty Bomb—no measurements available)
Point Source (Undetonated Dirty Bomb—no measurements available)

Radiation Dose Measurements are Available

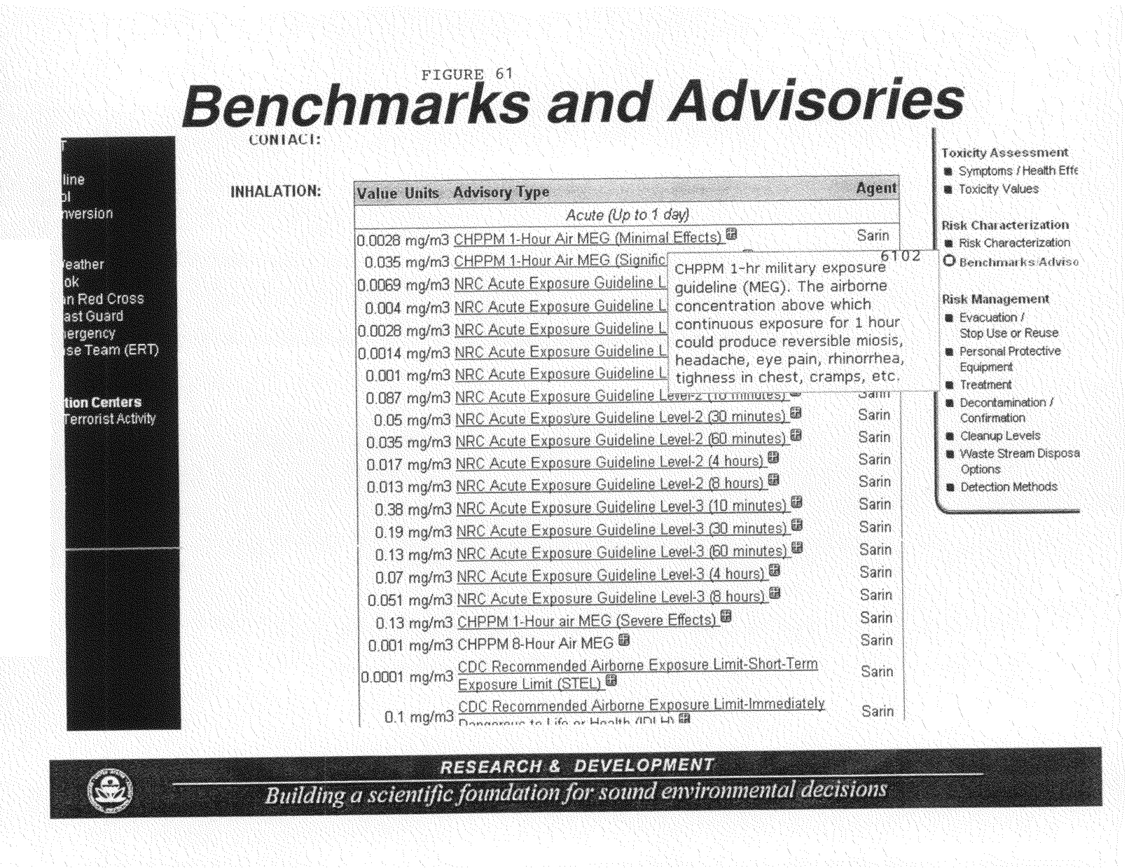

A measured dose may be available from radiation detection devices. Many of these are calibrated to give dose rather estimates at whatever point the device is exposed to the radiation source. The dose estimate taken from detection equipment can be from a discrete point source (such as an undetonated dirty bomb) or from a diffuse source (a detonated dirty bomb). If the radiation dose is known the user may select this option and input the radiation dose in rem. This dose will be compared to the Health Benchmark as well as alternative benchmarks and advisories in the risk characterization. FIG. 61 shows by way of an example of an ECAT system screen showing benchmarks and advisories. ECAT includes agent benchmarks and advisories for each of the exposure routes. To get more information about each advisory, the user simply holds the cursor over the advisory. A sub-screen related to the advisory being pointed to will appear such as sub-screen 6102.

Diffuse Source (Detonated Dirty Bomb)

The dirty bomb release is modeled using the Hotspot model, version 2.06, which was developed at the University of California, Lawrence Livermore National Laboratory (2005). The Hotspot Health Physics codes were created to provide emergency response personnel and emergency planners with a fast set of software tools for evaluating incidents involving radioactive material. Hotspot codes are a first-order approximation of the radiation effects associated with the atmospheric release of radioactive materials. The Hotspot codes are designed for short-term (less than a few hours) release durations.

Hotspot is a hybrid of the well-established Gaussian plume model, widely used for initial emergency assessment or safety-analysis planning. Virtual source terms are used to model the initial atmospheric distribution of source material following an explosion.

The International Commission on Radiological Protection (ICRP) Publication 30 Respiratory Tract and ICRP 30 Part IV Systematic models are the basis for the Dose Conversion Factors (DCFs). A one micrometer Activity Mean Aerodynamic Diameter (AMAD) is assumed.

Hotspot uses the Federal Guidance Document 11 (FGD 11) (EPA 1988) dose conversion factors for the cesium chloride dirty bomb scenario. These factors are based on a 50 year committed dose, but the biological half-life of cesium in the body is about 72 days. Due to the short biological half-life of cesium, the setting: Cs-137 D 3.0000E+01 y, was used. The class “D” setting was used to account for the relatively short biological half-life of Cs, and the 30 y refers to the radioactive half-life of 30 years. The use of FGR-11 for the estimation of non-cancer risks is conservative because the acute phase of the radiation dose-response (bone marrow suppression, GI effects, and developmental effects) would be expected to occur over the course of a few days to weeks. After this, time repair and compensation mechanisms may tend to make the acute response less symptomatic. Cancer risk will continue to increase over time as the radioactive isotope is retained in the body, producing high energy photons that can interact with DNA. Comparison of estimating doses using acute DCFs with 30 days of integration with estimations using DCF 11 showed DCF 11 to be slightly more conservative, but very similar to estimates using the acute DCFs.

If the option: “No, radiation dose measurements are not available (TEDE will be modeled)” is chosen, the User will be sent to a series of pages to make entries required to run the Hotspot model. The dirty bomb modeling component of ECAT requires input from the user regarding the release scenario. Input parameters for the dirty bomb model are described below.
Amount of Explosive (TNT Equivalent): Dirty bombs disperse radioactive isotopes with a primary explosive. In order to model the force of the explosion that disperses the radioactive isotope, the user is asked to supply the amount of explosive material in pounds of Trinitrotoluene (TNT) equivalent. For example, a conservative estimate of the TNT equivalent of an exploding vehicle gas tank is one pound.
Selection of Preferred Measurement Systems: This function allows the user to chose classic units for radiation measurement (curies, rem, rad) or international units (Sieverts, Grey, Becquerels), as well as English and metric distance units.
Radioactive Source Activity: The user will be asked to describe the amount of radioactive material involved in the explosion. Radioactive source activity is input in Curies (Ci).
Deposition Velocity: The Respirable Release component is the fraction of the total quantity of material involved in the fire, explosion, etc., that is respirable and available for dispersion into the atmosphere. This component has a separate respirable deposition velocity (default value of 0.3 cm/sec for non noble gases), and is used to determine the inhalation, ground shine and submersion doses due to the respirable component of the Material at Risk
Airborne Fraction: This is the fraction of the radioactive material that is released to the atmosphere. The most conservative assumption is that all of the material is released into the environment, and the default value is 1, to reflect that 100 percent of the isotope is released in the explosion. The user can modify this from the default value.
Respirable Fraction: The Respirable Release component is the fraction of the total quantity of material involved in the fire, explosion, etc., that is respirable and available for dispersion into the atmosphere.

Include 4 days of Ground Shine: Ground shine is the radiation produced by radioactive materials on a surface. Ground shine is the portion of the radiation dose that can come from being exposed to contaminated surfaces at a distance. The user can chose to ignore ground shine, or include a four day dose of exposure for persons remaining in the area of the explosion for a 4-day period.

Terrain: The City terrain factor accounts for the increased plume dispersion from crowded structures and the heat retention characteristics of urban surfaces, such as asphalt and concrete. The City terrain factor will estimate lower concentrations than the Standard factor, due to the increased dispersion from large urban structures and materials.

10-meter Wind Speed: Enter the wind speed, (m/s or mph), at a height of 10 meters/33 feet. If current wind speed information is unavailable, local wind conditions may be obtained by going to the links located on the left side of the screen and clicking on “Local Weather”. This will take you to the National Oceanic and Atmospheric Administration webpage where the name of a city and state may be entered to obtain current weather information. Radio buttons with the following wind speed selections are available:
0 to 4.25 miles per hour (mph)—Calm to light air: in light air, smoke drifts downward
4.26 to 6.49 mph—Light breeze: wind felt on face; leaves rustle
6.50 to 11.0 mph—Gentle breeze: leaves and twigs in constant motion
11.1 to 13.2 mph—Moderate breeze: raises dust and loose paper
Greater than 13.2 mph

Wind Direction: The wind direction drop-down menu allows the user to input the following 16 wind directions: West, North West, North North West, North, etc.

Sun Status: The sun status allows the user to pick the time of day in which the explosion occurs. This, along with wind speed, is used to determine the stability of the air.
Selection of Receptor: The receptors chosen earlier in the Exposure Assessment will be available to the user for input into the Hotspot model. Only one receptor can be chosen for each run of the model, and the dose to this receptor will be compared with the Health Benchmark and advisories in the Risk Characterization.
Breathing Rate: The breathing rate associated with the chosen receptor and level of activity are displayed. The user may modify the calculated breathing rate, however this will cause it to deviate from the estimated rate calculated for the chosen receptor and will affect the dose of radiation to that receptor.
Receptor Height: Height above the ground that the output dose data are determined. The default value is (1.5 meter). However, if you are interested at the dose an individual would receive upon a 30-m tower, you can change the receptor height to 30 m, etc. Ground deposition data are always determined at ground level (0 meter).

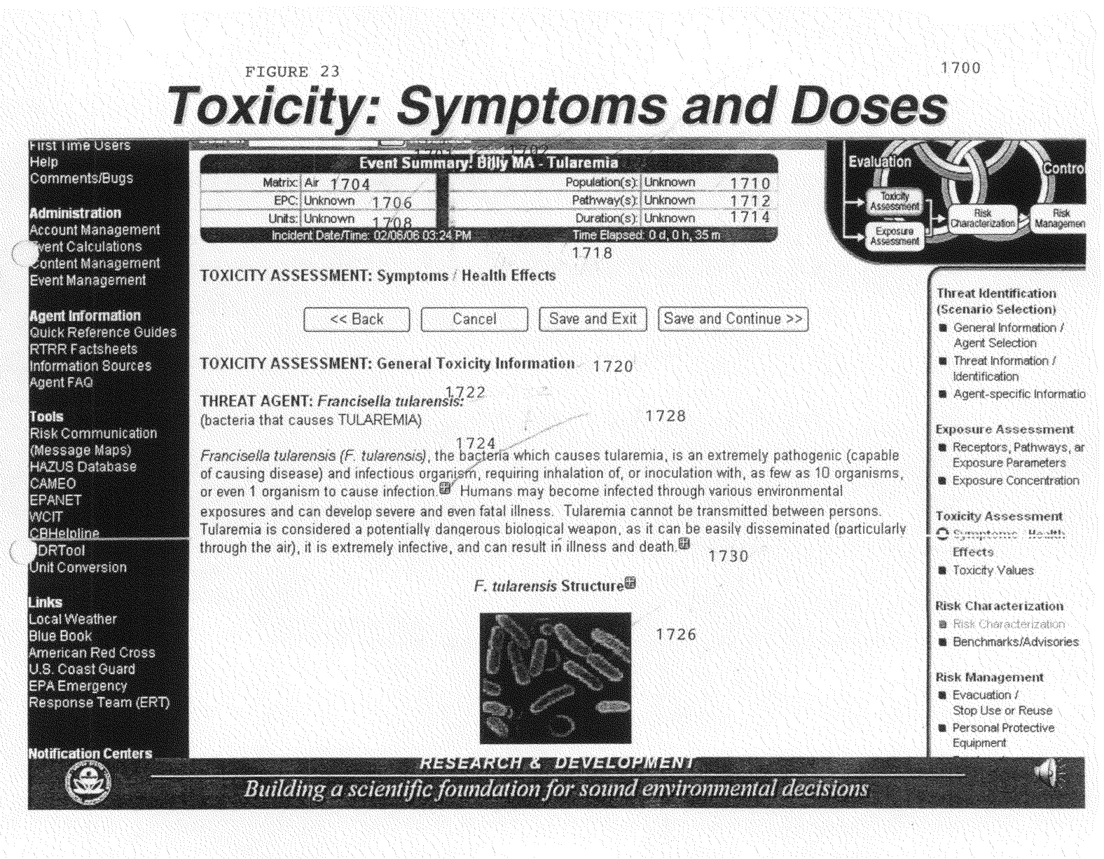

The user is next asked to run the Hotspot Model, which may take a few minutes. FIG. 23 shows by way of an example a tabulated result from running the Hotspot Model. Any changes in parameters, including changing receptors, will require the model to be rerun. Once the model has been run, the user can click on the Tabular Output, to get the estimated doses at discrete distances on a line downwind of the explosion. The Tabular output contains doses in rem, time-integrated air concentrations, ground surface deposition, ground shine rates, and estimations of arrival times of the radioactive plume at each distance from the explosion.

Radio buttons next to each row of data allow the user to chose a position downwind of the explosion for determination of the dose to the receptor and evaluation of the acute exposure cancer risk and hazard quotient for acute non-cancer effects (such as developmental toxicology and radiation sickness).

Point Source (Undetonated Dirty Bomb)

Undetonated dirty bombs are considered to be point sources. The dose absorbed by a receptor is a function of the time exposed, the distance from the source, and the amount of shielding (or dense matter between the source and the receptor).

The amount of time a receptor is exposed to a radioactive source is directly related to the dose received. The further a receptor is from the source the lower the dose will be for any given exposure time. As a rule, if you double the distance, you reduce the exposure by a factor of four. Halving the distance increases the exposure by a factor of four.

Calculation of point exposures can be carried out in one of two ways (Voss 2001):

(1) from the mass, or estimated mass, of an isotope or (2) from the activity of the source.

Activity of a source can be calculated from mass as follows:

A=SA×W

where,
A=Activity of source (Curies [Ci])
SA=Specific activity (Ci per gram)
W=Weight of source (grams)

Dose (or intake) can then be calculated using the activity of source and the distance from the source as shown below:

I=GRC×A/D²

Where:
I=Intake (rem per hour)
GRC=Gamma-ray constant (rem-square meters [m²])
A=Activity (Ci)
D=Distance (m²).

Toxicity Assessment

The toxicity assessment evaluates the evidence regarding the potential for a threat agent to cause an adverse effect in an exposed population. The toxicity assessment is comprised of a hazard assessment and dose-response assessment. The hazard assessment is the process of determining whether exposure to an agent can cause increased incident or severity of adverse effects (for example, a reduction in blood cholinesterase or the disease anthrax). Toxicity information is quantitatively evaluated in the dose-response assessment to determine the relationship between the dose of chemical administered and the incident of adverse effects. The dose-response data are used to derive toxicity values, that is, Health Benchmarks (H B), cancer slope slopes (CSF), and unit risk factors (URF), which can be used to estimate the potential for adverse effects or a cancer risk probability as a function of exposure (EPA 1989; EPA 2005a). ECAT contains default HBs and CSFs appropriate to the route of exposure chosen by the user.

The Health Benchmark is an estimated daily dose of a chemical at which no appreciable risk of noncarcinogenic effects is expected to occur in the human population (including sensitive subpopulations, like children). HBs are specific to the threat agent, exposure route, and duration. For dermal exposures, a gastrointestinal absorption factor (ABSgi) is applied to the oral HB to derive a dermal HB.

HBs are derived by selecting an appropriate low exposure level for the critical toxicological effect from the available data, such as a no-observed-adverse-effect level (NOAEL) or lowest-observed-adverse-effect level (LOAEL) and applying an uncertainty factor, if appropriate. The uncertainty factor is a composite of several factors (usually factors of 10), designed to address uncertainties because of species extrapolation, use of a LOAEL when a NOAEL is not available, study duration, sensitive subpopulations, etc. The general formula for derivation of an HB is:

HB=(NOAEL or LOAEL)/Uncertainty Factor

For carcinogenic agents that are presumed to have no threshold dose (i.e., every dose, no matter how small, carries some risk). CSFs are used for oral exposure to represent the estimated increased risk for each unit of ingested dose associated the development of cancer in a human population. URFs are used to represent the increased risk from exposure to each unit of chemical concentration in the media (water or air). CSFs and URFs are specific to the threat agent. Although there is some evidence that single exposures can lead to cancer, IRIS currently includes risk-based factors for chronic exposures.

CSFs and URFs are derived for chronic exposures from available animal and human data. Each of these factors represents an upper bound on the increased cancer risk from a lifetime exposure to an agent. This estimate is usually expressed in units of proportion (of a population) affected per unit exposure (i.e., risk per mg/kg-day for oral CSF, or risk per mg/m³ for inhalation URF, is generally reserved for use in the low-dose region of the dose-response relationship, that is, for exposures corresponding to risks less than 1 in 100. URFs represent the increased cancer risk from exposure to a unit chemical concentration in the media. Oral URFs for drinking water are derived from CSFs by assuming the standard daily water intake. Inhalation URFs are derived directly from data with the assumption that air concentration is the appropriate metric for inhalation cancer risk.

The toxicity assessment features of the ECAT system are activated as soon as an agent is selected or identified. For biological threat agents, toxicity assessment is used synonymously with infectivity/virulence assessment. FIG. 23 shows by way of an example an ECAT screen 1700 regarding symptoms and doses related to toxicity. In this example, the threat agent is tularemia 1703 which is clearly identified along with the name 1702 of the person making the report in event summary 1701. The event summary 1701 contains further detail information as the matrix 1701 in which the threat agent is released, the Exposure point concentration (EPC) 1706 of the threat agent, the units 1708 of thread agents released, the population 1710 in which the thread agent may be exposed to, the pathways 1712 the threat agent is traveling in, the duration 1714 in which the thread agent has been present, the incident date and time 1716 and the time elapsed 1718 since the reporting of the event.

On screen 1700, there is given a toxicity assessment 1722 identifying the name of the threat agent 1722, general toxicity information of the threat agent 1724 and a pictorial structural depiction of the threat agent 1726. From the general toxicity information, should a user wish to dig deeper into the general information about the thread agent, there are a number of icons 1728 and 1730 which can be clicked to obtain more detailed information.

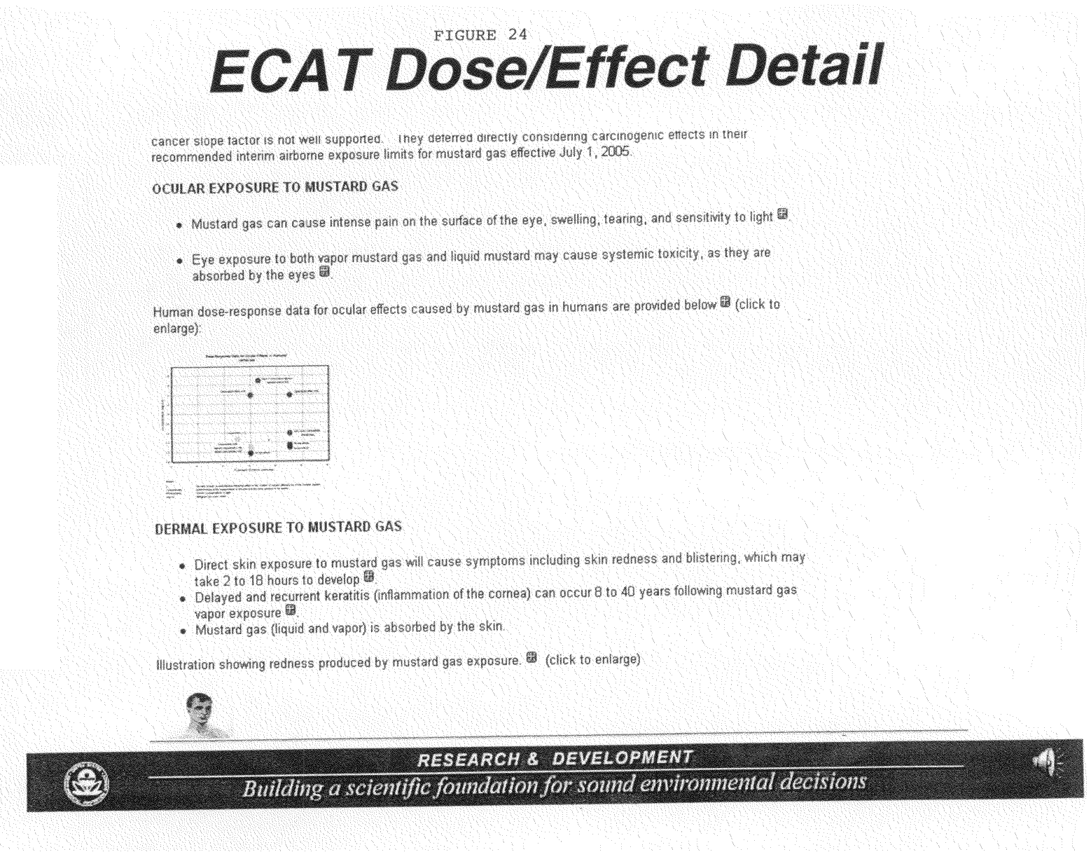

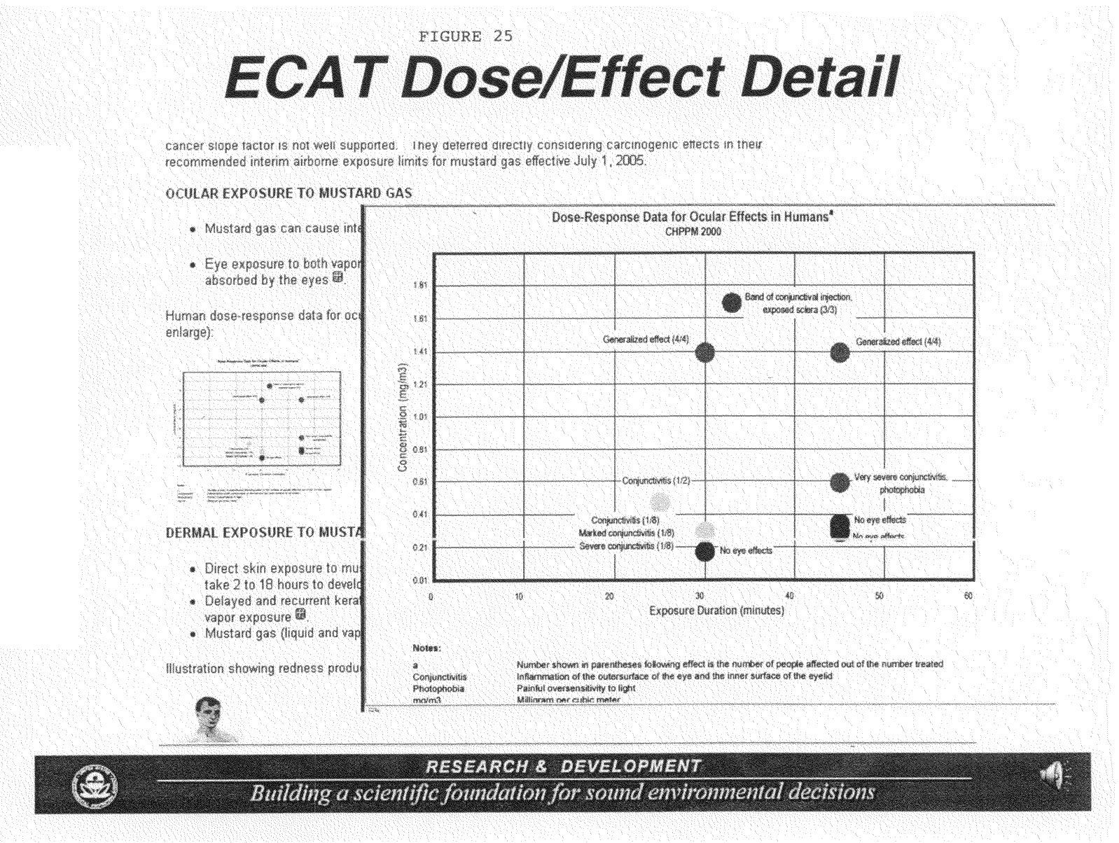

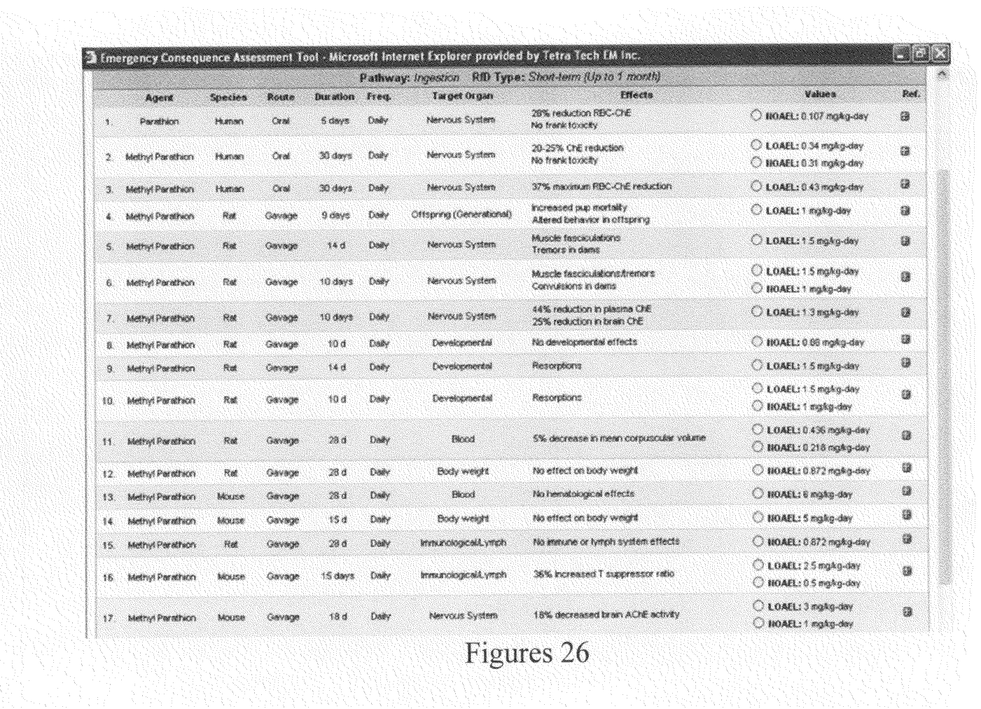

Thumbnail sized information can also be opened in a new window for more detailed analysis of how exposures of the threat agent by inhalation, ingestion, or dermal/ocular exposure may cause. FIG. 24 shows by way of an example an ECAT system screen of a dose/effect detail, and FIGS. 25 shows by way of an example a tabulated result of a dose-response data for ocular effects in humans.

Information regarding chemical threat agent toxicity was collected from sources such as EPA's Integrated Risk Information System (IRIS), Provisional Peer Reviewed Toxicity Values (PPRTV), the Centers for Disease Control (CDC), the Agency for Toxic Substances and Disease Registry (ATSDR) toxicological profiles, and the National Institute for Occupational Safety and Health. Toxicity information provided by ECAT for chemical threat agents includes target organ/system and effects (symptoms), mode of action, and available toxicity information (NOAELs and LOAELs) as a function of exposure duration.

For most chemical threat agents, toxicity data exists to derive toxicity values (either an HB or CSF), which can be used to quantify risk. Where adequate data is available, ECAT contains preselected HBs and CSFs for the acute, short-term, and intermediate exposure durations. The preselected (or default) toxicity values are displayed on the Toxicity Assessment screen. For the estimation of noncancer risk, if users do not want to use the default Health Benchmarks, ECAT provides an option for creating a customized toxicity value.

For biological agents, the toxicity information includes a description of the disease caused by exposure to the threat agent (for example, inhalational anthrax caused by exposure to Bacillus anthracis spores), symptoms, and information on infection rates. Available data pertaining to infectious doses (that is, the amount of a bacteria or virus that is sufficient to cause infection) or lethal doses (for example, the _{LD50}, which is the amount of an agent that will be lethal to 50 percent of the exposed population) have been compiled when available. Little to no dose response data is available for biological agents, which complicates the assessment of risk.

For radiological agents an HB approach, similar to the one used for chemical agents, is used for noncarcinogenic effects. The radiological HB is derived in the same way as that for chemical agents, but the noncarcinogenic effect is elicited from external exposure, rather than by direct contact/ingestion. The calculation of carcinogenic risk from exposure to radiological agents is carried out using a general CSF for beta and gamma radiation doses (ISCORS 2002).

Sources of Posted Toxicity Information

Toxicity information, including RfDs, RfCs, MRLs, NOAELs, LOAELs, LD50s, LC50s, etc., was obtained from a variety of sources, including EPA's IRIS, the ATSDR, and the peer-reviewed literature. By September 2006, inputs from other sources, such as CBHelpline, the Compilation Project, and the draft Provisional Advisory Levels projects may be available to supplement the existing toxicity information currently housed in ECAT.

Media-Specific Displays

As explained under the Content Management discussion in Section 8.1, administrative users may select whether toxicity data and screen output appear for only specific media (corresponding to exposure routes). In other words, data for ingestion and inhalation may be presented, or administrators can select to show only ingestion toxicity data, if the user has selected ingestion as the exposure route.

Customized Toxicity Benchmarks

An option to create a customized toxicity value for toxic industrial chemicals is available, for experienced toxicologists who prefer to evaluate all the data and customize a toxicity value.

ECAT first calculates a risk estimate using the default toxicity values called Health Benchmarks (HB); the default values are displayed on the TOXICITY ASSESSMENT: Toxicity Values screen; information concerning the basis for the default toxicity values can be displayed by clicking on the value and opening a popup screen.

When Save and Continue is selected, the User moves to the RISK CHARACTERIZATION screen where the numerical risk estimate is displayed (see also Section 6 below). The table containing the risk estimate will also display the default toxicity value and a “Custom” option. When “Custom” is selected by the User, all available agent-specific toxicity studies contained within ECAT will be displayed. Study information includes, when available, the agent name, test animal species, exposure route and duration, dosing frequency, target organ, effect(s), and study NOAEL and/or LOAEL; the study reference is also available. A radio button is used to select a study for creation of the custom toxicity value; the screen allows the application of an uncertainty factor between 10 and 10,000.

ECAT will calculate the custom toxicity value (or HB) and display the value for the User; the User may then select “Apply New HB Value” or “Cancel”; the User is then taken back to the RISK CHARACTERIZATION screen. The re-calculated risk estimate will be displayed. The User may return to the default toxicity values by selecting “Default” on the RISK CHARACTERIZATION screen. FIG. 25 shows by way of an example an ECAT system screen of the calculated custom toxicity value.

Risk Characterization

In the risk characterization step, information collected during the exposure assessment and toxicity assessment are summarized and used to generate a quantitative or qualitative estimate of risk. Standard methodology (EPA 1989) for calculating noncancer risk is used to quantitatively assess the risk of an adverse effect after exposure to a chemical threat agent. Risk associated with exposure to a biological threat agent is qualitatively assessed due to a lack of quantitative toxicity data. Although ECAT includes data on infectious or lethal doses when available, for most bioagents dose response information is not available and methods for using such information in a risk characterization are still under development by EPA and other agencies.

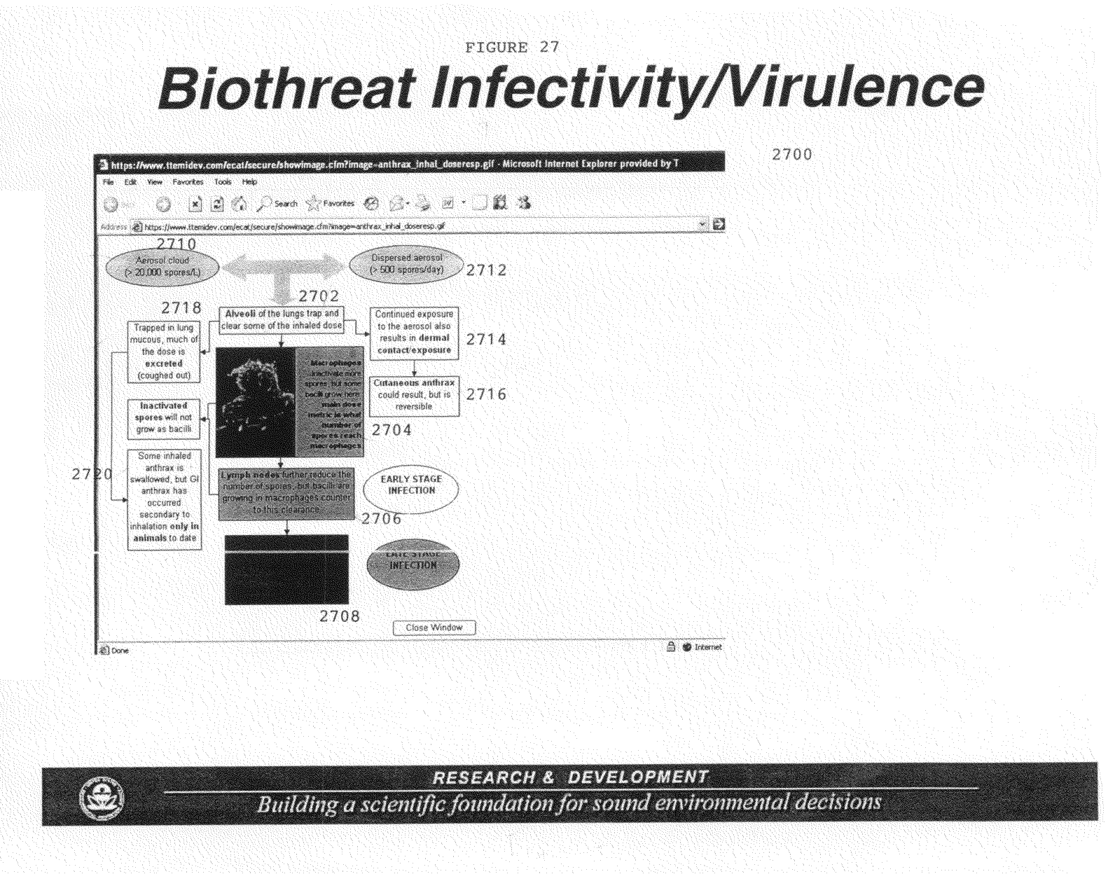

FIG. 27 shows by way of an example of an ECAT system screen 2700 illustrating bio-threat infectivity and virulence information. In this example, the threat agent is identified as anthrax. There is an explanation indicating alveoli 2702 is the specific part of a body this threat agent attacks, follow by a pictorial depiction of how macrophages 2704 are affected, how lymph nodes 2706 are affected and how blood is affected. In this example, there are also shown two pathways for anthrax to travel, first is by aerosol cloud 2710 and second is by dispersed aerosol 2712. If pathway is through dispersed aerosol 2712, then in addition to inhalation exposure, there is also a possibility of dermal exposure 2714. However, it is explained that cutaneous anthrax 2716 could result, but the effect is reversible.

On the other hand, if anthrax is traveled through aerosol cloud and inhaled by a person, then the anthrax will be trapped by lung mucus and the person will attempt to excrete the anthrax by coughing as explained in 2718. It will further explain in 2720 that some inhaled anthrax is swallowed but GI anthrax has occurred secondary to inhalation by animals to date.

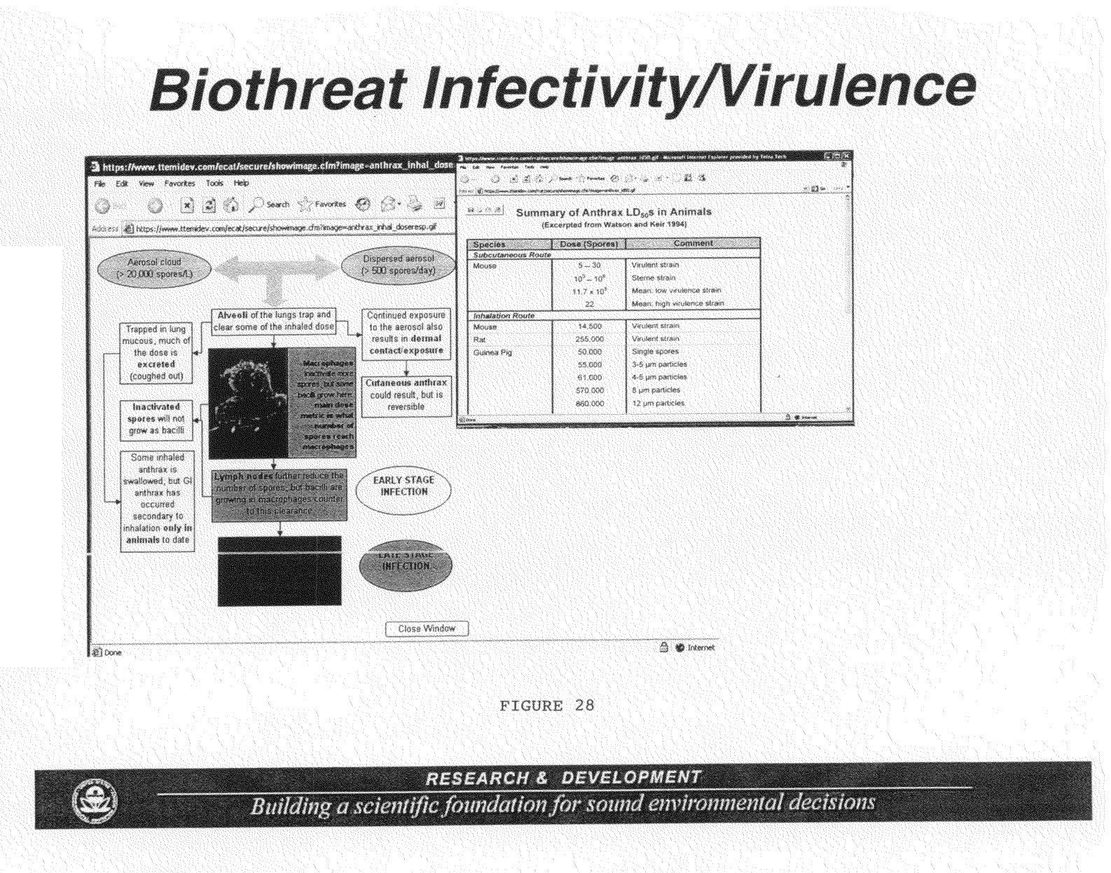

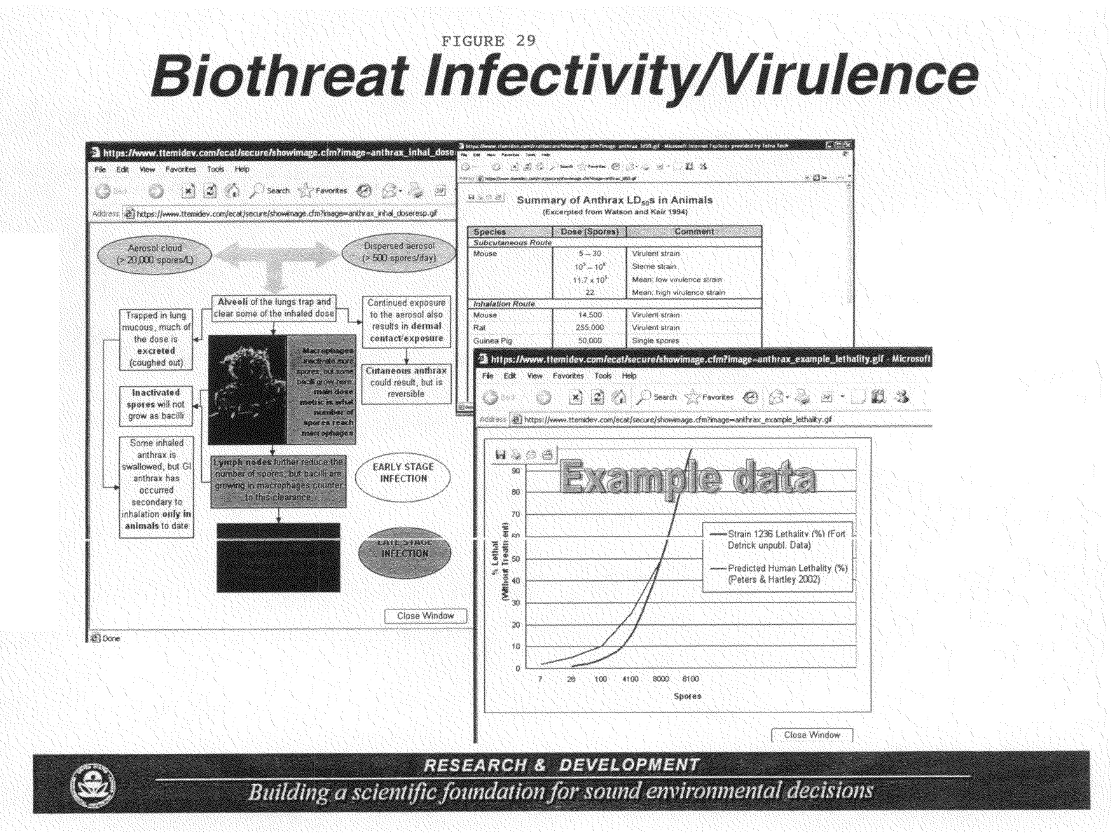

FIG. 28 shows by way of an example a screen providing a summary of anthrax in animals. FIG. 29 shows by way of an example a screen with example data charted in percentage lethal versus quantity of spores. The thumbnail dose-response curves and tables of relevant date, when enlarged, provide links to primary and secondary literature to enable quick research by science advisors and other reachback staff.

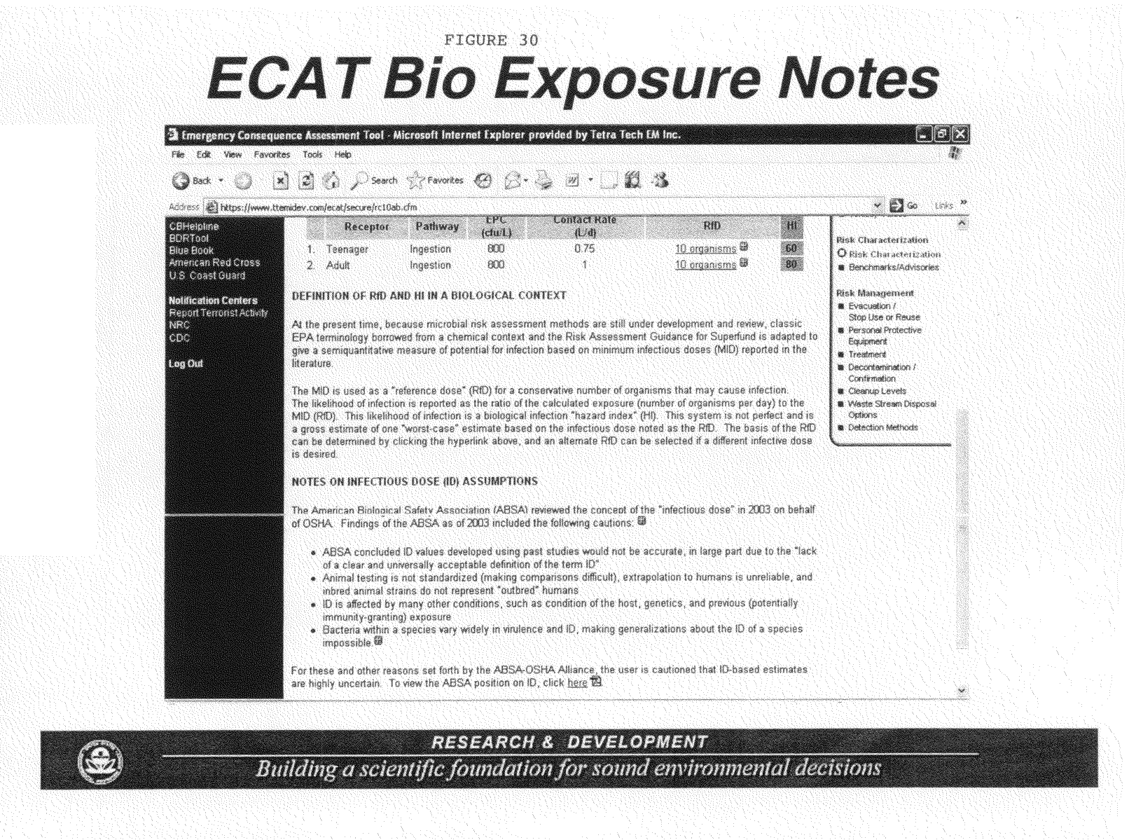

Furthermore, bio exposure notes are also made available in the ECAT system, as shown by way of an example in FIG. 30. These notes would for example provide information regarding controversial and evolving methods such as quantitative microbial risk assessment approaches are updated and annotated according to current science, guidance and policy.

Methodology for estimating risk for chemical and biological threat agents is summarized in the following sections.

Chemical Threat Agents

The potential for adverse effects from exposure to noncarcinogenic chemicals are evaluated by calculating a chemical-specific hazard quotient (HQ). The HQ is the ratio of the actual or predicted exposure level or intake and the toxicity value (IRIS value or customized toxicity value). For carcinogens presumed to have no toxicity threshold, the cancer risk is calculated by using the CSF or URF to convert the predicted exposure level or intake into a probability that a receptor will develop cancer.

The predicted exposure level or intake is calculated using the EPC and exposure parameters selected for each scenario (for example, the drinking water ingestion rate for a toddler receptor). As discussed earlier, the exposure durations considered in the ECAT are up to 1 year.

Therefore, ECAT can provide estimates of acute, short-term, and intermediate noncancer risk, provided suitable toxicity values are available. For carcinogens ECAT provides both a chronic (averaged over a lifetime) cancer risk estimate and an acute cancer risk estimate. The following text describes the equations used to estimate noncancer hazards and cancer risk probability (acute and lifetime).

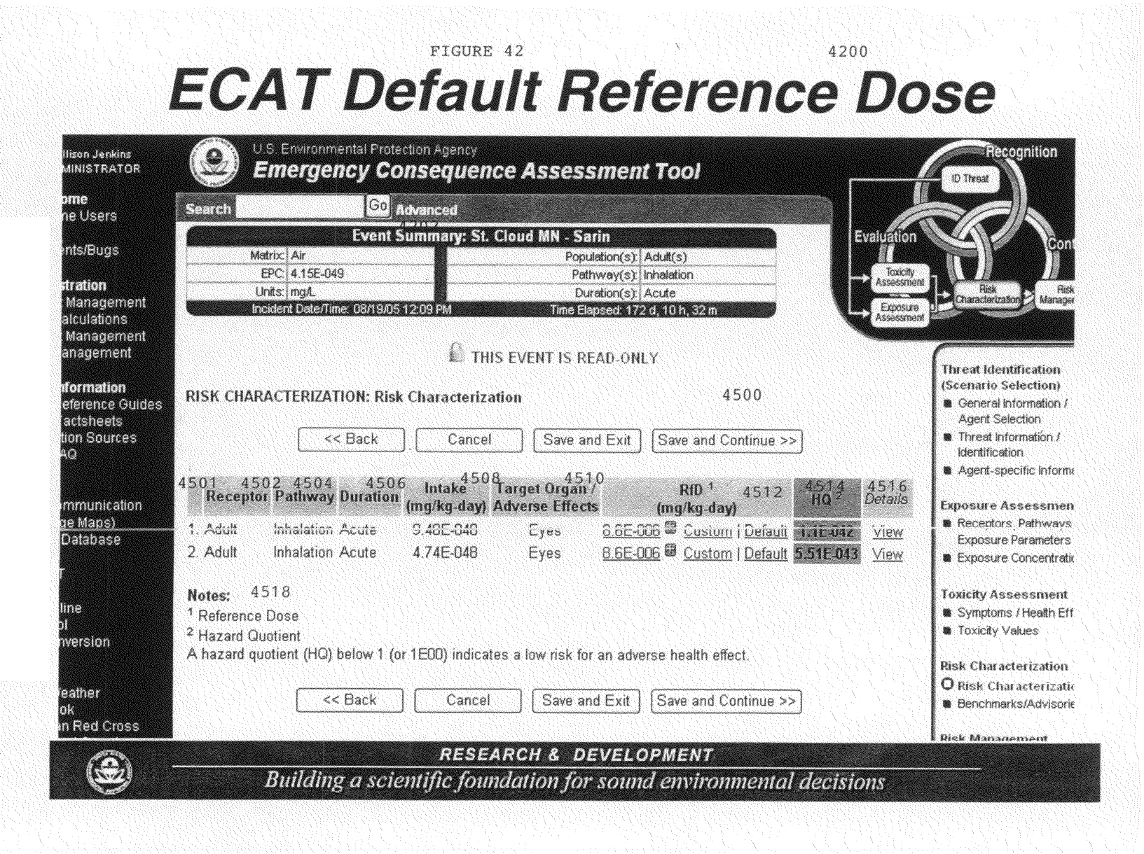

FIG. 42 shows by way of an example an ECAT system screen showing risk characterization including the ECAT default reference dose. For the convenience of the user, an event summary 4202 including major details of the incident in which the risk characterization is given are shown. In terms of the actual risk characterization report, a table 4500 organized in rows and columns is shown. In this table, there is a column 4501 dedicated to the item identification, a receptor type column 4502, a pathway column 4504, a duration column 4506, an intake column 4508 with units of mg or mg per day, a target organ or adverse effects column 4510, a default reference dose or default health benchmark in column 4512 with units of mg or kg per day, a hazard quotient column 4514, and a further details column 4516. There is also a separate notes 4518 portion to communicate important information. ECAT calculates a hazard quotient as shown in column 4514 using the default reference dose for the threat agent of interest.

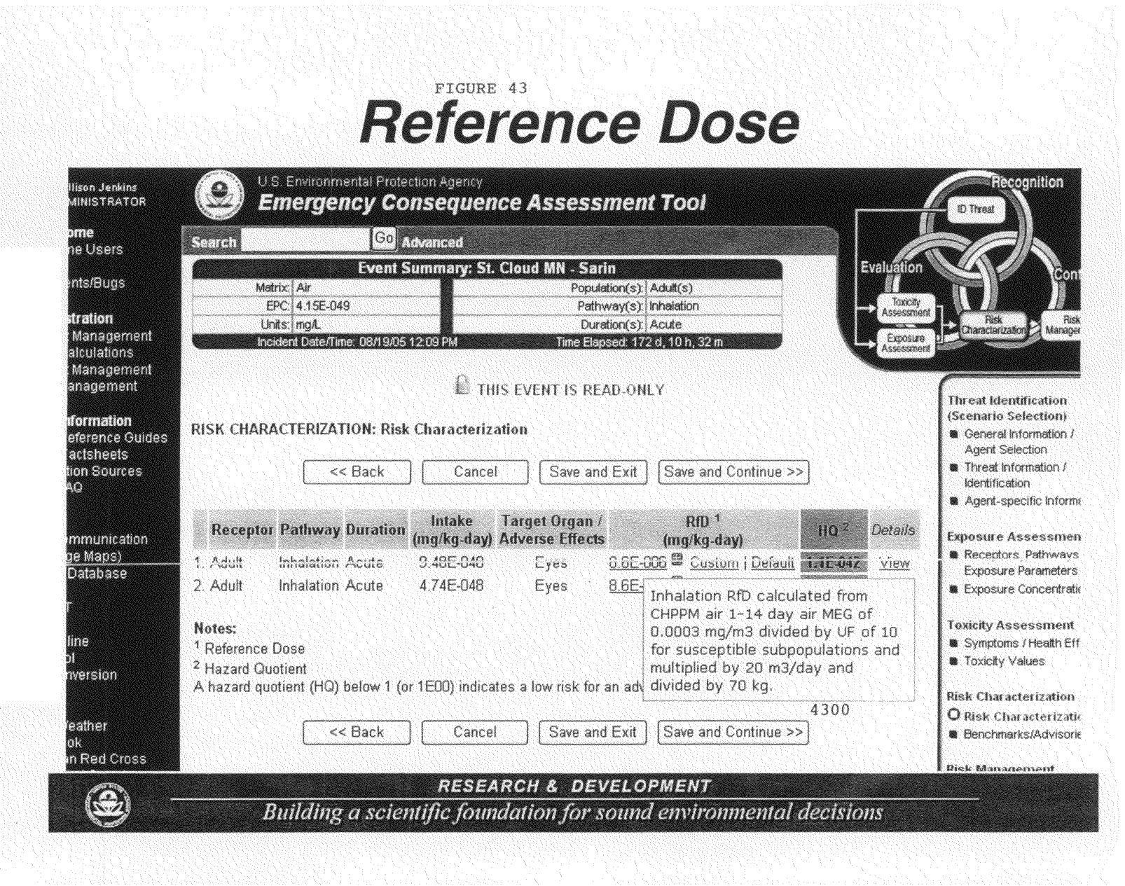

If the basis of the default reference dose is desired, the user may place a mouse cursor over the RfD icon, a sub-screen 4300 communicating how the basis of the default reference dose is derived will be shown. FIG. 43 shows by way of an example an ECAT system screen showing the basis of the default reference dose.

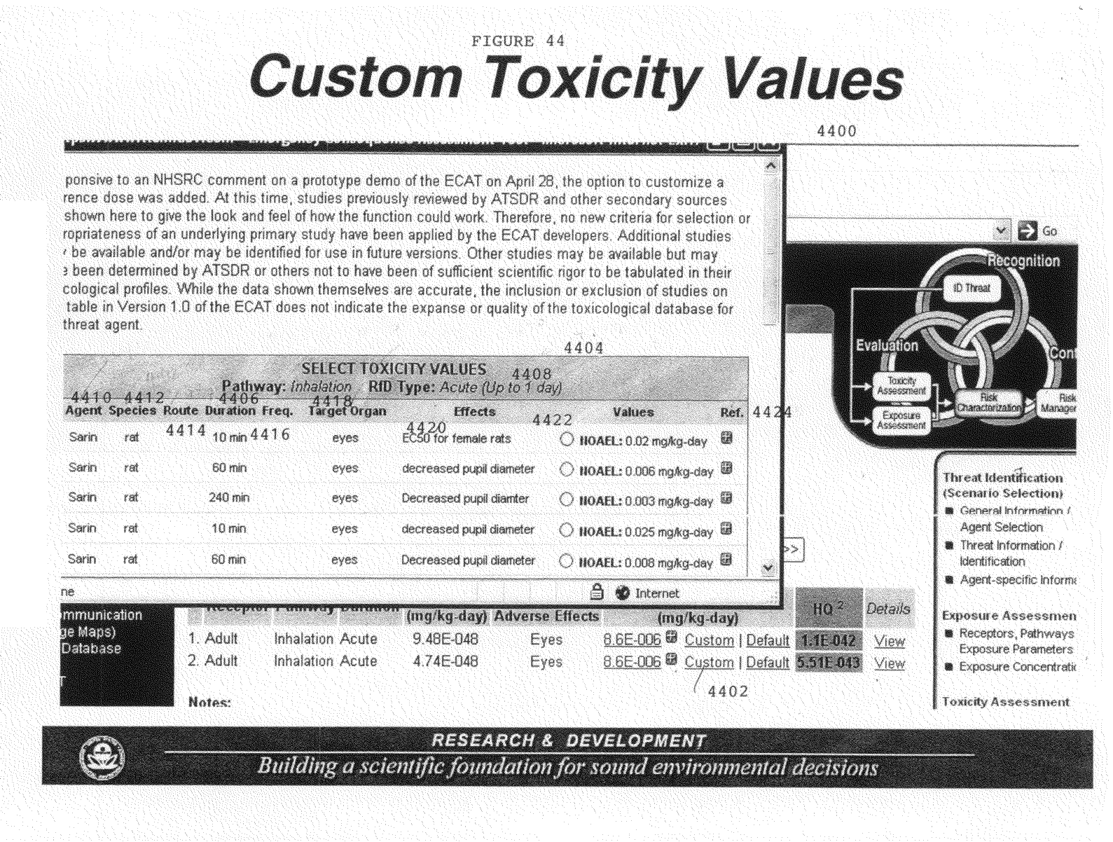

If the user would like to use custom reference dose for calculation instead of the default reference dose, the user may click on a custom icon. FIG. 44 shows by way of an example an ECAT system screen showing custom toxicity values for hazard quotient calculations. As shown, if the user clicks on the custom icon 4402, a sub-screen containing custom toxicity value information 4400 appears. In it, there is a table 4404 organized in rows and columns containing user selectable toxicity values. On the header of Table 4404, there are indications of pathway 4406 and default reference dose type 4408. Among the tabulated information contain an agent column 4410, a species column 4412, a route column 4414, a duration frequency column 4416, a target organ column 4418, an effects column 4420 a selection column 4422 with values to be selected and a reference column 4424. This customization capability of the ECAT system provides greater flexibility to suit the scenario faced by the user and renders the ECAT system a more powerful tool for emergency assessment and management.

Calculation of Noncancer Hazards

A chemical-specific HQ is calculated using risk assessment paradigm equations found in the EPA's RAGS Part A (EPA 1989). For example, a HQ for oral exposure based on the HB is represented by the equation:

HQ=I/HB

where:
I=Predicted oral dose or intake (e.g., amount of the agent that is ingested, inhaled, or absorbed through the skin per day; mg/kg-day)
HB=Health Benchmark (mg/kg-day)

Using the equation above and the exposure information input by the user, ECAT calculates an HQ. For noncancer hazards, an HQ of 1 or less indicates there is no risk (or a low risk) of adverse effects. The target organ/adverse effect (upon which the toxicity value is based) is also returned by ECAT along with the HQ.

Calculation of Carcinogenic Risk

For chemicals that are known carcinogens presumed to have no toxicity threshold, the chemical intake is used to estimate cancer risk probability. For example, for oral exposures, the cancer risk is calculated using the estimated intake (or dose) and the CSF, as shown in the general equation below:

Cancer Risk=I×

CSF where,
I=Predicted dose or intake (e.g., amount of the agent that is ingested per day; mg/kg-day)
CSF=Cancer slope factor (mg/kg-day)⁻¹

Studies on cancer risk are carried out at high doses over the course of a lifetime. The reason for this is that cancer occurs at a low rate in populations that are not exposed to any known carcinogen and the development of cancer requires many sequential changes to the genetics and function of a cell line. In order to develop cancer a cell line goes through stages of abnormal function from atypical presentation to metaplasia (benign tumors), and finally to cancer. To capture these changes in a study, lifetime exposures and high doses are used to increase the probability of detection of the rare event of cancer formation. Doses from studies are extrapolated from the relatively high exposures of studies to the often much lower exposures that may occur in the environment. In order to be conservative, assumptions of “no threshold” and linearity are made. The no threshold assumption means that there is no dose of a carcinogen that is without risk for causing the development of cancer. The linearity assumption means that a consistent increase in risk is associated with each incremental increase in dose.

Recently, EPA has suggested that doses of mutagenic carcinogens (those that directly damage DNA) should be modeled assuming different risks at different life-stages of the receptor (EPA 2005a). The rationale for the adjustment of cancer risk based on different life-stages is detailed below. For carcinogens that are mutagenic, a “less than lifetime” cancer risk may be calculated (EPA 2005a).

For adults, the “less than lifetime” cancer risk is calculated using the equation below:

Less than Lifetime Cancer Risk (Adult)=(I×TWAF)×CSF

Where:
I=predicted dose or intake (mg/kg-day)
TWAF=Time-weighted adjustment factor (unitless) equal to the exposure duration (years) divided by the expected lifetime (70 years)
CSF=Cancer slope factor (mg/kg-day)⁻¹

Exposure to a mutagenic carcinogen during a critical lifestage (that is, childhood) may increase a receptor's susceptibility to cancer; factors that may contribute to an increased susceptibility include:
Cells divide more frequently in children, therefore there is a greater potential for a mutation to become fixed (rather than being repaired)
Some embryonic cells lack key DNA repair enzymes
Some components of the immune system are not fully functional during development
Hormonal systems operate at different levels during different lifestages
Induction of developmental abnormalities can result in a predisposition to cancer later in life

To calculate the “less than lifetime” cancer risk for a child, an age-dependent adjustment factor (ADAF) is applied to the CSF. The ADAF factors vary based on the age of the exposed individual, and are used to account for differences in susceptibility to mutagenic carcinogens at different stages during childhood.

The following ADAF factors are based on those derived by EPA for mutagenic carcinogens where data indicates an increased susceptibility during childhood exposure (EPA 2005a):
Age 0 to 3 years: ADAF=10
Age 3 to 18 years: ADAF=3
Age >18 years: ADAF=no adjustment

The age categories used reflect those in ECAT and have been slightly modified from those derived by EPA (EPA 2005a). Changes made are conservative, and in all cases reflect the application of the higher ADAF for a given age. Therefore the equation for the “less than lifetime” cancer risk for a child (aged <16 years) is represented as:

Less than Lifetime Cancer Risk (Child)=(I×TWAF)×(CSF×ADAF)

Where:
I=Predicted dose or intake (mg/kg-day)
TWAF=Time-weighted adjustment factor (unitless) equal to the exposure duration (years) divided by the expected lifetime (70 years)
CSF=Cancer slope factor (mg/kg-day)⁻¹
ADAF=Age-dependent adjustment factor (unitless)

Generally, cancer risks below 10⁻⁶ (or 1 in 1,000,000) are below the cancer risk management range and no further action may be warranted to reduce exposure. Cancer risks between 10⁻⁶ and 10⁻⁴ fall in the risk management range. A cancer risk probability greater than 10⁻⁴ (1 in 10,000) may represent an excess cancer risk and action may be warranted to reduce exposure.

Biological Threat Agents

HBs are not available for biological agents. No “safe” dose of bacteria or virus particles have been identified. Risk of infection due to exposure to a biologic threat agent is qualitatively assessed by ECAT. That is, the EPC (or net exposure) is compared to any available infection metrics (infectious doses or lethality information).

Radiological Threat Agents

All radiologic agents are capable of producing both cancer and the more acute effects of radiation sickness. Radiation damages living tissues by damaging DNA, proteins, and other large molecules. This damage can lead to cell death, especially in those cells that divide quickly or can lead to mutations that may eventually lead to cancer. The effects on rapidly dividing cells lead to the symptoms of radiation sickness: nausea (damage to stomach lining), reduction in blood cells (damage to the bone marrow), paleness of the skin (damage to skin cells). The noncancer effects of radiologic agents are evaluated using the same HQ method that was described for noncancer effects of chemical agents.

The cancer effects of radiologic agents are also evaluated based on the same acute exposure methods used for carcinogenic chemicals in ECAT. Cancer risk for exposure to radiologic agents is based on an estimated CSF of 8×10⁻⁴ per rem for low linear energy transfer radiation (gamma and beta radiation) (ISCORS 2002). Cancer risk due to less than lifetime exposures for radiological agents are calculated in ECAT based on the same methodology described above for other mutagenic carcinogens.

As part of the risk characterization, ECAT provides a summary of available duration-, pathway-, and media-specific benchmarks and guidelines for comparison purposes. Tabulated benchmarks and guidelines include, but are not limited to:
Federal Maximum Contaminant Levels for drinking water
EPA 1-day, 10-day, and lifetime Drinking Water Health Advisory Levels
ATSDR Minimal Risk Levels (MRL)
   U.S. Army Center for Health and Promotion and Preventative Medicine Military Exposure Guidelines
   Occupational standards, such as the National Institute for Occupational Safety and Health Recommended Effect Limits, Occupational Safety and Health Administration Permissible Exposure Limits, and American Council of Governmental Industrial Hygienists Threshold Limit Values.

Risk Management

ECAT contains risk management information including guidance on evacuation/stop use or reuse, personal protective equipment (PPE), treatment, decontamination methods, and sampling.

Evacuation/Stop Use or Reuse

Information regarding the evacuation measures that may be necessary after the release of a threat agent is summarized in ECAT. In addition, where available, ECAT provides information regarding when the use of impacted drinking water should be stopped.

Personal Protective Equipment

Agent-specific information for PPE is provided, if available. Sources of PPE information include: EPA's Quick Reference Guides (QRG) for First Responders, the Quick Selection Guide to Chemical Protective Clothing (Wiley-Interscience), the Occupational Safety and Health Administration (OSHA), and the National Institute for Occupational Safety and Health (NIOSH).

When available, information regarding protective suit and glove material and respirator selection information is provided.

Note: The user is advised to consult the appropriate site- or incident-specific health and safety plans or designated site health and safety personnel prior to entering an area of suspected contamination.

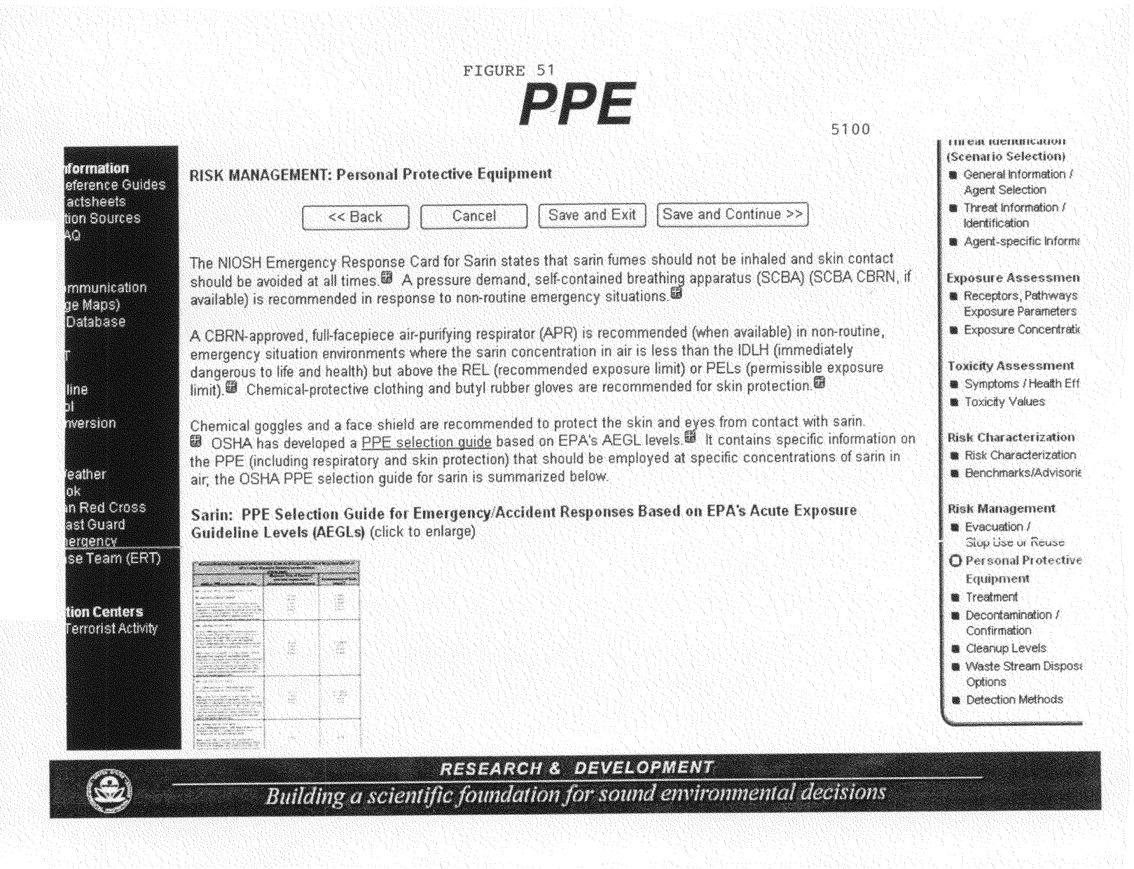

FIG. 51 shows by way of an example an ECAT system screen showing personal protection equipment information. The personal protection equipment information provided is threat agent specific. Screen 5100 shows sample personal protection equipment information pertaining to the threat agent sarin. Part of this PPE information also includes a PPE selection guide for emergency/accident responses base on EPA's acute exposure guideline levels. This guideline can be enlarged to reading or printout conveniences.

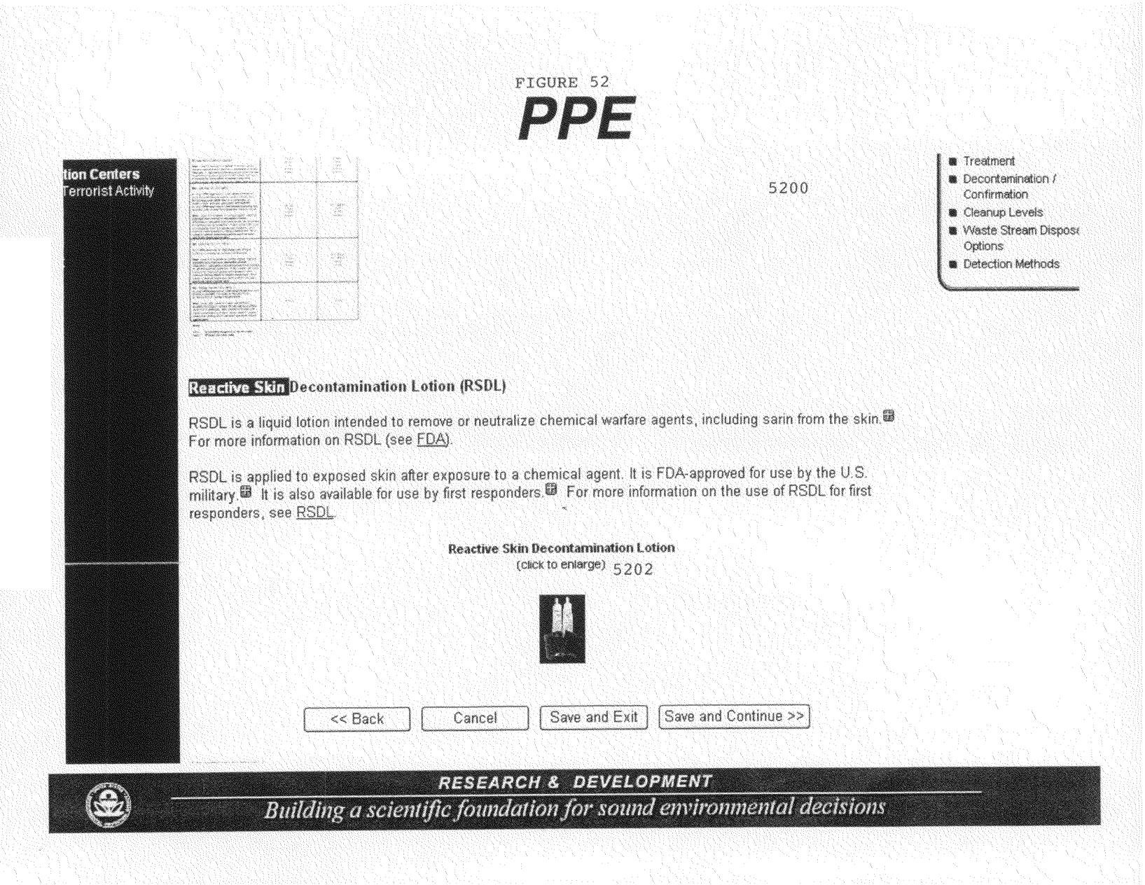

FIG. 52 shows by way of an example an ECAT system screen continuing the information from FIG. 51. In screen 5200, information on commercially available products that assist with removal or neutralization of threat agents is also provided. Furthermore, a pictorial depiction of the commercially available products is also shown and the pictorial depiction can be enlarged for viewing or printout conveniences.

Treatment

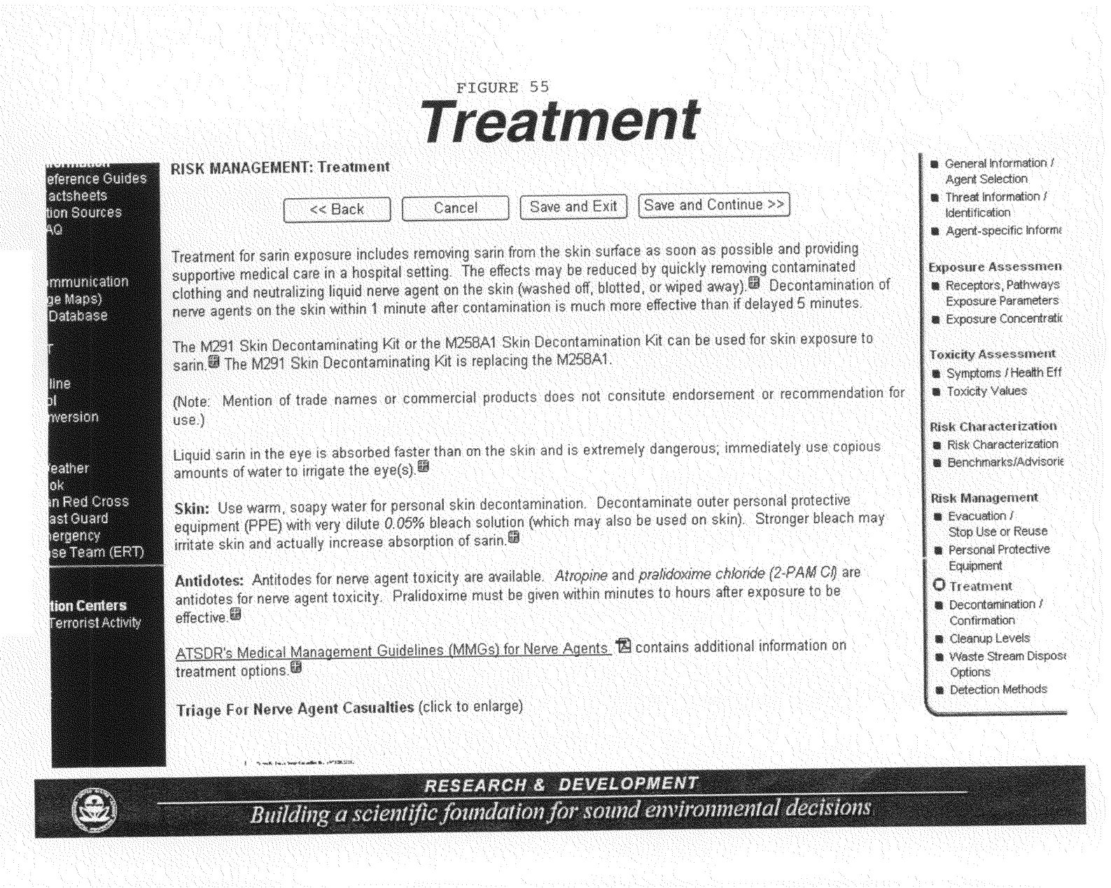

ECAT is not intended to serve as a definitive source of medical treatment information, if available. ECAT provides a summary of treatment information available from federal agencies, such as the CDC, ATSDR, and EPA's QRGs. FIG. 55 shows by way of an example an ECAT system screen showing treatment information for sarin exposure. The user is advised to seek medical advice from trained medical personnel.

Decontamination Methods

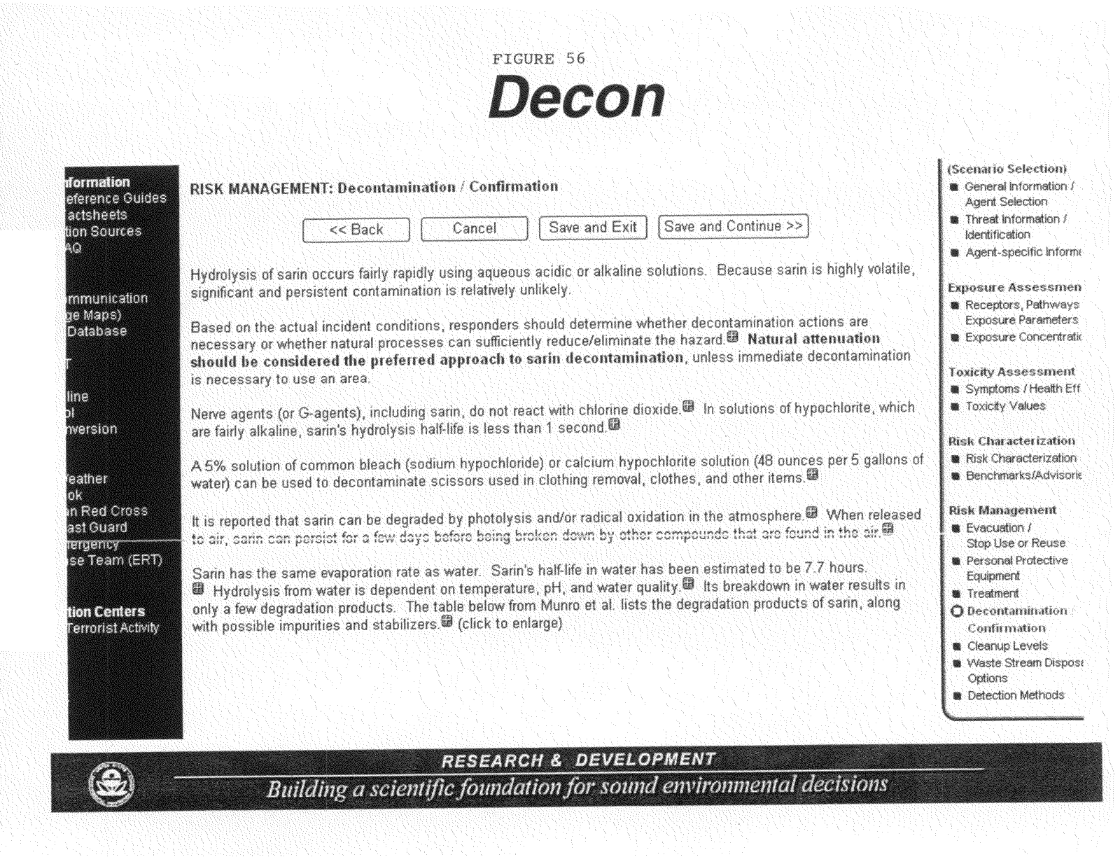

ECAT provides information regarding decontamination agents and methods. Information from various agencies has been compiled, including information contained in EPA's QRGs. FIG. 56 shows by way of an example an ECAT system screen showing decontamination information of sarin. In this example of a sarin threat agent, ECAT also includes information on its breakdown in air, evaporation rate, and breakdown products in water.

Sampling

ECAT contains information to aid in confirmation sampling (that is, to confirm the release of a threat agent) and decontamination sampling (that is, to confirm the efficacy of decontamination efforts.

Sampling methods for various matrices, for example, solid surfaces, water, and air are summarized.

Calculation of Risk-Based Cleanup Goals

Risk based cleanup goals (RBCG) for chemicals with potential adverse noncarcinogenic effects are calculated using the same equations used to calculate a chemical-specific HQ. The RBCG is the ratio of the Health Benchmark and the actual or predicted dose or intake.

A chemical-specific RBCG is based upon a target HQ (or hazard index) of 1 for noncarcinogens. The primary equation used to determine a chemical-specific RBCG is found in the EPA's RAGS Part A (EPA 1989) and RAGS Part B (EPA 1991) and is represented by the equation:

RBCG=HB/

I where:

I=Predicted dose or intake (e.g., amount of matrix ingested or inhaled per day; mg/kg-day or liters per kilogram per day [L/kg-day])

HB=Health Benchmark (mg/kg-day)

Dose or intake is calculated as described above. Exposure parameters used in the intake equation are based upon the input parameters provided by users.

In most cases RBCGs are not listed for biological threat agents in ECAT, however these are added where data is available. Information on infective doses of microorganisms is complicated and specific data for each organism is required. An estimate of a risk-based clean-up goal for Anthrax is included in ECAT. The clean-up level is based on suggestions by the National Research Council (NRC 2004). The calculations for these clean-up level goals are based on the concentration in the air that comes from spores that are resuspended from room surfaces.

Assumptions for Bacillus anthracis resuspension risk include:
(1) A dose-response relationship for anthrax inhalation that is derived based on data from Druett et al. (1953) which was fitted to the following exponential equation from Haas (2002) (both as cited in NRC 2004):

p=1−exp(−7.16×10⁻⁶×d)
where,
   p=Risk (unitless)
   d=Dose (per exposure)
(2) This model is for a non-threshold dose-response relationship (that is, there is no dose that is without some risk of infection) and the suggested target risk level (p) used here is 10⁻⁷ (NRC 2004).
(3) The dose is calculated based on the respiratory rate of the exposed individual and is based on the same assumptions as those detailed above and in Table 2.
(4) The “transference” of spores from surfaces to the air is modeled by an equilibrium partitioning in which the ratio is 1 spore per cubic meter air for each 10 spores on surfaces in the room to be modeled (NRC 2004).
(5) The risk-base clean-up goal is estimated from concentrations of anthrax spores on surfaces in the room to be reused after an anthrax release, the amount of time to be spent in the room for each exposure, and the type of receptor and activity level (which effect breathing rate) of the persons to reuse the space.

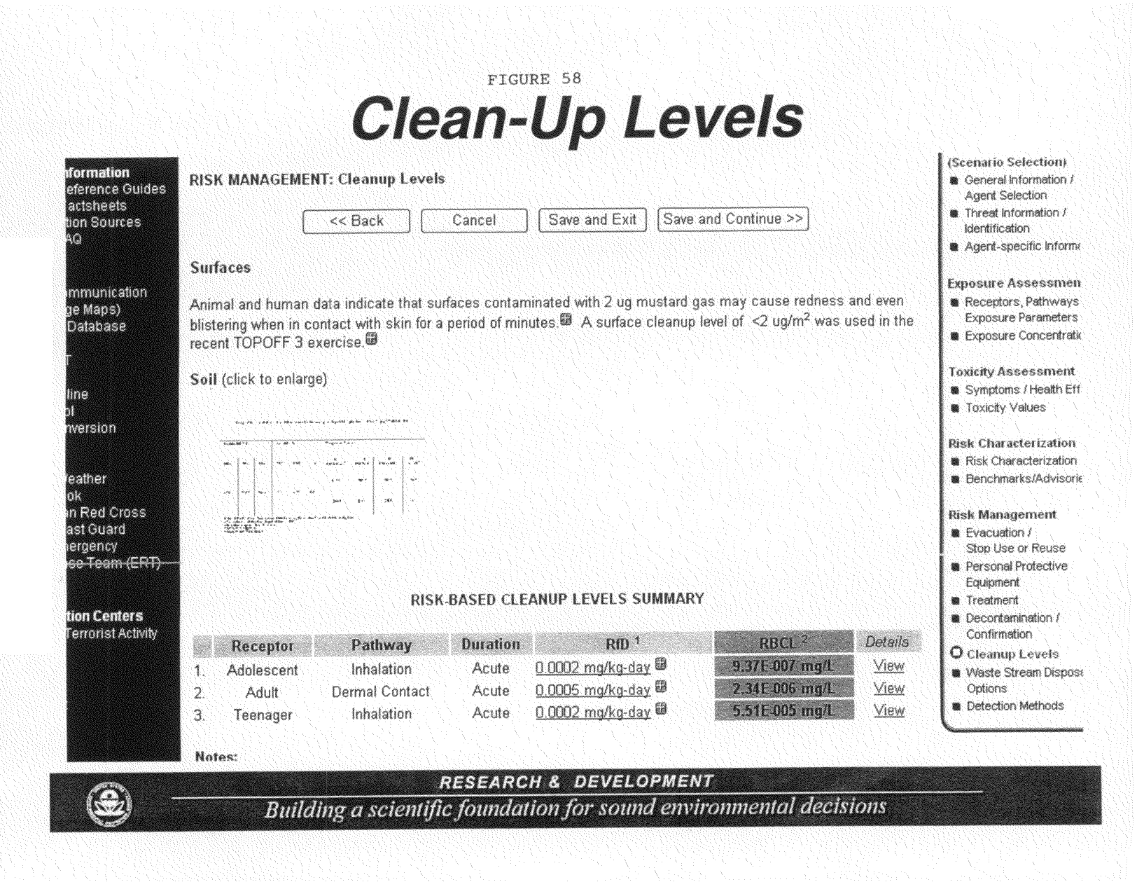

FIG. 58 shows by way of an example an ECAT system screen regarding clean-up information. Established clean-up levels as well as risk-based cleanup levels calculated by ECAT are presented so the user knows the answer to the question “how clean is clean” or “how clean is safe”?

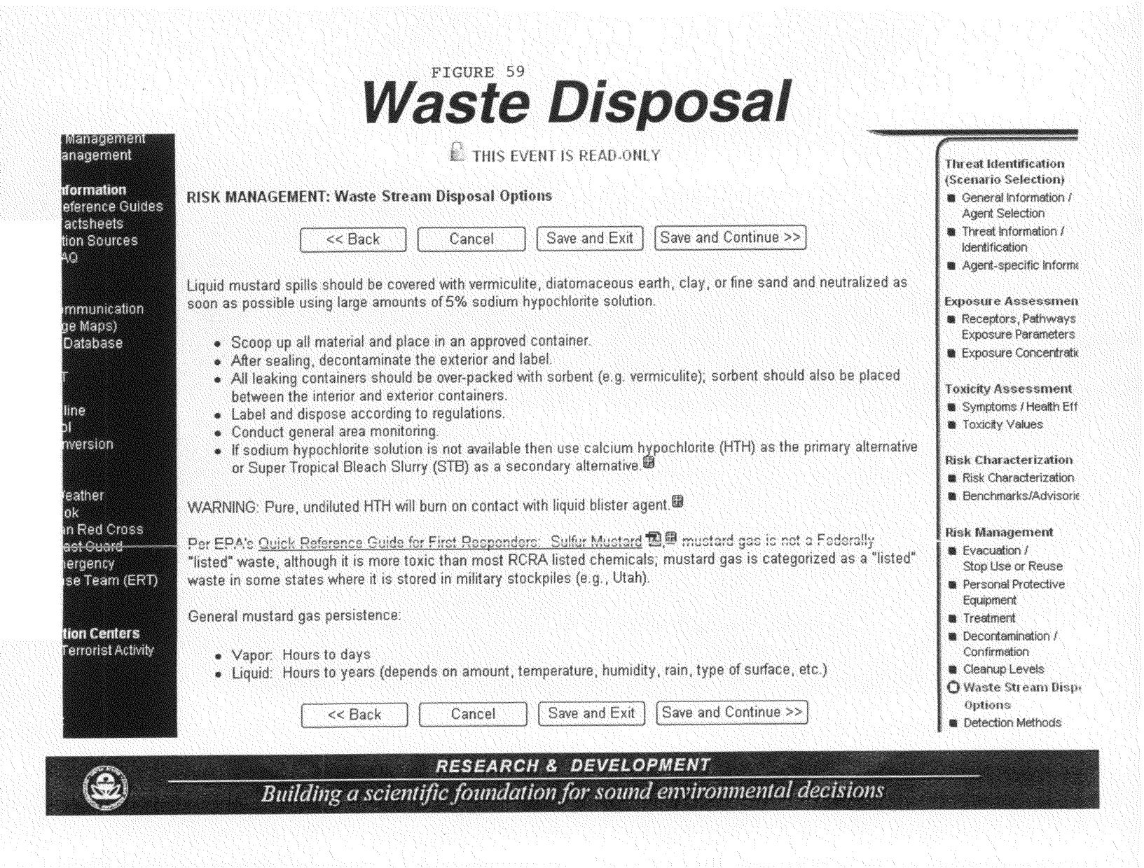

FIG. 59 shows by way of an example an ECAT system screen regarding waste disposal. General waste disposal information is included in ECAT for guidance on quick removal of contaminated media in the event of an emergency.

Detection Limits

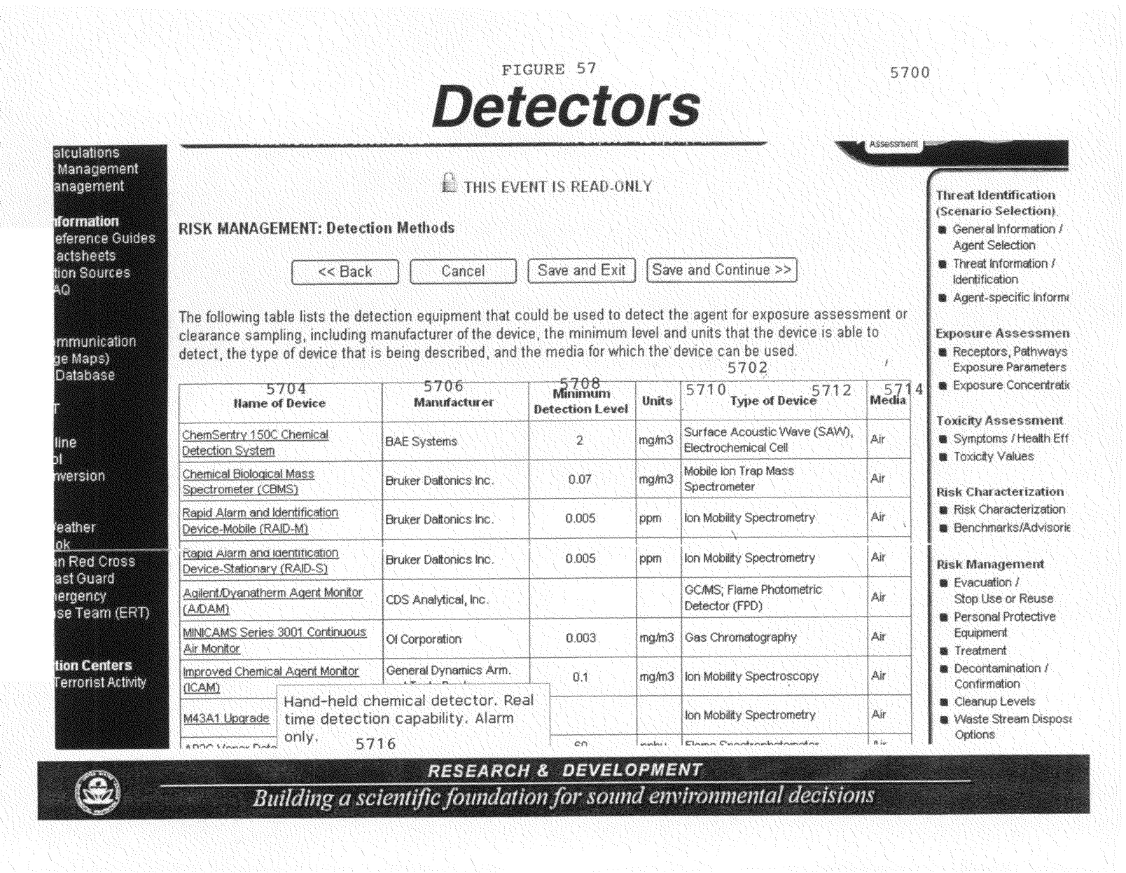

ECAT contains data on detectors that may be of use for specific threat agents and are displayed in a scenario-dependent fashion. Sampling and detection equipment is displayed based on the medium into which the agent is released (that is, liquid, solid, air). A detection limit utility has been created in ECAT. FIG. 57 shows by way of an example an ECAT system screen regarding detection methods and detectors. ECAT includes detectors appropriate for each agent along with the manufacturer, minimum detection level, and the type of technology utilized in the detector. In screen 5700, there is a table 5702 showing detection related information. Table 5702 is organized with a name of device column 5704, a manufacturer column 5706, a minimum detection level column 5708, a detection measuring unit column 5710, a type of device column 5712 and a media column 5714. Under these columns, relevant information is listed. To get a quick description of each detector, the ECAT user may hold the cursor over the detector's name, a brief summary 5716 of the detector will appear.

The detection limit utility compares the EPC and the detection limits of selected detectors in order to determine which detectors may be useful for specific scenarios. If the detection limit for a given detector is greater than the EPC, it may not be useful for decision-making purposes.

Some detectors have been excluded from this utility for various reasons. Biological agents are excluded due to the lack of consensus in the scientific community in regard to infectious doses of microorganisms, and the recent suggestion by the National Academy of Sciences (NAS 2005) that microbial risk assessment should proceed assuming no threshold of exposure for infection, no comparisons of EPCs and detection limits has been made for biological agents. The decision not to include the measurement of biological agents in the EPC-detection limit comparison is further supported by the nature of many detection methods for microbes. Commonly used methods for detection of microbes, such as the polymerase chain reaction, microarray, culture, and most probable number, are rarely quantitative and may or may not be restricted to viable organisms.

Detectors that collect a sample in one medium (for example air) but detect concentration in another medium (for example, a liquid solvent) have been excluded from this utility because the conversion from the sample media to the analytical media requires the input of information from the sample collection event (for example, sample air flow rates or volumes). Excluded from the utility are:
Detectors that sample air and transfer the sample to a liquid media
Detectors that sample a solid and transfer the sample to a liquid media
Detectors that sample air and transfer the sample to a solid media

In addition to simple conversions of one unit of measure to another (such as pg to mg) and parts per million in water to mg/L, more complicated conversions involving air sampling methods are performed. The following conversions are contained in ECAT for the comparison of EPC values with detection limits in air (note: all conversions assume 25 degrees in Celsius and pressures of 1 atmosphere)

Assuming the agent in air acts as an ideal gas, conversion of ppm in air to mg/L in air can be performed using the following equation (EPA 2005b):

Concentration in mg/L=[(Concentration in ppm)×MW]/(24.45×1,000)

where,
MW=Molecular weight
24.45=Molar volume of air at 25 C.
1,000=Conversion factor from milligrams per cubic meter [mg/m³] to mg/L air

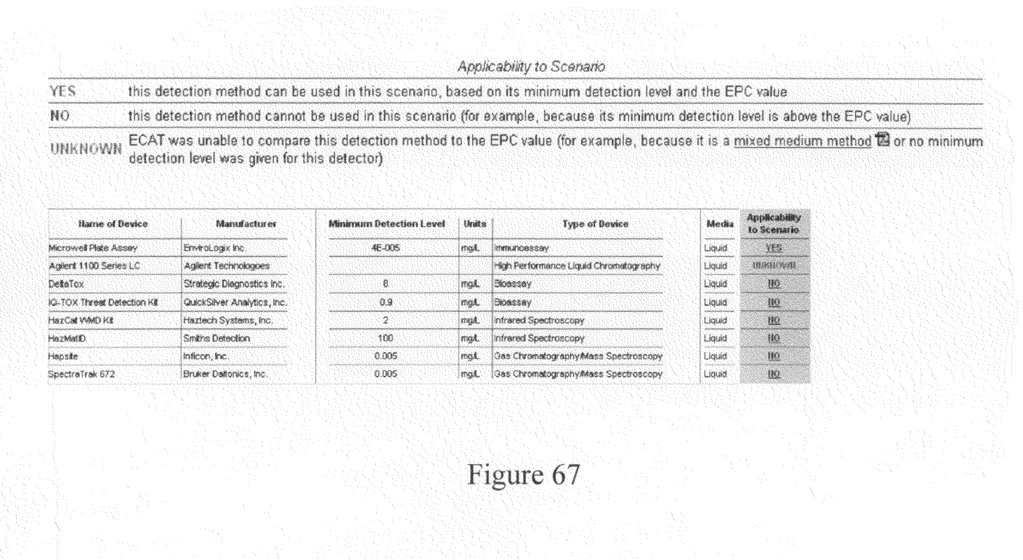

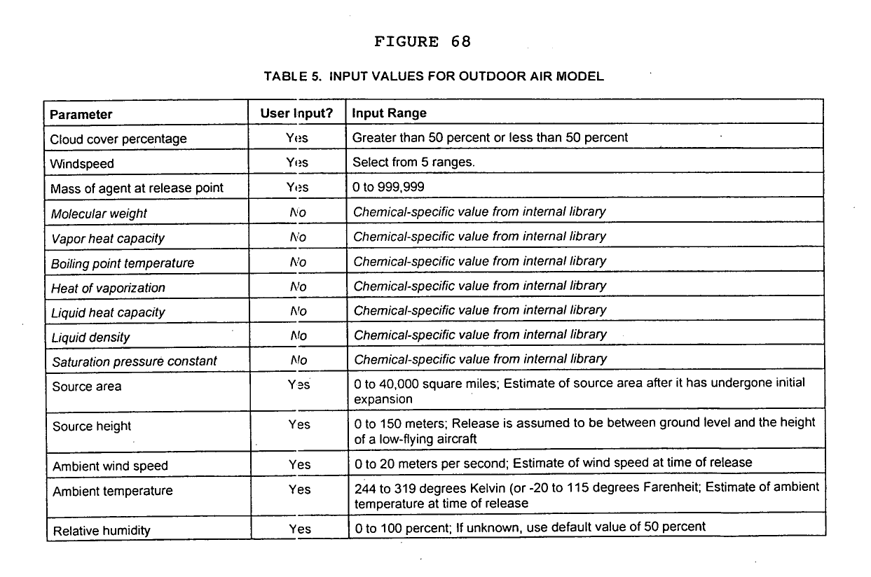

Sample output from the detection limit utility is shown FIG. 67.

Summary Reports

The ECAT Scenario Summary Report provides a printable summarized report of events entered into the system. This report conforms with the EPA NHSRC “message mapping” concepts and includes the following information to users of the system.

Incident Summary
Location
Time line
Threat agent involved

Exposure Summary
Population Exposed
Agent Physical Characteristics
Exposure Concentration

Health Effects
Immediate Symptoms
Delayed Symptoms
Sensitive Populations to Consider
Existing Toxicity Benchmarks

Risk Characterization

Response and Post-Incident Risk Management

ECAT Content Management

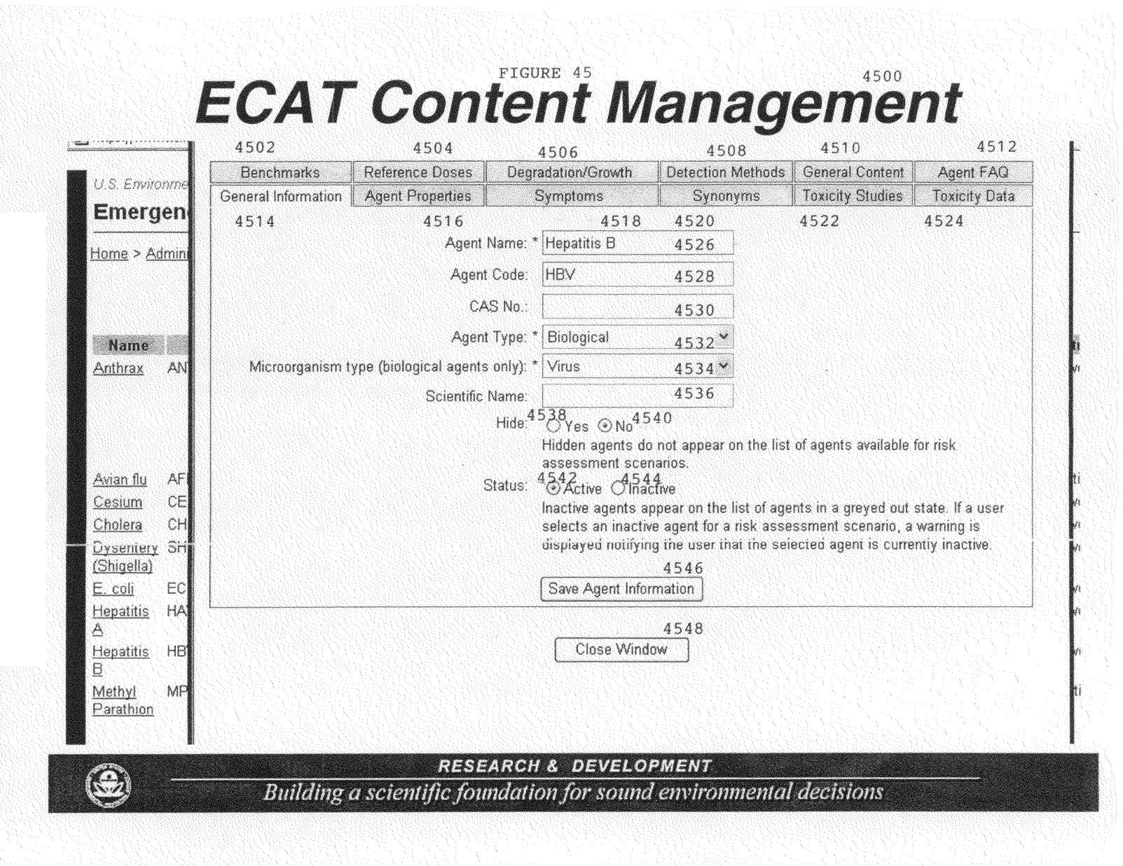

ECAT is a comprehensive tool with a broad scope of features and functionalities, as such, a management system with capabilities commensurate the ability of the ECAT system is required. FIG. 45 shows by way of an example an ECAT system screen of its content management system. The content management functions are designed for easy addition and revision of information relied and utilized by the ECAT system.

In screen 4500 of FIG. 45, there are shown twelve function taps; namely, benchmark tap 4502, reference doses tap 4504, degradation/growth tap 4506, detection methods tap 4508, general content tap 4510, agent frequently asked question tap 4512, general information tap 4514, agent properties tap 4516, symptoms tap 4518, synonyms tap 4520, toxicity studies tap 4522 and toxicity data tap 4524. On this screen, it so happens the general information tap 4514 is clicked all information prompts associated with this tap are shown. They are agent name prompt 4526, agent code prompt 4528, CAS No. prompt 4530, agent type prompt 4532, and microorganism type for biological agents only prompt 4534. The administrator/user can set whether hidden agents to be shown on the list of agents available for risk assessment scenarios by selecting either checking the yes circle 4538 or checking the no circle 4540. The administrator/user can also set whether the agent in question is active or inactive by checking circles 4542 and 4544, respectively. Inactive agents appear on the list of agents in a grayed out state. If a user selects an inactive agent for a risk assessment scenario, a warning is displayed notifying the user that the selected agent is currently inactive. Once all proper prompt entries selections are made, the administrator/user may save the agent information at 4546 and close the window at 45.

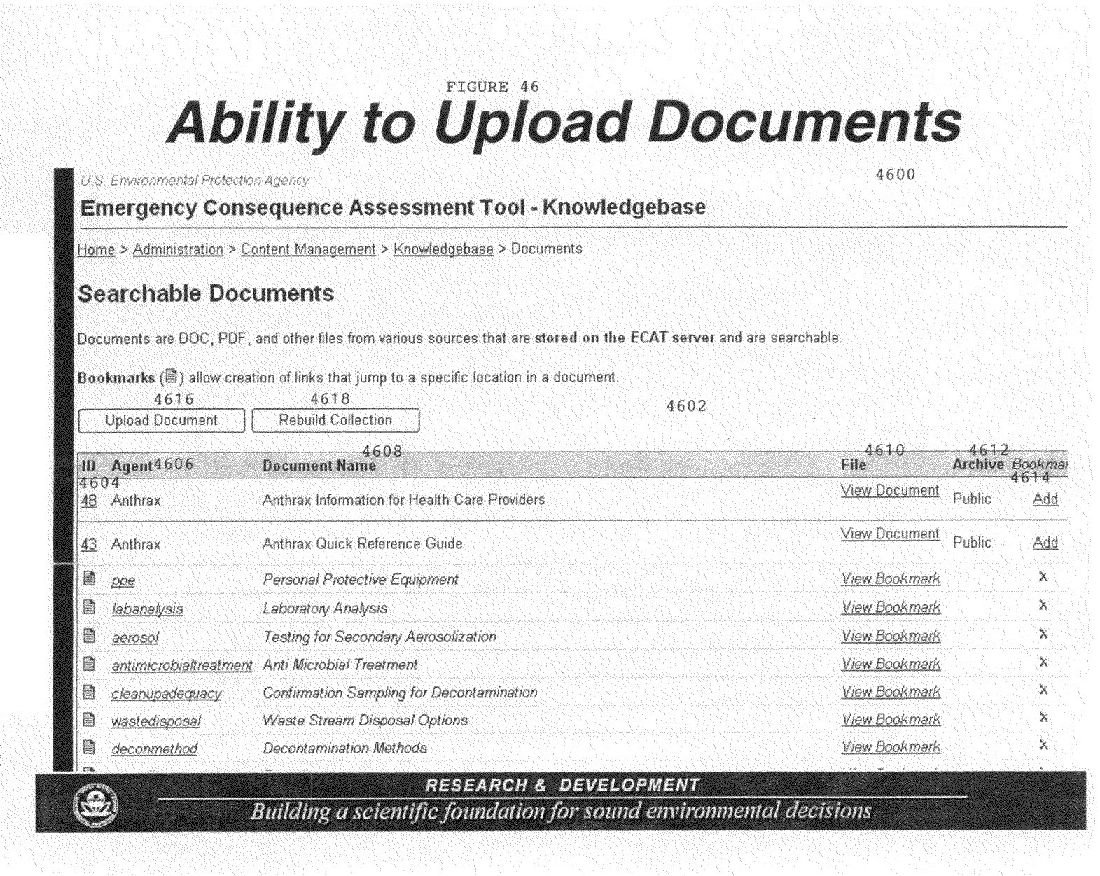

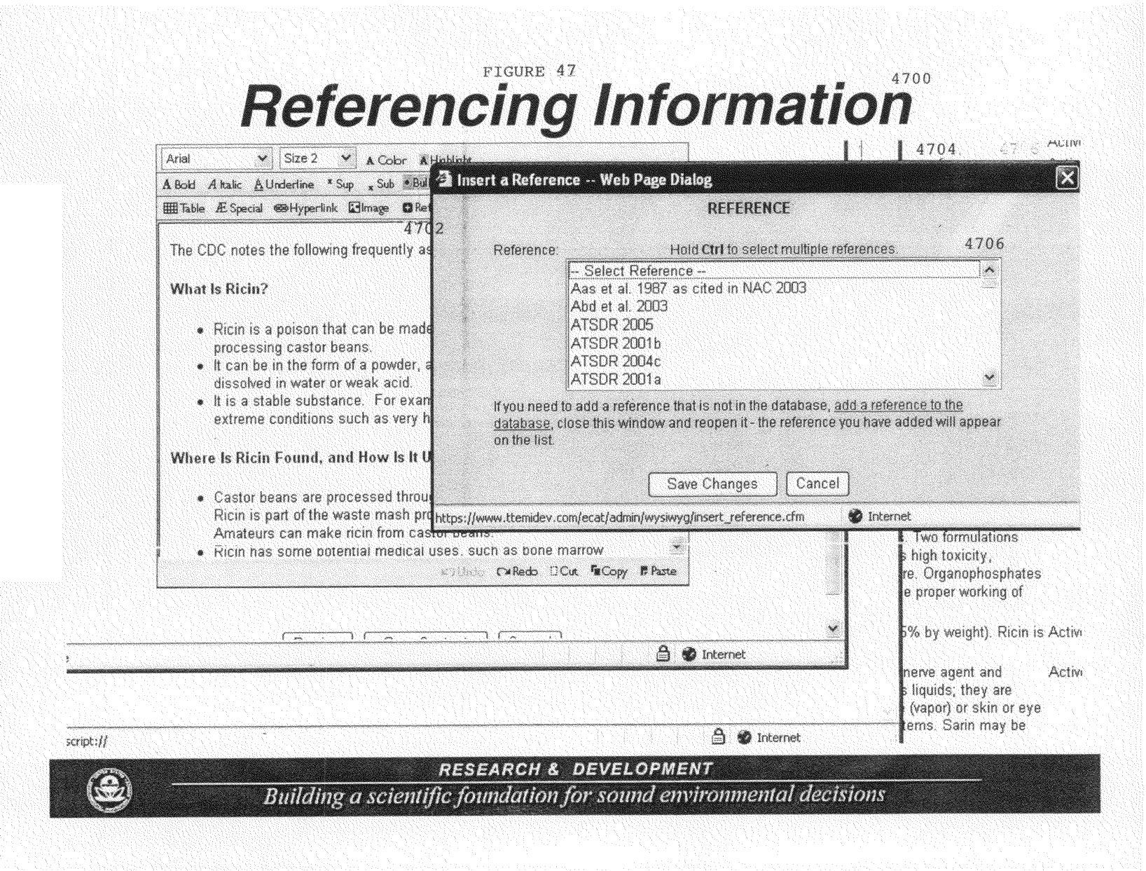

A large knowledge base is available to the ECAT system. Large documents can be uploaded into ECAT easily. Documents are either linked within ECAT so the user can view them in their entirety or for use only by ECAT administrators. Documents are in Microsoft Word .DOC, PDF and other files from various sources that are stored on the ECAT server and are searchable. FIG. 46 shows by way of an example an ECAT system screen showing a number of searchable documents in the ECAT knowledge database. As shown, there is a table 4602 tabulating information in an ID column 4604, agent column 4606, document name column 4608, file column 4610, archive column 4612 and bookmark column 4614. Under these columns is listed specific document information. The administrator/user may choose to either upload document by clicking icon 4616 or rebuild collection by clicking icon 4618. The ECAT system provides all documents and references. The master reference list is accessed when the reference icon is selected. The administrator can then select a reference already in the list or add a new one to the master list. FIG. 47 shows by way of an example an ECAT system screen showing a screen to obtain referencing information. In screen 4700, when the reference icon 4702 is clicked, a sub-screen 4704 with the title reference appears. From which screen, a user may make selection of desired reference material at prompt 4706.

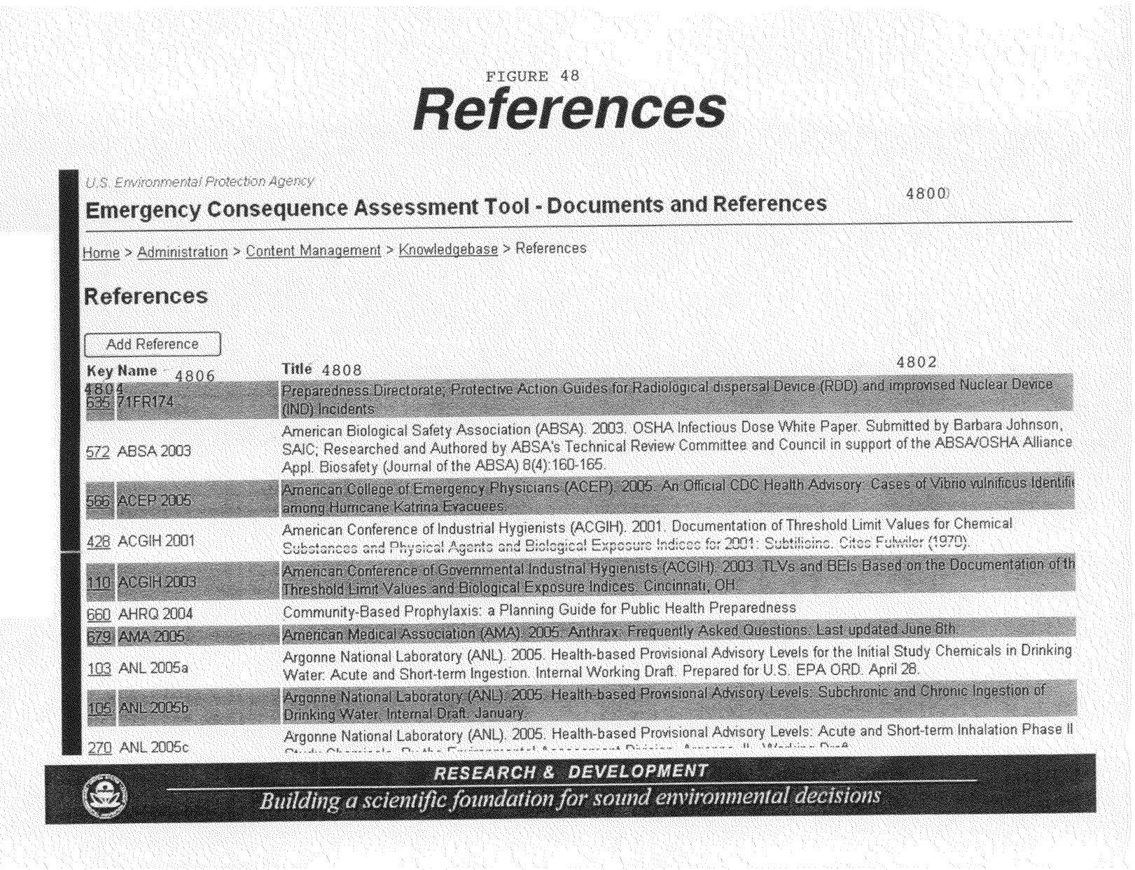

References can also be added in the content management. FIG. 48 shows by way of an example an ECAT system screen showing documents or references being added to the content management. Documents and references that are added are tabulated in a table 4802. The table is organized with a key column 4804, name column 4806 and a title column 4808.

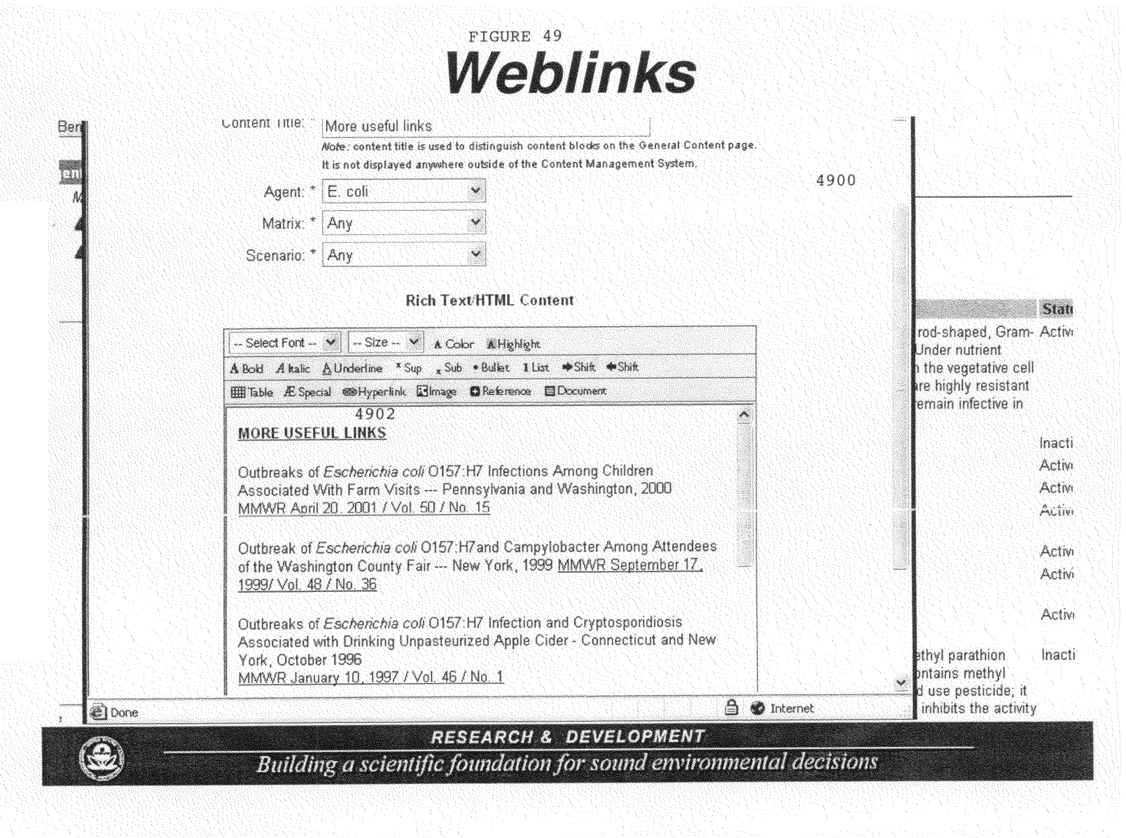

When adding information to ECAT, it is easy for the administrator to add weblinks. FIG. 49 shows by way of an example of an ECAT system screen showing how weblinks may be added. On screen 4900, there is a hyperlink tap 4902. By using this hyperlink tap 4902 to link a word with a specific reference, whenever a user clinks on the word, the specific reference appears for the reading convenience of the user.

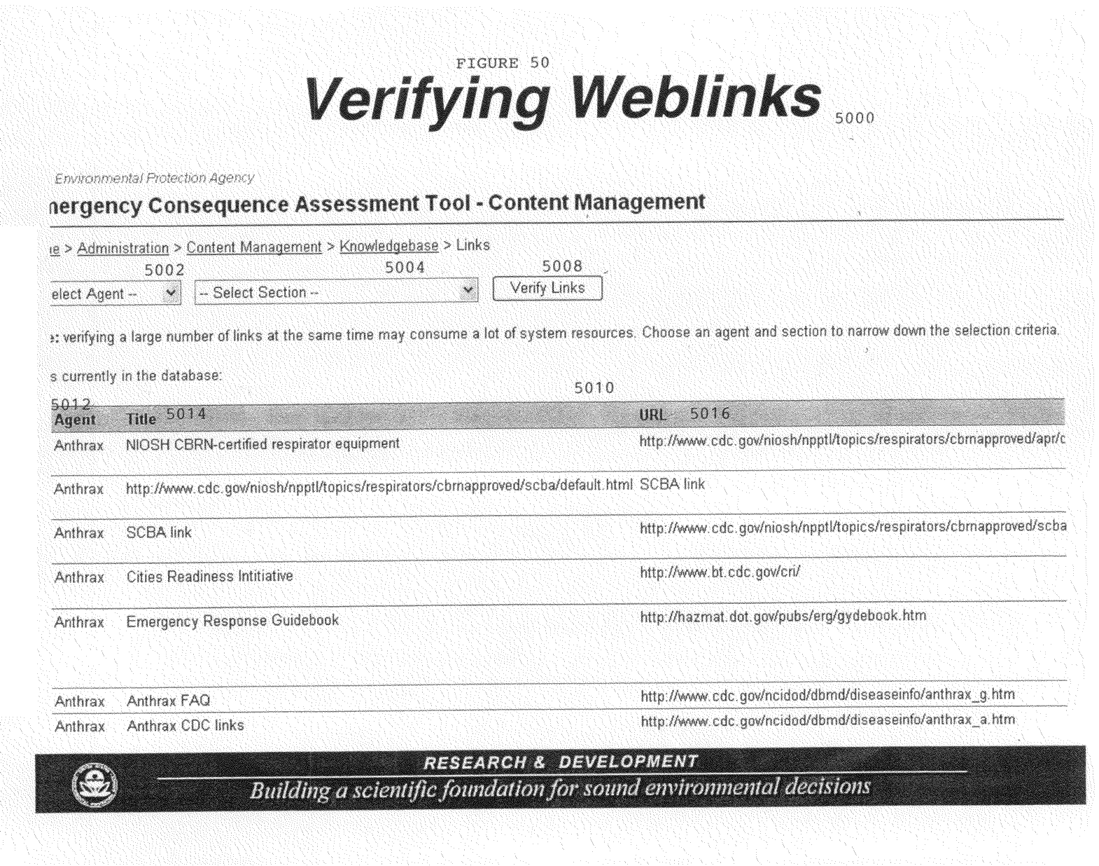

Weblinks can be verified by ECAT periodically to ensure users are able to access the links and not become frustrated at broken links when trying to access important information. FIG. 50 shows by way of an example an ECAT system screen showing how weblinks can be verified. Verifying a large number of links at the same time may consume much system resources. To economize the weblink verification operation, a select agent prompt 5002 and a select section prompt 5004 are recommended. After the verify links command 5008 is clicked, document information with link information are shown in table 5010. Table 5010 is tabulated with an agent column 5012, a title column 5014 and a uniform resource locator (URL) column where respective document with relevant information are organized and displayed accordingly.

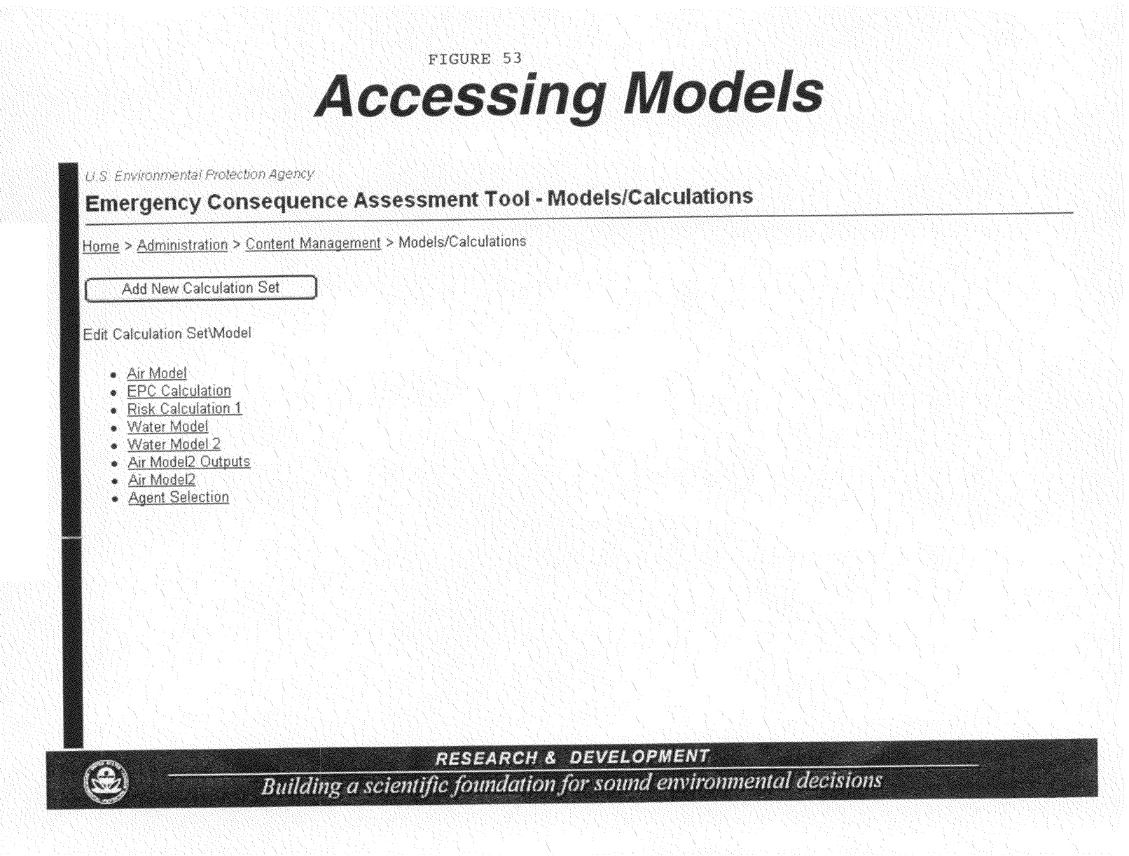

Calculation sets or models can be added and accessed by the administrator. FIG. 53 shows by way of an example an ECAT screen where calculation set or model can be added or edited.

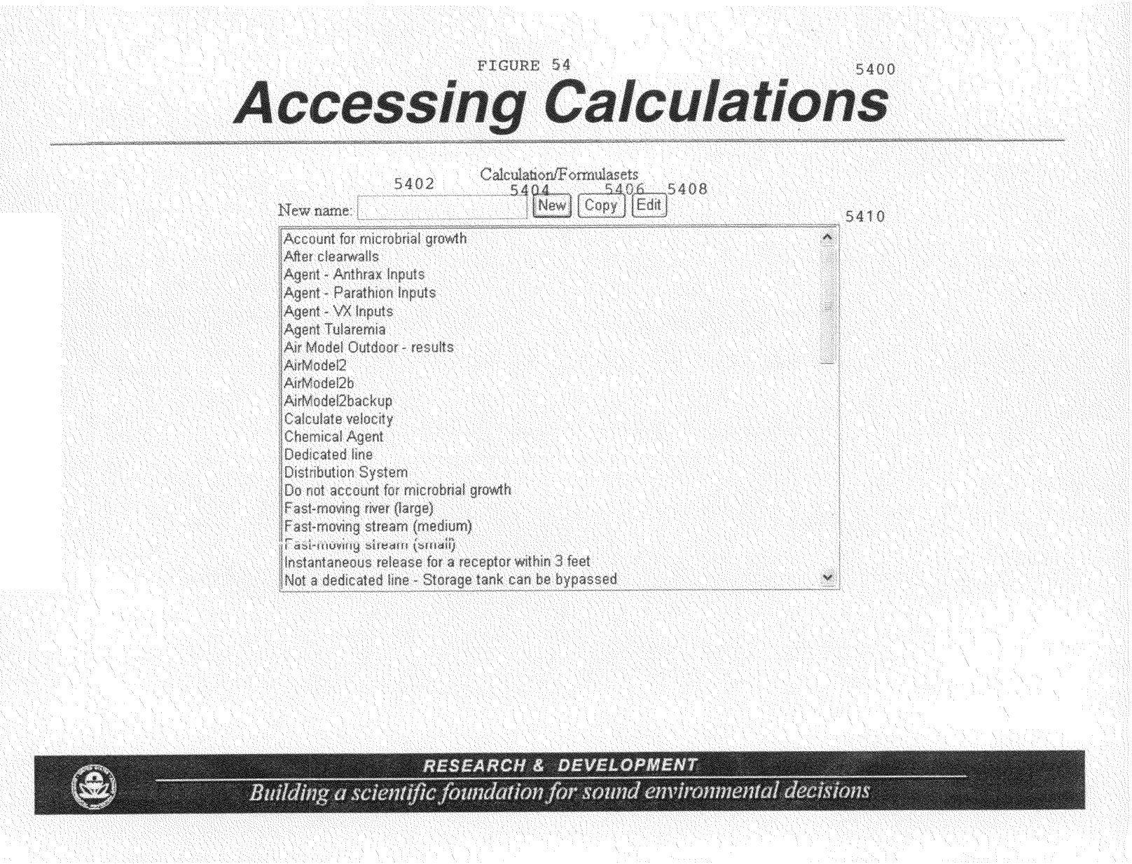

All equations and calculations in ECAT can be easily accessed and edited by the administrator. FIG. 54 shows by way of an example an ECAT system screen showing a selection screen to add, copy or edit calculations or formulates. In screen 5400, selection screen 5410 displays all calculation/formulate sets in the ECAT system. The administrator can select a calculation/formulate set of interest and copy or edit by clicking on icon 5406 and 5408, respectively. If a new calculation/formulate set is to be introduced to ECAT, the administrator may enter a new name at prompt 5402 and clicked on the new icon 5404.

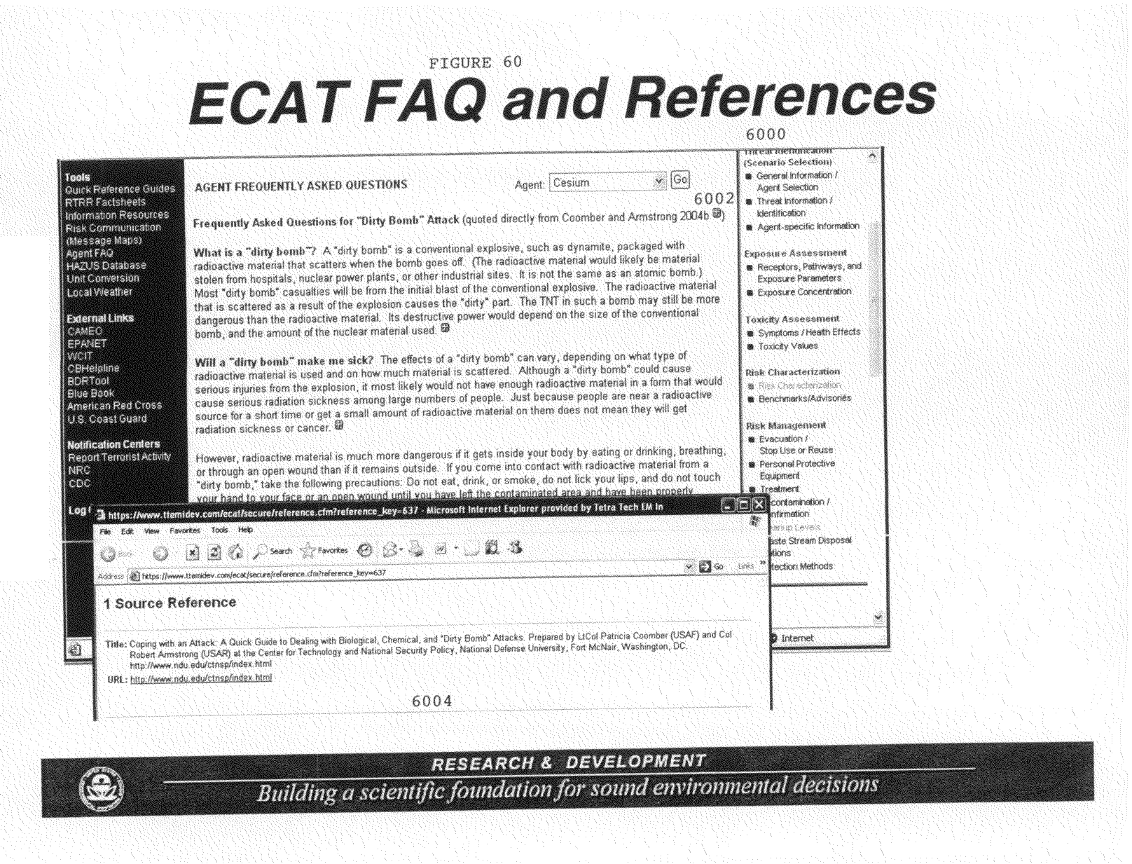

Expedited briefings and “at your fingertips” answers and references are enabled with ECAT frequently asked questions (FAQ). Questions and answers can be pre-checked during training and preparedness to ensure clear communication and avoid public embarrassment during a crisis. FIG. 60 shows by way of an example an ECAT system screen showing some frequently asked questions with answers regarding a dirty bomb attack. In screen 6000, there are many reference material links appearing in an icon such as that shown at 6002. When a reader needs to know the authority providing sentence or paragraph information, the reader may click on the related icon. For example, when a reader clicks on icon 6002, a sub-screen 6004 with title and weblink information appears.

### REFERENCES

All references expressed herein this patent application, including those listed hereinbelow and others hereinabove are incorporated herein by reference.
American Water Works Association (AWWA). 1990. Water Quality and Treatment. McGraw-Hill, Inc. New York, N.Y.
Balk, S. J., B. A. Gitterman, M.D. Miller, M. W. Shannon, K. M. Shea, and W. B. Weil. 2000. “Chemical-Biological Terrorism and Its Impact on Children.” Pediatrics. 105(3):662-670. As cited in Vogt and Sorensen 2002.
Cohen-Hubal, E. A., Sheldon, L. S., Burke, J. M. 1999. Children's Exposure Assessment: a Review of Factors Influencing Children's Exposure, and the Data Available to Characterize and Assess that Exposure. U.S. Environmental Protection Agency, National Exposure Research Laboratory, Research Triangle Park, N.C. As cited in EPA 2002.
Committee of the Great Lakes. 1997. “Recommended Standards for Water Works.” Formerly known as the Ten State Standards. Upper Mississippi River Board of State Public Health and Environmental Managers.
Dickinson, B. 2005. “Sanitary Survey Self-Assessment Guide for
Surface Water.” Western Kentucky University Technical Assistance Center for Water Quality. Available online at http://water.wku.edu/products/Sanitary%20%Survey%20for%20Surface%20Water.pdf
Druett H A, Henderson D W, Packman L, Peacock S. 1953. “Studies on Respiratory Infection. I. The Influence of Particle Size on Respiratory Infection with Anthrax Spores.” Journal of Hygiene. London. 51 (3): 359-371.
Haas, C. N. 2002. “On the Risk of Mortality to Primates Exposed to Anthrax Spores.” Risk Analysis. 22(2):189-193. As cited in NRC 2004.
Interagency Steering Committee on Radiation Standards. 2002.
Final Report. A Method for Estimating Radiation Risk from Total Effective Dose Equivalent (TEDE). Available online at: http://www.iscors.org/library.html
Jobson, H. E. 1997. “Predicting Traveltime and Dispersion in Channels.” Prepared for the U.S. Geological Survey, Water Resources Division. ASCE Journal of Hydraulic Engineering. Available online at http://smig.usgs.gov/SMIG/features 1296/dispersion.html.
Kilpatrick, F. A. 1993. “Simulation of Soluble Waste Transport and Buildup in Surface Waters Using Tracers.” Techniques of Water-Resources Investigations of the United States Geological Survey. Prepared for the U.S. Geological Survey, Denver, Colo. Available online at http://water.usgs.gov/pubs/twri/twri3-a20/pdf/TWRI 3-A20.pdf.
Lawrence Livermore National Laboratory/Lakes Environmental. 1997. User's Manual for SLAB: An Atmospheric Dispersion Model for Denser-Than-Air-Releases. Abridged Version.
National Research Council (NRC). 2004. Reopening Public Facilities After a Biological Attack: A Decision-Making Framework. National Academies Press. Available online at http://books.na.edu/catalog/11324.html
NRC. 1986. Criteria and Methods for Preparing Emergency Exposure Guidance Level (EEGL), Short-Term Public Emergency Guidance
Level (SPEGL), and Continuous Exposure Guidance Level (CEGL) Documents. Committee on Toxicology. National Academy Press. Washington, D.C.
Samuels, William B. and others. 2002. “RiverSpill: A GIS-Based Real Time Transport Model for Source Water Protection.” Available online at: http://eh2o.saic.com/iwqss/links/WTO208b.pdf
Taylor, G. I. 1954. Dispersion of Matter in Turbulent Flow through a Pipe, Proc. Roy. Soc. London (A), Vol. 223.
U.S. Environmental Protection Agency (EPA). 1988. Federal Guidance Report, Number 11: Limiting Values of Radionuclide Intake and Air Concentration and Dose Conversion Factors for Inhalation, Submersion, and Ingestion. Available online at: http://www.epa.gov/radiation/docs/federal/520-1-88-020.pdf
EPA. 1989. Risk Assessment Guidance for Superfund, Volume 1, Human Health Evaluation Manual (Part A). Interim Final. Office of Emergency and Remedial Response, Washington, D.C. December.
EPA. 1991. Risk Assessment Guidance for Superfund, Volume 1, Human Health Evaluation Manual (Part B, Development of Risk-based Preliminary Remediation Goals). Interim. Office of Emergency and Remedial Response, Washington, D.C. December.
EPA. 1997. Exposure Factors Handbook, Vols. I-III. Washington, D.C.: Office of Research and Development. EPA/600/P-95/002Fa-c.
EPA. 1998. Human Health Risk Assessment Protocol for Hazardous Waste Combustion Facilities (HHRAP). Office of Solid Waste. EPA-530-D-98-01A. July.
EPA. 2000. Office of Water. EPA-816-F-00-006. February. Available online at: http://www.epa.gov/ogwdw000/consumer/hist.pdf
EPA. 2002. Child-specific Exposure Factors Handbook. National Center for Environmental Assessment, Washington, D.C. EPA/600/P-00/002B. Available online at http://www.epa.gov/ncea
EPA. 2005a. Supplemental Guidance for Assessing Susceptibility from Early-Life Exposure to Carcinogens. Risk Assessment Forum. U.S. Environmental Protection Agency. Washington, D.C. EPA/630/P-03/003F. Available online at http://www.epa.gov/ttn/atw/childrens supplement final.pdf
EPA. 2005b. Air Toxics Website: Napthalene. Available online at: http://www.epa.gov/ttn/atw/hlthef/naphthal.html
United States Geographical Survey (USGS). 2005. “Real-Time Data for the Nation; Daily Streamflow Conditions.”
Vogt, B. M. and J. H. Sorensen. 2002. “How Clean is Safe? Improving the Effectiveness of Decontamination of Structures and People Following Chemical and Biological Incidents.” Prepared by Oak Ridge National Laboratory, Oak Ridge, Tenn., for U.S. Department of Energy. October. Available online at: http://emc.ornl.gov/EMCWeb/EMC/PDF/How Clean is Safe.pdf
Voss, J. T. 2001. Los Alamos Radiation Monitoring Notebook. James T. Voss. LA-UR-00-2584. Available online at: http://www.nrrpt.org/documents/la-ur-00-2584.pdf.
Walski, T. and others. 2003. “Advanced Water Distribution Modeling and Management.” Haestad Methods, Inc.
Wiley-Interscience. 2003. Quick Selection Guide to Chemical Protective Clothing. 4th Edition. John Wiley and Sons Publication.

We claim:

1. An emergency consequence assessment method, comprising a plurality of steps of:
a. prompting an un-registered user to become a registered user by requesting and establishing a login account with the assessment method;
b. prompting a registered user to log-in to the assessment method to begin a session of using the assessment method;
c. prompting the registered user to designate whether the session is for a live incident emergency event or for a training exercise of a mock emergency event;
d. prompting the registered user to report general information of a threat agent.

2. The emergency consequence assessment method of claim 1, further comprising a step of:
e. prompting the registered user to inform where the threat agent is found.

3. The emergency consequence assessment method of claim 2, further comprising a step of:
f. determining whether the identity of the threat agent is known or unknown.

4. The emergency consequence assessment method of claim 3, further comprising a step of:
g. if it is determined in step f that the identity of the threat agent is known, then information related to the threat agent is made accessible to the user.

5. The emergency consequence assessment method of claim 4, further comprising a step of:
h. determining whether to gather information regarding pathway to exposure or estimate concentration of the threat agent.

6. The emergency consequence assessment method of claim 5, further comprising a step of:
i. if it is determined in step h to prompt for information regarding pathway to exposure from the user, and if the user selects ingestion pathway, then the user is made assessable to a screen that collects information regarding ingestion pathway.

7. The emergency consequence assessment method of claim 5, further comprising a step of:
j. if it is determined in step h to prompt for information regarding pathway to exposure from the user, and if the user selects inhalation pathway, then make assessable to the user a screen that collects information regarding inhalation pathway.

8. The emergency consequence assessment method of claim 5, further comprising a step of:
k. if it is determined in step h to prompt for information regarding pathway to exposure from the user, and if the user selects dermal pathway, then make assessable to the user a screen that collects information regarding dermal pathway.

9. The emergency consequence assessment method of claim 5, further comprising a step of:
l. if it is determined in step h to estimate concentration of the threat agent, then a determination is made whether the threat agent is released to air or water.

10. The emergency consequence assessment method of claim 9, further comprising a step of:
m. if it is determined in step l that the threat agent is released to water, then a plurality of prompts is presented to the user to gather information regarding where within a water treatment distribution system the threat agent was released.

11. The emergency consequence assessment method of claim 9, further comprising a step of:
n. if it is determined in step l that the threat agent is released to water, then a plurality of prompts is presented to the user to gather information regarding water body inputs where the threat agent is introduced.

12. The emergency consequence assessment method of claim 9, further comprising a step of:
o. if it is determined in step 1 that the threat agent is released to water, then a plurality of prompts is presented to the user to gather information regarding distribution inputs of the threat agent.

13. The emergency consequence assessment method of claim 9, further comprising a step of:
p. if it is determined in step 1 that the threat agent is released to water, then a water dispersion model is selected based on information gathered in one of steps m, n, and o.

14. The emergency consequence assessment method of claim 13, further comprising a step of:
q. determining an exposure point concentration based on information from one of steps m, n, o and p.

15. The emergency consequence assessment method of claim 9, further comprising a step of:
r. if it determined in step 1 that the threat agent is released to air, then an air dispersion model is selected.

16. The emergency consequence assessment method of claim 15, further comprising a step of:
s. determining an exposure point concentration based on information from step r.

17. The emergency consequence assessment method of claim 16, further comprising a step of:
t. making a risk characterization based on information from one of steps i, j, k, q and r in conjunction with information from general toxicity and dose response.

18. The emergency consequence assessment method of claim 17, further comprising a step of:
u. generating and presenting to the user a summary of one of the live incident emergency event and the mock emergency event.

19. The emergency consequence assessment method of claim 18, further comprising a step of:
v. generating and presenting to the user a proposed risk management in view of the presence of the threat agent.

20. The emergency consequence assessment method of claim 18, further comprising a step of:
w. permitting the user to save all information related to the session before logging out from the session.

21. The emergency consequence assessment method of claim 15, wherein the air dispersion model comprises a radiation dispersion model.
